(19) United States
(12) Patent Application Publication
(10) Pub. No.: US 2005/0049924 A1
(43) Pub. Date: Mar. 3, 2005

(54) Techniques for use with application monitoring to obtain transaction data

(76) Inventors: Jason DeBettencourt, Medfield, MA (US); Stanley Yamane, Needham, MA (US); Marco Lara, Topsfield, MA (US)

Correspondence Address: FISH & RICHARDSON PC, 225 FRANKLIN ST, BOSTON, MA, 02110, US

(21) Appl. No.: 10/648,982

(22) Filed: Aug. 27, 2003

(51) Int. Cl. G06F 17/60

(52) U.S. Cl. 705/21

(57) ABSTRACT

Described are techniques used with application monitoring in connection with performing Web Services. Associated with each application performing a service are one or more application servers and associated stream sensors. The stream sensors filter received XML messages in accordance with a set of rules to gather data. The filtered data is gathered at each point and then may be aggregated locally for each transaction by an aggregation service. Data may be gathered from each aggregation service by a global aggregator. Rules are specified initially and may be revised during runtime while gathering data. Rules are evaluated at runtime in accordance with the data stream.

### BACKGROUND

1. Technical Field

This application generally relates to a computer system, and more particularly to applications executing in a computer system.

2. Description of Related Art

Computer systems may be used to perform a variety of services, transactions, and tasks, such as performing a service in response to a request. The Internet may be used in communicating the request from a first computer system to a second computer system that returns the response. On the second computer system, one or more software applications may be executed in connection with performing the requested service. One example may be a user's request to make a on-line computer purchase from a personal computer. The user's request may be issued from a first computer system over the Internet to a second computer system hosting a website. At the website, the requested purchase may be completed by a first application checking local inventory on hand and communicating with a second application that handles mailing and/or delivery services. As part of management and other administrative tasks, for example, of the second computer system, it may be desirable to provide information about the one or more applications that execute on the second computer system in connection with a business process or service. It may be desirable to use a monitoring and management tool which monitors data flow and/or determines metrics in connection with transactions that involve one or more applications. It may be also be desirable to have the data gathering and associated transactional analysis performed in real time with minimal modification to existing applications and business processes to be monitored. Additionally, it may be desirable to have this technique perform the foregoing without adversely impacting the flow of data and the performance of the applications of the business process.

### SUMMARY OF THE INVENTION

In accordance with one aspect of the invention is a method for filtering data from a data stream of a web services application. A message is received. Using data from the message, a current set of one or more rules is evaluated producing a current set of evaluated rules. Data is collected that is associated with the message in accordance with the current set of evaluated rules.

In accordance with another aspect of the invention is a system for filtering data comprising: at least one application providing a service; at least one application server and stream sensor associated with each of the at least one application, the stream sensor filtering a data stream of the at least one application in accordance with a dynamically evaluated current set of rules producing filtered data, the current set of rules being dynamically evaluated with each received message; and a context engine associated with each of the at least one application, the context engine including an aggregation service that aggregates the filtered data for the application in accordance with at least one local aggregation condition.

In accordance with yet another aspect of the invention is a method for capturing data from a data stream of an application. A first message is received from the data stream of the application. First context information is stored including a copy of a first set of one or more rules. The first context information describes a processing state of the first message used during a first processing lifetime of the first message. The first set of one or more rules is used in obtaining first data related to the first message. The first set of one or more rules is the current set of rules. A second set of one or more rules is defined at runtime of the application while the application is servicing a request such that any subsequently received messages are processed in accordance with the second set of one or more rules. The second set of one or more rules replaces the first set of one or more rules as the current set. A second message is received from the data stream during the first processing lifetime of the first message. Second context information is stored that includes a copy of the second set of one or more rules. The second context information describing a processing state of the second message used during a second processing lifetime of the second message. The second set of rules is used in obtaining second data related to the second message. The first processing lifetime and the second processing lifetime overlap for at least a portion of both lifetimes such that the first and second messages are concurrently processed.

In accordance with another aspect of the invention is a computer program product for filtering data from a data stream of a web services application comprising: executable code that receives a message; executable code that evaluates, using data from the message, a current set of one or more rules producing a current set of evaluated rules; and executable code that collects data associated with the message in accordance with the current set of evaluated rules.

In accordance with still another aspect of the invention is a computer program product for capturing data from a data stream of an application comprising: executable code that receives a first message from the data stream of the application; executable code that stores first context information including a copy of a first set of one or more rules, the first context information describing a processing state of the first message used during a first processing lifetime of the first message, the first set of one or more rules used in obtaining first data related to the first message, the first set of one or more rules being the current set of rules; executable code that defines a second set of one or more rules at runtime of said application while said application is servicing a request such that any subsequently received messages are processed in accordance with the second set of one or more rules, the second set of one or more rules replacing the first set of one or more rules as the current set; executable code that receives a second message from the data stream during the first processing lifetime of the first message; and executable code that stores second context information including a copy of the second set of one or more rules, the second context information describing a processing state of the second message used during a second processing lifetime of the second message, the second set of rules used in obtaining second data related to the second message, the first processing lifetime and the second processing lifetime overlapping for at least a portion of both lifetimes such that the first and second messages are concurrently processed.

In accordance with another aspect of the invention is a method for obtaining data about a transaction in a computer system. At least one message is received at each of a plurality of nodes in connection with performing a service of the transaction. The at least one message is filtered at each of the plurality of nodes in accordance with a current set of one or more rules producing local filtered data at each of the plurality of nodes. At each of the plurality of nodes, processing the local filtered data producing aggregated data about the transaction.

In accordance with another aspect of the invention is a computer program product for obtaining data about a transaction in a computer system comprising: executable code that receives at least one message at each of a plurality of nodes in connection with performing a service of the transaction; executable code that filters the at least one message at each of the plurality of nodes in accordance with a current set of one or more rules producing local filtered data at each of the plurality of nodes; and executable code that processes, at each of the plurality of nodes, the local filtered data producing aggregated data about the transaction.

### BRIEF DESCRIPTION OF THE DRAWINGS

Features and advantages of the present invention will become more apparent from the following detailed description of exemplary embodiments thereof taken in conjunction with the accompanying drawings in which:

FIG. 1 is an example of an embodiment of a computer system according to the present invention;

FIG. 2 is an example of an embodiment of components that may be included in the server system of FIG. 1;

FIG. 3 is an example of an embodiment of the components that may be included in a host of FIG. 1;

FIG. 4 is an example showing more detail of some components included in the server system of FIG. 2;

FIG. 5 is a flowchart of steps that may be performed in an embodiment to perform data filtering and monitoring;

FIG. 6 is a flowchart of steps that may be performed in an embodiment in connection with rule specification after an initial set of rules has been specified.

FIG. 7 is a flowchart of steps that may be performed in an embodiment in connection with data reporting;

FIG. 8 is an example of an illustration of messages that may be exchanged in one embodiment between a web application server node and a console;

FIG. 9 is an example of components that may be included in an embodiment of a stream sensor and the context engine and data flow there between;

FIG. 10 is a flowchart of steps that may be performed in an embodiment in connection with stream sensor configuration processing including rule specification processing;

FIG. 11 is a flowchart setting forth more detail of one embodiment of rule configuration processing;

FIG. 12 is a flowchart setting forth more detail of one embodiment of runtime filtering and data monitoring;

FIG. 13A is an example of one embodiment of a session object;

FIG. 13B is an example illustrating how rules may be represented in the session object;

FIG. 14 is an example of one embodiment of a writer object;

FIG. 15 is an example of one representation of an incoming message;

FIG. 16 is an example of one embodiment of sections of an Object Definition Format file (ODF file) used in defining rules;

FIG. 17 is an example of one embodiment of different writer object types in accordance with the associated writer destinations or outputs;

FIGS. 18 and 19 are steps illustrating the use of different rule versions at different points in time during data gathering and monitoring;

FIGS. 20-25 are examples of screen shots of a user interface that may be used in an embodiment of the computer system of FIG. 1;

FIGS. 26 and 27 are illustrations of configurations in which the data monitoring and filtering techniques described herein may be used.

### DETAILED DESCRIPTION OF EMBODIMENT(S)

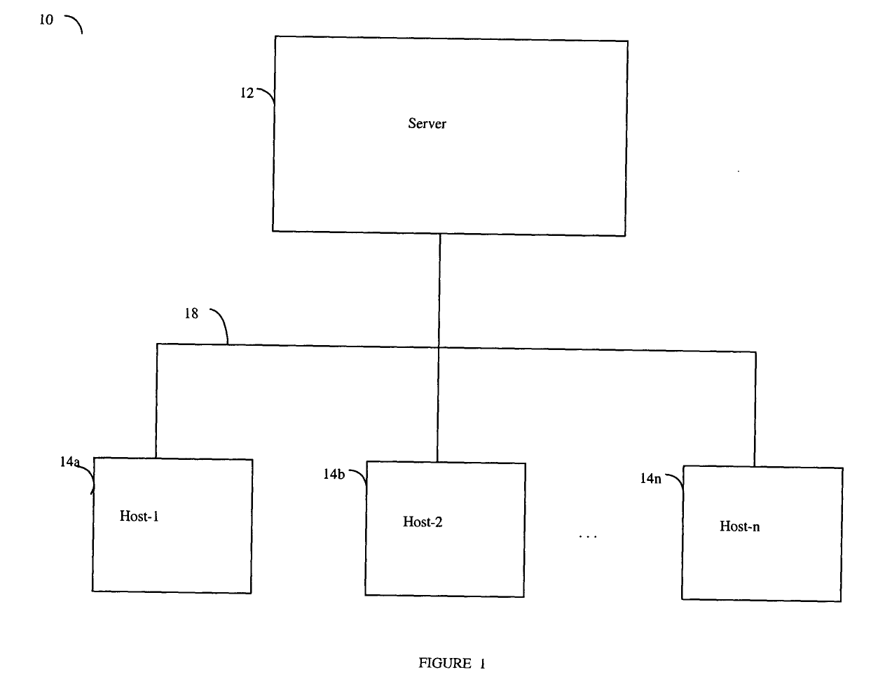

Referring now to FIG. 1, shown is an example of an embodiment of a computer system according to the present invention. The computer system 10 includes a server 12 connected to host systems 14a-14n which communicate through communication medium 18. In this embodiment of the computer system 10, the communication medium 18 may be any one of a variety of networks or other type of communication connections as known to those skilled in the art. For example, the communication medium 18 may be the Internet, an intranet, network or other non-network connection(s) by which the host systems 14a-14n communicate with the server system 12.

Each of the host systems 14a-14n and the server system 12 included in the computer system 10 may be connected to the communication medium 18 by any one of a variety of connections as may be provided and supported in accordance with the type of communication medium 18. The processors included in the host computer systems 14a-14n and the server system 12 may be any number and type of commercially available single or multi-processor system, such as an Intel-based processor, mainframe or other type of commercially-available or proprietary processor able to support incoming traffic in accordance with each particular embodiment and application.

It should be noted that the particulars of the hardware and software included in each of the host systems 14a-14n and the server system 12 are described herein in more detail, and may vary with each particular embodiment. Each of the host computers 14a-14n, as well as the data server system 12, may all be located at the same physical site, or, alternatively, may also be located in different physical locations. Some or all of the connections by which the hosts and server system may be connected to the communication medium 18 may pass through other communication devices, such as routing and/or switching equipment.

Each of the host computer systems as well as the server system may perform different types of data operations in accordance with different types of tasks or services. In the embodiment of FIG. 1, any one of the host computers 14a-14n may issue a request to the server system 12.

Web Services may be used in an embodiment of the computer system 10 of FIG. 1. Web Services may generally be characterized as a distributed computing approach for connecting software applications together to perform a business process as described at (http://www.research.ibm.com/journal/sj/412/gottschalk.html, http://www.w3c.org/TR/ws-arch/). Web Services utilize protocols for communications, such as, for example, XML (Extensible Markup Language) (as described at http://www.w3c.org/XML/), TCP/IP, HTTP (Hypertext Transfer Protocol) (as described at http://www.w3c.org/Protocols/) or Message Queuing (as described at http://www3.ibm.com/software/integration/mqfamily/library/manualsa/csqzal05/csqzal050f.htm), SOAP (Simple Object Access Protocol) (as described at http://www.w3c.org/TR/2003/REC-soap12-part0-20030624/), and WSDL (Web Services Description Language) (as described at http://dev.w3.org/cvsweb/˜checkout˜/2002/ws/desc/wsd112/wsdl12-primer.html), there between to provide for the interaction between multiple applications for a business process or task. Web Services entail the connection between two or more applications, such as may be executing on one of host systems 14a-14n and/or the server system 12, in which queries and responses are exchanged, for example, using SOAP/XML over HTTP. When using Web Services, the Internet is used to facilitate communications between a requesting application, and one or more server applications executing on the server system 12. The requesting application may issue a call that is serviced by one or more applications executing on server system 12. The server system 12 may return a resulting response. Web Services provide for integration of Web applications, as well as data that may be transferred between them, over the Internet using standardized protocols and platform independent technologies. As described herein, an embodiment using Web Services may be implemented using the web-related technology standards, such as those set forth above.

In connection with Web Services, a monitoring and management tool may be provided as software which performs data monitoring and/or determines metrics for transactions of a particular business process or service provided by one or more applications. What will be described herein are techniques that may be used in connection with application monitoring, such as monitoring the applications that may be included in an embodiment using Web Services.

The techniques described herein may be used in connection with tapping into the data streams of each of the applications providing a service, such as may be included in the server system 12, to monitor data used in connection with a business application process. The techniques described in the following paragraphs monitor data streams to obtain real time business data which may then be further analyzed and/or aggregated into different combinations. It should also be noted that the techniques described herein may be used in monitoring applications and data exchanges between them for other purposes and in other embodiments. Described herein are techniques that capture the XML data stream flowing between a requesting application and/or between nodes providing a Web Service such as may be provided by the server system 12 of FIG. 1.

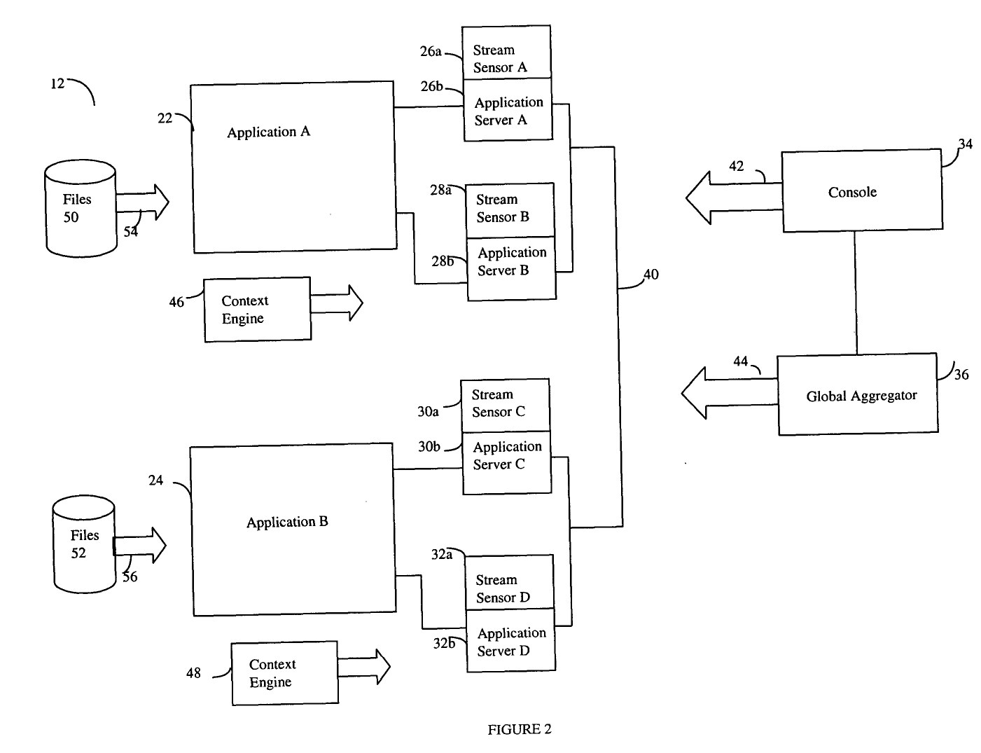

Referring now to FIG. 2, shown is an example of an embodiment of components that may be included in the server 12 of FIG. 1. In this example, the server 12 of FIG. 1 may be used to provide a service or a response in connection with a request, such as a query, from one of the host systems 14a through 14n previously described in connection with FIG. 1. The server 12 in the example described in following paragraphs may include a plurality of applications at a single Internet site. As an example, an application on a host system, such as host 14a, may be accessing the server system 12 which includes a banking application, such as may be used to obtain account information or to perform another service. The server system 12 may include a plurality of applications running within a single Internet site with one or more applications executing on one or more computer processors. Each of the different computer processors may also reside at one or more different physical locations. The server system 12 may execute one or more applications to provide a service returning one or more data items to the requesting host system. Different applications may also be associated with performing different tasks in accordance with each phase, for example, of a business transaction or service. The techniques described in following paragraphs may be used in connection with monitoring and gathering data of the various applications included in the server system 12 and data received from the user on a host system.

In another example of an embodiment, a host system 14a may make a request of an application at a first Internet site which utilizes services of one or more different Internet site locations. For example, an application on host system 14a may make a request of a site, such as Travelocity, which may also use the services of Mapquest to provide information or data to the user's browser executing on host system 14a. In this embodiment, multiple applications may reside on multiple Internet site locations rather than at a single Internet site.

It should be noted that the foregoing are only two examples of how applications may be arranged and utilized in connection with providing services to a user in which the applications may be monitored using techniques described herein. The particular configuration as to what particular server applications reside and/or are executed on one or more computers included in the server system 12 may vary in accordance with each embodiment.

Included in this example of the server 12 of FIG. 2 are two applications 22 and 24, console 34 and Global Aggregator 36. The application A 22 includes the following application-related components: one or more application servers 26b, 28b and corresponding stream sensors 26a, 28a, a context engine 46, and one or more data files 50. Similar application-related components are also included for application B 24. Each of the foregoing included in the server system 12 are described in more detail elsewhere herein.

It should be noted that even though this example includes two applications in which each application has two application servers, the techniques described herein may be applied to other embodiments having more or fewer applications and/or application servers.

In this example in connection with application A 22, incoming and outgoing data streams pass through application servers 26b and 28b. Application server A 26b is associated with a stream sensor A 26a. As described in more detail elsewhere herein, the stream sensors are used to tap into the incoming and/or outgoing data stream of the applications. Application A 22 and application B 24 communicate over communication connection 40. The context engine 46 and the data files 50 each have one or more connections to other components associated with application A as well as other components included in the server 12. Generally, the context engine 46 is used in connection with communicating with the one or more stream sensors 26a and 28a to tap into, and extract, data of interest from the incoming data stream with respect to application A. Similar data flow is exhibited using the application B 24.

Also included in the server system 12 of FIG. 2 is the console 34 and the Global Aggregator 36. The console 34 may be used in connection with supplying rules to each of the context engines 46 and 48 indicating which data portions of interest are to be extracted by the stream sensors. Additionally, the console may configure the Global Aggregator to gather data collected locally by each application. The Global Aggregator 36 may then aggregate, summarize or transform the gathered data from the one or more applications within the server system 12 to present a more global view of the processing performed by applications A and B collectively in connection with a single transaction or business process. The console 34 has external connections 42 to other components included in the server system 12 as will be described herein in more detail. Similarly, the Global Aggregator 36 also has external connections 44 to other components included in the server system 12 also described elsewhere herein in more detail.

In the embodiment described herein, each of the applications, such as application A 22, may be associated with one or more application servers. It should be noted that the one or more instances of each application server may be provided for the purpose of redundancy. The application A22 may be any application or process used in connection with providing, for example, a business service on one of the host systems such as host system 14a. In one embodiment, each application is associated with one primary application server and associated stream sensor. In this embodiment, any additional instances of the application servers and associated stream sensors may be used for the purpose of redundancy in the event that the primary application server and/or stream sensor is unavailable, off-line, and the like.

The application server may be any one of a variety of different well known application servers, such as IBM WebSphere, BEA WebLogic, Microsoft.net, and the like. As known to those skilled in the art, each of the application servers provides a standard plug-in interface that may be used in connection with facilitating communications between the application server and each of the stream sensors. For example, in connection with the foregoing Microsoft.net application server, the application server uses the well known Internet Information Services (IIS) server. This server provides a plug-in architecture using the Internet Server Application Programming Interface (ISAPI) (as described at http://msdn.microsoft.com/library/default.asp?url=/library/en-us/iisref/htm/ISAPIRef_Filters.asp), as well as other mechanisms. It should be noted that different functionality may be included in each of the different versions and may affect the particular functionality included in an implementation of the stream sensor for an embodiment. For example, in one version of IIS, insufficient information may be provided in the ISAPI and an embodiment of the Stream Sensor may be utilized that is layered on .NET directly to support this version of an IIS server. Other foregoing application servers are implemented in accordance with the Java Second Enterprise Edition (J2EE) technology and architecture. In connection with the J2EE servers, the stream sensor may be implemented using the JAX-RPC handler, for example, (as described at http://java.sun.com/j2ee/1.4/docs/api/javax/xml/rpc/handler/package-summary.html) in conjunction with servlet filters (described at http://java.sun.com/j2ee/1.4/docs/api/javax/servlet/http/package-summary.html). An embodiment using one of the foregoing application servers allows the stream sensor associated with each of the application servers to execute within the same process address space as each corresponding application server. In this embodiment, each stream sensor may be used to selectively filter out data from each incoming XML message to an application.

The console 34 may be used in connection with performing administrative and/or monitoring tasks. The console sends configuration calls in the form of web-service requests which are described in more detail elsewhere herein. Using the configuration rules provided by the console to the stream sensor through the use of the context engine, the stream sensor selectively filters the incoming data stream for each XML message sent or communicated to the application. Various components associated with application A 22 are used in connection with monitoring and collecting the data which is then communicated to the console 34. Through the use of the console 34, a user may enter new rules and/or modify existing rules affecting the data being collected.

In this embodiment, it should be noted that each application server, such as 26b, processes the incoming and/or outgoing data streams in accordance with the rate at which the data stream is received by the application server. In other words, the application server 26b in combination with the stream sensor 26a process the incoming data stream such that the rate at which the incoming data stream is received by application A 22 is not adversely affected in a significant way. As such, the stream sensor 26a of this embodiment may be characterized as lightweight such that the stream sensor operates efficiently. Details of the stream sensor 26a and other stream sensors used in connection with other application servers included in the server 12 are described in more detail elsewhere herein.

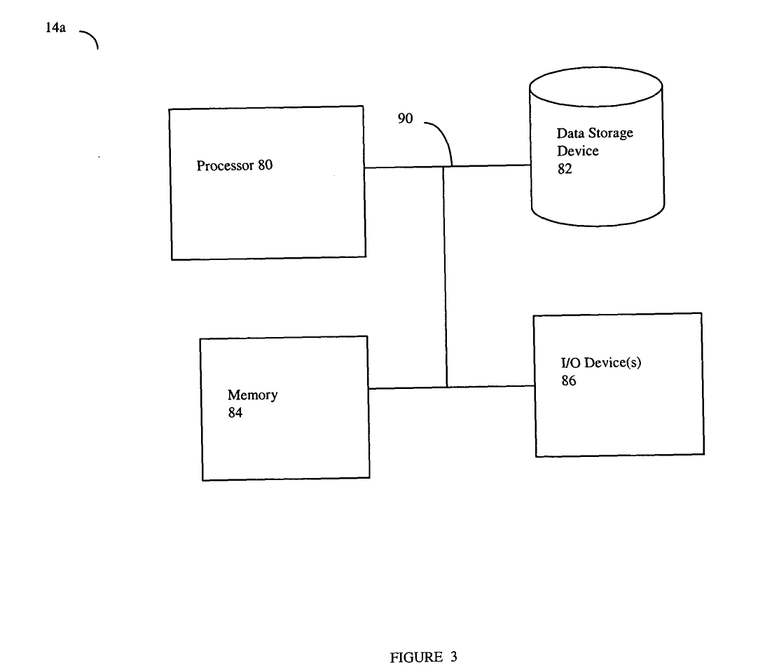

Referring now to FIG. 3, shown is an example of an embodiment of a host or user system 14a. It should be noted that although a particular configuration of a host system is described herein, other host systems 14b-14n, as well as one or more computers included in the server 12, may also be similarly configured. Additionally, it should be noted that each host system 14a-14n and computer in the server 12 may have any one of a variety of different configurations including different hardware and/or software components. Included in this embodiment of the host system 14a is a processor 80, a memory, 84, one or more I/O devices 86 and one or more data storage devices 82 that may be accessed locally within the particular host system. Data may be stored, for example, on magnetic, optical, or silicon-based media. The particular arrangement and configuration of data storage devices may vary in accordance with the parameters and requirements associated with each embodiment. Each of the foregoing may communicate using a bus or other communication medium 90. Each of the foregoing components may be any one of more of a variety of different types in accordance with the particular host system 14a.

Computer instructions may be executed by the processor 80 to perform a variety of different operations, such as execute instructions of a Web browser application. As known in the art, executable code may be produced, for example, using a loader, a linker, a language processor, and other tools that may vary in accordance with each embodiment. Computer instructions and data may also be stored on a data storage device 82, ROM, or other form of media or storage. The instructions may be loaded into memory 84 and executed by processor 80 to perform a particular task. In one embodiment, the host or user system 14a may include a browser used to communicate with the server system 12.

A computer processor included in the server system 12 may be used to execute instructions implementing the techniques and functionality described in connection with components of the server system 12 and the filtering and/or monitoring techniques described herein.

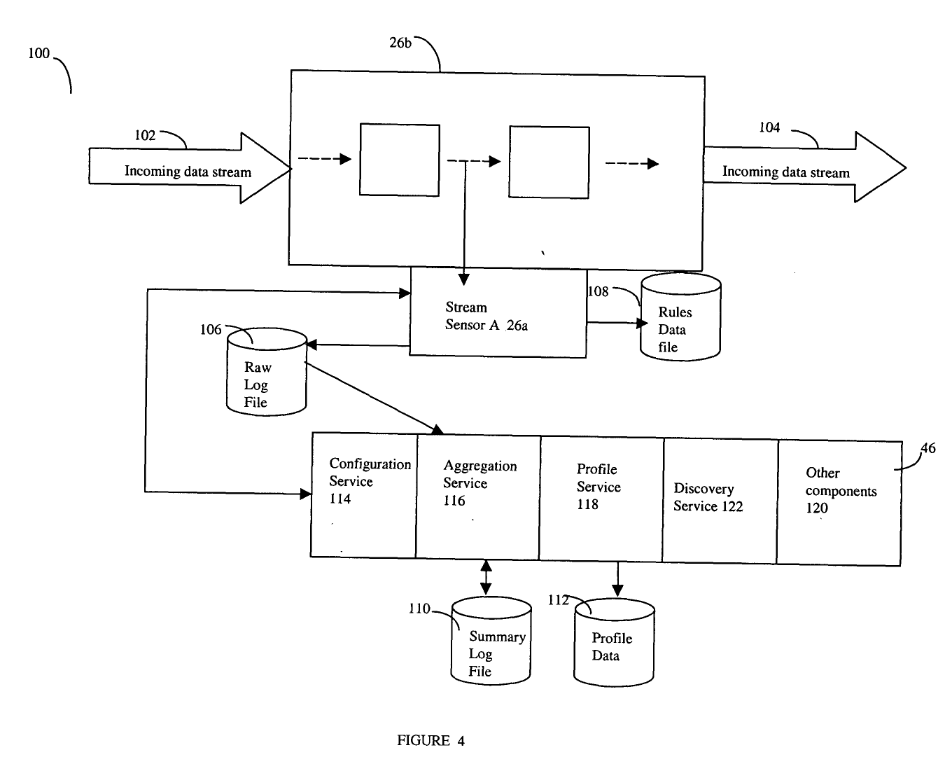

Referring now to FIG. 4, shown is an example 100 illustrating the data flow in more detail between an application server and some of its application related components described previously in connection with FIG. 2. In particular, shown in the example 100 of FIG. 4 are more details of the data flow between the files 50, the context engine 46, the stream sensor 26a and the application server 26b previously described in connection with application A 22. It should be noted that although the description of the example 100 and the components of FIG. 4 relate to one of the application servers of application A 22, similar description and data flow also apply to additional application servers of application A22 and application B 24.

Incoming data to the application server 26b is “tapped” by stream sensor A 26a such that the incoming data stream is filtered to copy selected data of interest in accordance with the rules included in the rules file 108. An output of the stream sensor A 26a is the raw log file 106. In this embodiment, the raw log file 106 includes the raw or unprocessed data gathered by the stream sensor A from the incoming XML message stream 102 to the application server 26b. It should be noted that the incoming data stream 104 passing out of the application server 26b is a combination of the input and the output data streams with respect to the application A 22. Although FIG. 4 illustrates filtering and monitoring of only the incoming data stream, the techniques and concepts described herein may also be performed on the outgoing data stream.

In connection with the techniques described herein is rule specification processing and runtime data monitoring. The rule specification processing may be performed by specifying an initial set of rules, as well as an updated or revised set of rules in accordance with any revised data selections and/or conditions specified by the user, for example, using the console as described elsewhere herein. The runtime data monitoring is later performed in accordance with the rules. As part of the runtime data monitoring of the application server 26b, it should be noted that the stream sensor 26a plugs into the incoming and outgoing data streams such that the stream sensor 26a filters the incoming and/or outgoing data stream in accordance with a current set of rules and extracts corresponding data during execution of the application A 22. The processing steps for rule specification processing and runtime data monitoring are described elsewhere herein in more detail.

The context engine 46 communicates with the stream sensor 26a in this embodiment using an inter-process procedure call (IPC). It should be that, as described elsewhere herein, an IPC may not be used in all embodiments. For example, the IPC may be used in communications in an embodiment using Microsoft.net. However, other embodiments may not use an IPC, for example, if processes execute in the same address space.

It should be noted that a first set of rules may be initially specified and that a revised set of rules may be specified while the application is executing, such as in connection with providing a service. In this embodiment, rule revisions and updates as communicated to the Configuration Service 114 are communicated to the stream sensor A using an IPC channel. Other embodiments may use other techniques in connection with communication between components.

In this embodiment, the context engine 46 includes a Configuration Service 114, an Aggregation Servicel 16, a Profile Service 118, a Discovery Service 122, and may optionally include other context engine components 120. The rules indicating which data portions of the incoming data stream are of interest are received by the Configuration Service 114 from the console and forwarded to the stream sensor where they are stored locally with respect to the stream sensor in the rules data file 108. The stream sensor A 26a then filters the data stream using these rules producing the raw log file or files 106. The Aggregation Service 116 may process the raw log files 106 to provide callers with a view of the operation of the application.

Initially, a set of rules may be sent from the console to the Configuration Service 114, for example, in connection with initialization or setup of the system. An initial version of the rules data file 108 may also be established and/or transmitted using other techniques as well. Subsequently, during execution of applications on the server system, rules may be updated. The console may communicate the rule updates to the Configuration Service 114 as may occur from time to time during execution of the components included in the server system 12. The particulars of the data messages being monitored and the format of the rules as well as their generation and maintenance are described elsewhere herein in more detail. However, it should be noted at this point that the rules may be used in connection with monitoring the incoming and outgoing data streams for any one or more occurrences of a variety of different data items. For example, the incoming data stream may be monitored to extract specific fields of information of an XML message with regard to a particular customer as indicated, for example, by a customer identifier. Additionally, rules may be used to perform this monitoring of a particular data field for customers for a time period determined dynamically in accordance with the incoming data stream. For example, data may be monitored for a particular customer upon the occurrence of a particular transaction start and end. The transaction start and end may be dictated by a particular message(s).

As described herein, a single transaction may be, for example, performing a particular customer operation or other administrative operation. A single transaction may be associated with one or more XML messages in this embodiment. As an example, a single transaction may be associated with obtaining inventory status, reserving a particular quantity with an ordering system, and also shipping an item in connection with a purchase. All of these tasks may be associated with performing a single transaction, such as in connection with making a purchase from an on-line book vendor's website. The techniques described herein may be used in connection with gathering information from an incoming and/or outgoing data stream in accordance with the different operations performed for transactions.

In connection with detecting the beginning and ending of transactions, the Aggregation Service 116 may process the raw log file data to gather and/or reorganize requested data related to each particular transaction. As an output, the Aggregation Service 116 produces the summary log file including the processed raw transactional data presented in summary form. The summary log file 110 may be used as an input to the console 34 previously described in connection with FIG. 2. The Aggregation Service may be used to combine and gather data in accordance with any one or more different criteria, such as per transaction, for summaries at predetermined time intervals, and the like.

In one embodiment, the console 34 may copy summary log file information 110 from each of the application-related components as needed. For example, the console and/or Global Aggregator may be used in displaying information regarding transactions on a particular application. In connection with this processing, the console and/or Global Aggregator may copy data from one or more summary log files 110.

It should be noted that the raw log file 106 as well as the other data files described in connection with the example 100 may be stored in any one of a variety of different file configurations and/or directory hierarchies as well as on any one or more of a variety of different devices. For example, in one embodiment, the raw log file 106 may be stored as a flat file on a disk or other device included in the embodiment.

The Profile Service 118 stores console information such as what information or data is being monitored for a given console 34. It should be noted that an embodiment may include multiple consoles other than the single console 34 described in connection with FIG. 2. The profile data 112 may be stored per console and may include a description of the data view(s) being monitored for each application from each particular console. For example, a first user on a first console may select a first set of data to be filtered and monitored from an application's incoming and outgoing data streams. A second user on a second console may select a second set of data to be filtered and monitored from an application's incoming and outgoing data streams. The profile data may store the first set of data selections associated with the first console and the second set of data selections associated with the second console. When supplying information, for example, to one of the consoles, the profile data may be used in connection with the summary log file data 110 to provide the console with the selected data items for that particular console.

The Discovery Service 122 may be used in connection with communicating with the console and stream sensor during configuration to provide information about the services performed by the application, as described elsewhere herein in more detail.

The Aggregation Service 116 in one embodiment has an interface such that a user may enter a query. In response, the Aggregation Service may query a summary log file 110 or any of the generated raw log files to present an aggregated view of a transaction.

It should be noted that the Global Aggregator 36 in one embodiment may also include a query interface similar to the Aggregation Service 116. The Global Aggregator 36 may be used in observing or gathering data from multiple stream sensors of one or more applications by examining data from a plurality of Aggregation Services. Each of the Aggregation Services may be characterized as providing and gathering data from several of the Aggregation Services. The Global Aggregator may be characterized as gathering data from each of the Aggregation Services and/or consoles. The Global Aggregator may be used to provide a more global data view of a service performed by one or more applications as monitored by one or more associated stream sensors.

Although the embodiment 100 only shows a single instance of a summary log file 110 and a single instance of a raw log file 106, an embodiment may include multiple instances and types that vary with each embodiment. For example, there may be a first raw log file that includes data on errors and a second raw log file that includes data filtered from the application data stream.

As mentioned above, the data stream in this embodiment as input to the stream sensor is in the form of XML messages, for example, including service requests, responses, or parts of a document being exchanged. The rules may be initially specified and also may be later modified in real-time, for example, as communicated to the console through the use of a user interface. The rules are used in specifying the context of the data streams to be monitored. Context may include, for example, message origin, message headers, Web Service methods being invoked, message parameters, message metadata, transactional information, and the like. Use of the rules as described herein facilitates dynamic content capture of the XML messages in the data streams examined.

Described in following paragraphs are techniques for specifying, evaluating and translating these rules as may be used in context-based filtering. The system described herein determines the context of what data is captured by applying the rules to the XML stream and appropriate metadata of the incoming data stream. The filtering performed, as by the stream sensors described above, may be characterized as being dependent on the contents of the data stream itself. In other words, the data stream may dynamically modify the context settings of what data to collect, if any, throughout the data stream.

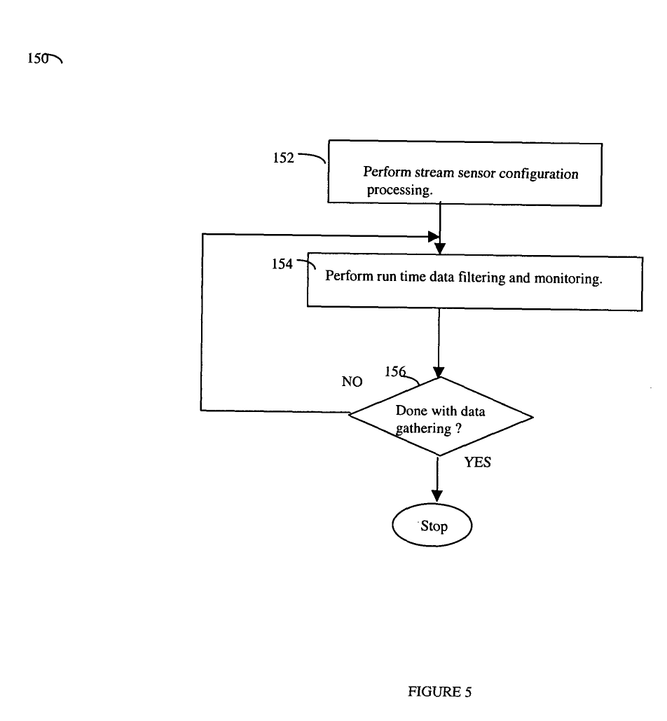

Referring now to FIG. 5, shown is a flowchart 150 of steps that may be performed in one embodiment for gathering and filtering data. At step 152, stream sensor configuration processing is performed. As part of configuration of the stream sensor, a set of rules for the rules data file 108 is specified. In one embodiment as described in more detail in following paragraphs, a set of rules may be specified by a user using a console. At step 154, runtime data filtering and monitoring are performed in accordance with the current set of rules. This is also described in more detail elsewhere herein. At step 156, a determination is made as to whether data gathering is complete. If so, data gathering stops. Otherwise, control proceeds to step 154 to filter and gather additional data from the data stream in accordance with the current set of rules.

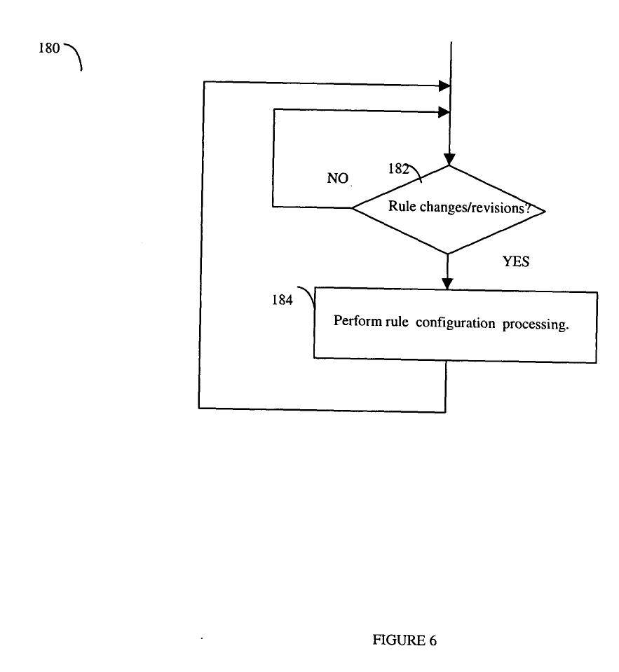

Referring now to FIG. 6, shown is a flowchart 180 of processing steps performed in one embodiment in connection with rule specification after a set of rules has been specified. At step 182, a determination is made as to whether there has been a rule change or revision. If so control proceeds to step 184 to perform rule configuration processing. Otherwise, processing waits at step 182 until a rule revision is made. The steps of flowchart 180 may be performed by the stream sensor.

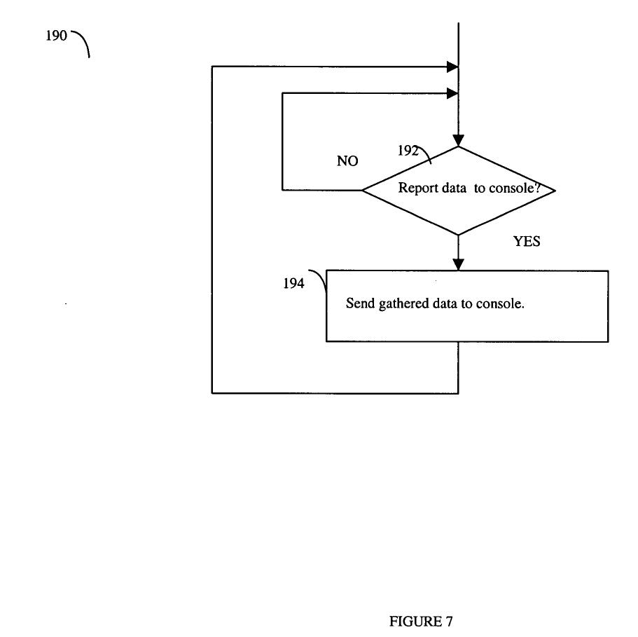

Referring now to FIG. 7, shown is a flowchart 190 of processing steps performed in one embodiment in connection with data reporting. The steps of flowchart 190 may be performed by an Aggregation Service, for example, in connection with reporting data to a user at a console. At step 192, a determination is made as to whether there has been a request for reporting data gathered by the stream sensor. If so control proceeds to step 194 to perform data reporting. Otherwise, processing waits at step 192 until a report request is made.

In one embodiment, the steps of flowchart 180 to specify a new set of rules are performed within the stream sensor, and between the stream sensor and other components, while the stream sensor is gathering and filtering data in accordance with an existing set of rules. The steps of flowchart 180 may be performed after the existing or initial set of rules is specified as part of processing of step 152. Subsequently, rule revisions may be made while data is being filtered and gathered. The steps of flowchart 190 may be performed after initialization and may also be performed while data filtering is ongoing. It should be noted that other processing steps may also be performed within an embodiment of the system 10 of FIG. 1.

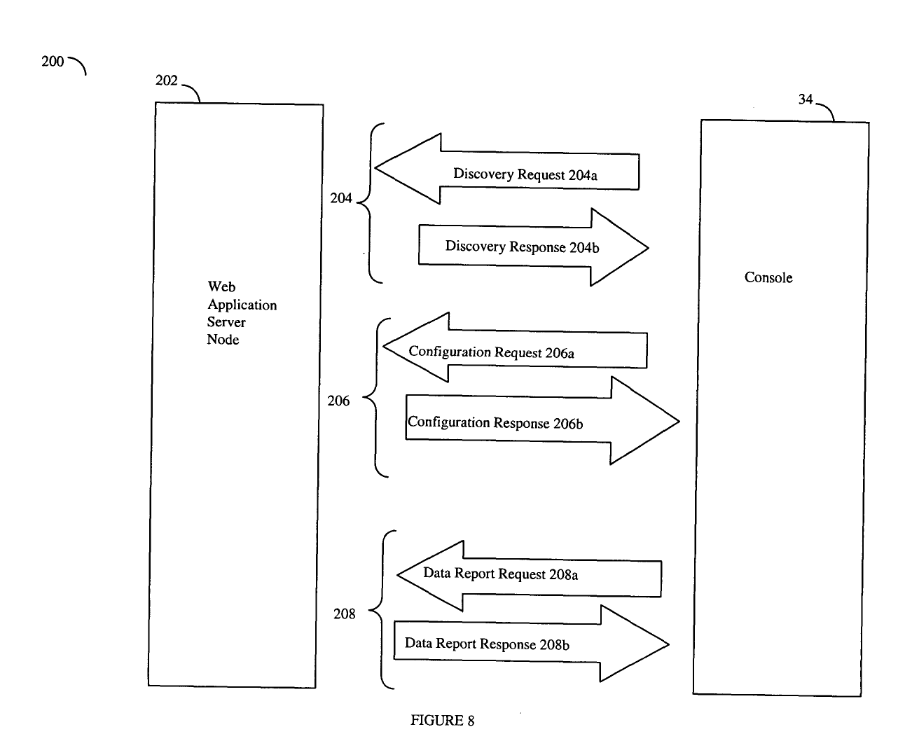

Referring now to FIG. 8, shown is an illustration 200 of messages that are exchanged in one embodiment between a web application server node 202 and the console 34. The message exchanges illustrated are used in one embodiment in connection with processing, as in step 152 including rule specification processing, and data reporting. The web application server node 202 may be, for example, a node within the server 12 included in the embodiment 10 of FIG. 1. The web application server node 202 may include one or more applications which are associated with one or more associated application servers and stream sensors and provide services to a requester. A user may log onto a node within the server system 12 that may be used as a console. From the console, the user may then view information regarding one or more applications on the web application server node 202 in order to select one or more data items to be monitored with respect to the data stream associated with each application.

In connection with stream sensor configuration, the console 34 may issue a discovery request 204a to the web application server node 202. The discovery request 204a may be characterized as a request for information about web services provided by the web application server node 202. The web application server node 202 responds to the discovery request 204a by sending a discovery response 204b. The discovery response 204b may be, for example, a message including information as to what services, data items, and the like are provided by the one or more applications within the web application server node 202. In one embodiment, the web application server node 202 may include in the discovery response 204b information from one or more WSDL files. It should be noted that WSDL is a well-known industry standard. As also described elsewhere herein, the WSDL file may be characterized as defining the behavior of a web service providing instructions to a potential client of the web service regarding how to interact with the web service. The WSDL file is an XML document. The WSDL file may include, for example, a description of the messages and data items that may be exchanged between web services provided by the web application server node 202 and the console 34. The WSDL file may include, for example, descriptions of the protocol or message exchanges included in the illustration 200 of FIG. 8. It should be noted that other embodiments may use other techniques in connection with providing information in connection with a discovery request and response.

After the console 34 receives the information in the discovery response 204b, the console 34 may display this information to a user, for example, on an output device such as a terminal or other display device. The data that is displayed on the console 34 may include, for example, the names of one or more applications of the web application server node 202 providing a web service and associated data items and associated conditions that a user may select for data monitoring and/or filtering purposes. At this point in processing, a user may select from the displayed data items those items which the user wants to monitor and gather information about in connection with an incoming and/or outgoing data stream of the one or more applications of the web application server node 202. Console 34 may include software that displays this information, for example, in a graphical user interface (GUI). The user may select one or more data items for each of one or applications residing on the web application server node 202. The console takes the data selections made by the user, for example, using an input device such as a mouse, and prepares a message that is sent to the web application server node 202. In connection with the illustration 200, the one or more user selections as collected by the console software 34 are included in a configuration request 206a sent to the web application server node 202. In response to receiving the configuration request 206a, the web application server node 202 sends a configuration response 206b to the console acknowledging receipt of the request 206a.

As described above, the discovery request 204a, discovery response 204b, configuration request 206a, and configuration response 206b may be characterized as message exchanges used in configuration of a stream sensor which includes specifying a set of rules for later application and evaluation. The stream sensor is included in the web application server node 202 and is configured in accordance with a particular set of selections made by a user from a console. The user selection of data or messaging items to be monitored in connection with a web service provided by an application that is included in a configuration request 206a may be transformed into rules included in the rules data file 108 as described elsewhere herein. The message sets 204 and 206 exchanged between a web application server node 202 and the console 34 are the messages that may be exchanged in an embodiment in performing the processing of step 152 of FIG. 5. The message set 204 may be exchanged between a web application server node and the console 34 in connection with specifying an initial set of rules, and also in connection with specifying a revised set of rules, as in connection with flowchart 180 of FIG. 6. The message set 208 may be exchanged between a web application server node and the console 34 in connection with reporting data filtered from the data stream using the stream sensor, as in connection with flowchart 190.

Once a set of rules is specified, the stream sensor applies those rules in connection with monitoring the data stream of an application's requests handled by the application server. At some point in time later, the stream sensor on the web application service node associated with an application uses the rules in filtering the application's data stream and gathers data. The console 34 may contact the Aggregator Service to view some report on the state of the Application server in accordance with the gathered data.

An embodiment may also send information from the web application server node 202 to the console 34 at times other than in connection with responding to a particular data report request. For example, a console 34 may initially send a message to the web application server node 202 requesting gathered data at pre-defined time intervals resulting in more than one data report response 208b sent from the web application server node 202 to the console 34. In another embodiment, the web application server node may automatically provide information in accordance with certain default conditions understood between the web application server node and the console 34 without the console 34 sending a particular data report request 208a. It should be noted that an embodiment may use different or additional message exchanges than as described in this illustration 200.

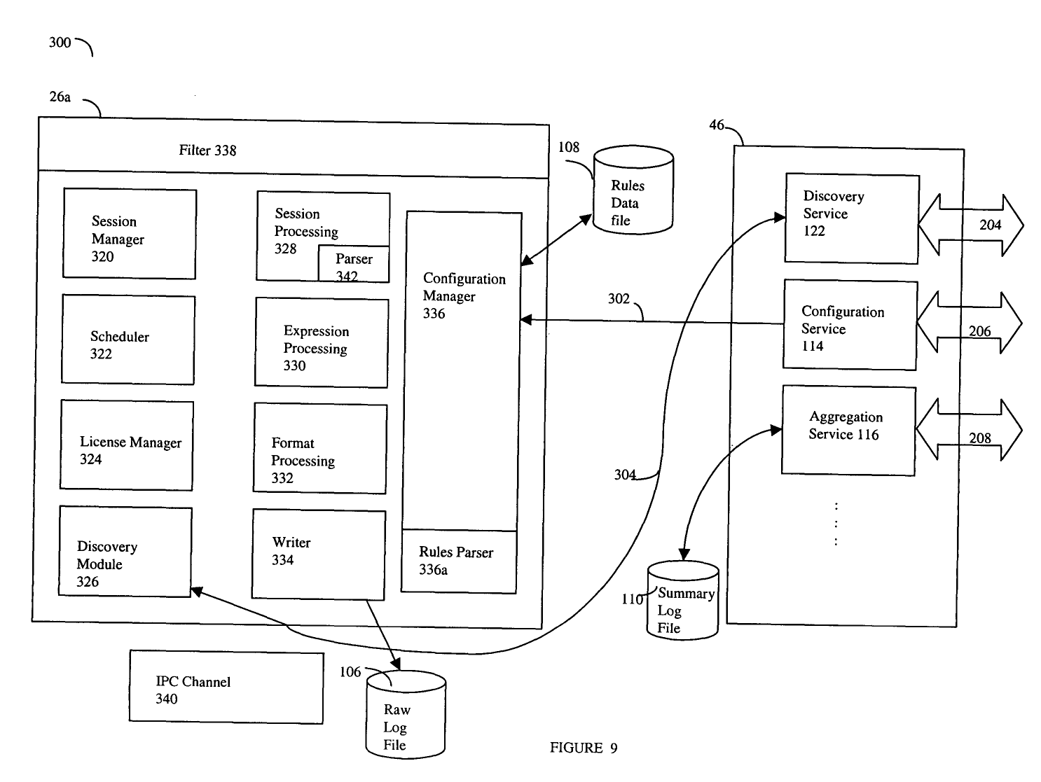

Referring now to FIG. 9, shown is an example 300 of components that may be included in an embodiment of the stream sensor 26a and the context engine 46. In the example 300, the stream sensor 26a includes a filter 338, a session manager 320, a scheduler 322, a license manager 324, a discovery module 326, a session processing module 328, an expression processing module 330, a format processing 332, a writer module 334, and a configuration manager module 336. Also shown associated with a stream sensor 26a is the IPC channel 340. It should be noted, as described elsewhere herein, whether an IPC channel is included in an embodiment and used for IPC may vary in accordance with each embodiment and implementation. In one embodiment using Microsoft.net, an IPC channel may be used that is layered on top of Windows Named Pipes (as described at http://msdn.microsoft.com/library/default.asp?url=/library/en-us/ipc/base/pipes.asp) to communicate between the Discovery and Configuration Services and the Stream Sensor. This IPC channel has a server component that is just another module in the Stream Sensor and a client component that is a module in the Configuration and Discovery Services. In the case of a J2EE implementation, there is no need for an IPC channel because the Stream Sensor and the Configuration and Discovery Services reside on the same process and share the same address space. It should be noted that components included in stream sensor 26a of the example 300 may represent only a portion of those included in an embodiment of the stream sensor.

Shown in the example embodiment of the context engine 46 are the Discovery Service 122, the Configuration Service 114, and the Aggregation Service 116. The components shown in the illustration 300 of the context engine 46 are also described in more detail in connection with FIG. 4 elsewhere herein. The particular components of the context engine 46 shown in the illustration 300 are only a portion of those components that may be included in an embodiment of the context engine 46.

What will now be described are the particular components within each of the context engine 46 and the stream sensor 26a that may be utilized in an embodiment in connection with the previously described message exchange protocol of 204 and 206.

The messages 204 may be communicated between the Discovery Service module 122 of the context engine 46 and the console 34. The discovery request message 204a is received by the Discovery Service 122. In one embodiment, the Discovery Service 122 invokes the discovery module 326 of the stream sensor 26a in order to obtain information regarding the services, data items, message protocols, and the like, that are provided in connection with application services associated with the stream sensor 26a. The discovery module 326 may, for example, obtain information from the configuration store of the application server and other sources, and transmit the information from the discovery module 326 to the Discovery Service 122. The Discovery Service 122 may provide the service information in the form of a discovery response 204b sent to the console. An incoming configuration request 206a may be forwarded to the Configuration Service 114 which then forwards the data in the configuration request 206a to the configuration manager 336 of the stream sensor. The configuration manager 336 stores the data from the configuration request 206a as rules in the rules data file 108. The Configuration Service 114 of the context engine 46 may return as an acknowledgement the message 206b to the console confirming that the message 206a has been successfully received and processed.

It should be noted that the foregoing messages 206 and associated processing steps may also be performed in connection with updating the data items to be monitored producing a new set of rules. For example, an initial set of rules may be formed in connection with a first selection of data items and conditions specified by the user from the console 34. Data is collected from the data stream of the application associated with the stream sensor 26a. Sometime later, the user may decide to alter the data being gathered and monitored by the stream sensor 26a. Accordingly, the user may specify that different data items are to be monitored. The user may also specify different conditions for evaluation affecting when the stream sensor gathers particular data items specified. The different set of conditions and associated data items to be gathered by the stream sensor 26a may be specified in a second set of rules. More details about rule specification processing are described elsewhere herein.

As part of initialization, the discovery module 326 determines what services are available on the application server associated with the stream sensor 26a.

In connection with the message exchange 208, a data report request 208a sent by a console may be received by the Aggregation Service 116 of the context engine. The Aggregation Service 116 may gather data from the summary log file(s) and/or raw log file(s) in accordance with a report request 208a and send the requested data in the form of a response 208b. It should be noted that an embodiment may also have a separate report service included in the context engine 46 to handle report requests and responses associated with the message exchange 208.

Each of the components of the stream sensor 26a of the illustration 300 is now described in more detail.

In connection with the rule specification processing, the configuration manager 336 stores the rules in the rules data file 108 in accordance with the data selections and conditions included in the message 206a. The rules are parsed by the rule parser 336a included within the configuration manager 336. It should be noted that the rules data file 108 in this embodiment may include rules specified in human readable form. The rules 108 may be transformed into another form used internally within the stream sensor 26a to facilitate processing described elsewhere herein. It should be noted that rules used in an embodiment may be stored in forms other than as described herein.

Once a set of rules has been specified, the configuration manager 336 notifies the session manager 320 as to the incoming set of rules. The session manager 320 assesses the incoming set of rules, and performs rule configuration or preparation steps such that, at some later point, the incoming and outgoing data streams being monitored and filtered may be processed in accordance with the new set of rules. In this particular embodiment, session processing 328, expression processing 330, format processing 332, and one or more writers 334 include functionality to execute in a first mode for rule configuration when defining a first or subsequent set of rules, and a second mode for filtering and monitoring at runtime when processing a received message in accordance with the current set of rules. Configuration manager 336 is responsible for alerting the session manager 320 when a new set of rules is received such that the session manager may perform any needed rule configuration processing. Rule configuration processing may include performing steps necessary to ensure proper handling and processing of the data stream in the second mode at runtime, such as creating new object definitions as needed in accordance with the new rules to perform gathering and monitoring of selected data items. The writer 334 may generally be characterized as producing output. In one embodiment, this may include having a file writer producing output to a log file 106, or other file of a file system, representing the data that has been gathered or monitored in accordance with selections. Other kinds of writers include event log writers which send output to a system event log, as may be included in a Microsoft.net embodiment, or a system log (syslog) in a J2EE-based embodiment. An embodiment may also include other types of writers that may, for example, send output, such as e-mail or web-service messages, on a network. As described elsewhere herein in more details, writers may also aggregate results and them to other writers. Within the session processing module 328 is a parser 342 that is used in one embodiment to parse the input and output streams of the application server. Each of the components 328, 330, 332, 342, and 334 are also described elsewhere herein in more detail.

It should be noted that in connection with the illustration 300, an embodiment may include more than one set of object definitions and methods in accordance with the number of rule versions currently in use by session objects. For example, once there has been a re-specification of a new set of rules, there may be multiple definitions for each of the different data objects if multiple versions of the rules are currently in use by different session objects. Accordingly, each of the session processing modules 328, expression processing module 330, format processing module 332, and one or more writer modules 334 also include functionality for operating on each object definition in connection with the second mode of data filtering. Examples and further description of having multiple versions or sets of rules at any point in processing is described elsewhere herein.

The scheduler 322 may be used in connection with scheduling various services such as scheduling one or more processes for execution for performing various tasks. For example, the scheduler 322 may schedule the license manager 324 to be executed at predetermined time intervals such that the license manager 324 may perform processing steps in connection with checking any licensing requirements for the stream sensor 26a. The scheduler 322 may also schedule when log files 106 are rolled over for purposes of maintenance, and the like.

It should be noted that the foregoing components of the illustration 300 are only one particular embodiment of the stream sensor 26a and the context engine 46. For example, the components of the illustration 300 may include an ISAPI filter as the filter 338 in connection with a Microsoft-based implementation. An embodiment may also use a combination of a JAX RPC handler and Servlet Filter as the filter 338 in an implementation using J2EE. In a J2EE implementation, the parser 342, the IPC channel 340, and the discovery module 326 may be omitted from the list of components included and used with the stream sensor 26a. In a J2EE implementation, the discovery module may be included in the Discovery Services in an embodiment. This is in accordance with how this particular implementation operates. Also, when parsing an application's data stream, a parser 342 is not needed with a J2EE implementation since the incoming data stream has already been parsed. In contrast, in connection with a Microsoft.net implementation using the ISAPI filter, the incoming data stream to the stream sensor is not already parsed. Accordingly, in this embodiment using the ISAPI filter, parsing techniques of the parser 342 may be used in connection with parsing received XML messages in the second mode for data filtering. What is described in herein in connection with FIG. 9, for example, is an implementation using the ISAPI filter. However, this should not be construed as a limitation of the techniques described herein since these techniques may be used in connection with other implementations.

The filter 338 in one embodiment is an ISAPI filter that is registered to be notified and sent the incoming data stream and outgoing data stream associated with a particular application server. In this example embodiment, the filter 338 is registered within IIS to be notified in connection with HTTP requests. The data is captured and sent to the filter 338 associated with the data stream. The registration may be performed as part of initialization of the stream sensor.

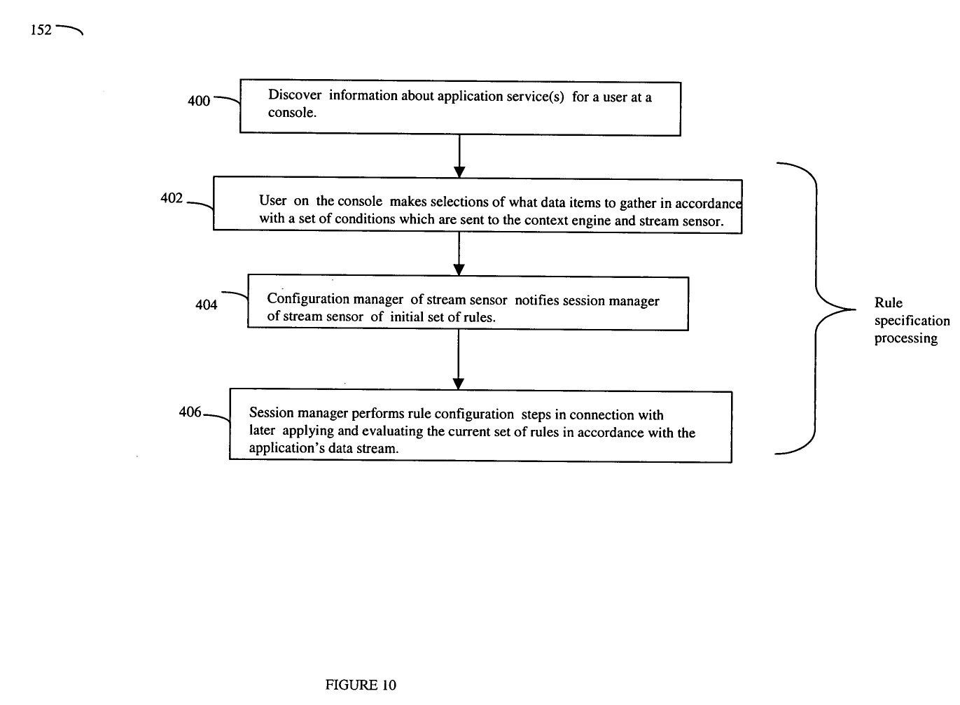

Referring now to FIG. 10, shown is the flowchart of steps of an embodiment for performing stream sensor configuration including rule specification processing. Flowchart 152 of FIG. 10 sets forth more detailed steps associated with previously described step 152 of FIG. 5. Additionally, the processing steps of FIG. 10 summarize the processing also described in connection with FIGS. 8 and 9. At step 400, information about application services are discovered for presentation to a user at a console. At step 402, the user on the console makes selections of what particular data items to gather in accordance with a set of one or more conditions. The data items and conditions are sent to the context engine and stream sensor in the form of rules. In one embodiment as described herein, the rules may be in the form of an XML message. At step 404, the configuration manager of the stream sensor notifies the session manager of the stream sensor of the initial set of rules. At step 406, the session manager performs rule configuration steps in preparation for later applying and evaluating the current set of rules in accordance with the application's data stream. It should be noted that steps 402, 404, and 406 are included as part of rule specification processing described elsewhere herein. The rule specification processing steps 402, 404, and 406 may also be performed at a later point in time, for example, in connection with revising a set of rules, for example, when the user makes subsequent selections or revisions of data items to be gathered and monitored. The processing of step 406 includes performing parsing by the rules parser 336a also described elsewhere herein.

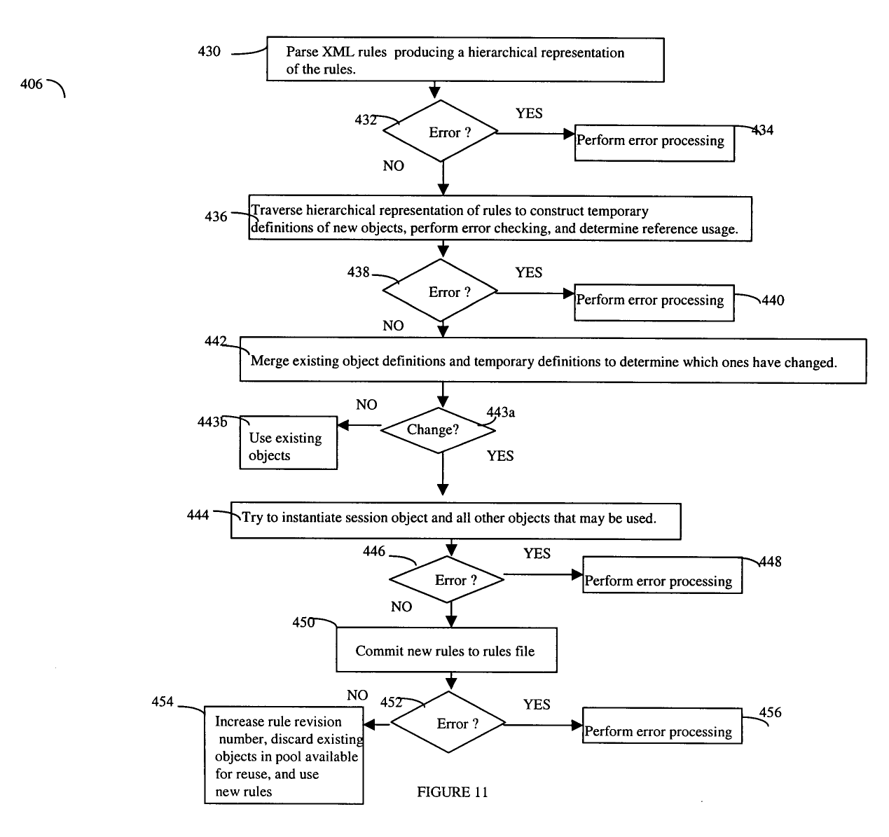

Referring now to FIG. 11, shown is a flowchart 406 setting forth more details of rule configuration processing as described in connection with step 406 of FIG. 10. Generally, as used and described herein, rule configuration processing may be those steps performed prior to filtering and monitoring an application's data stream at runtime, for example, when the application is performing a service or operation. The rule configuration processing includes steps performed by the stream sensor in preparation for subsequent filtering of the data stream as forwarded to a filter as in connection with the first mode of operation described elsewhere herein. This first mode of processing may also be performed in connection with specifying a subsequent new set of rules as well as the first initial set of rules. At step 430, the XML rules are parsed producing a hierarchical representation of the rules using the rules parser 336a included in the configuration manager 336 of FIG. 9. In one embodiment, the rules parser 336a is a Document Object Module (DOM) XML parser used in connection with parsing the rules which are in the form of an XML file as received from the console. DOM is described, for example, at http://www.w3.org/DOM. The XML file in this embodiment that includes the rules in accordance with a defined hierarchy is described elsewhere herein referred to as an Object Definition Format File (ODF file). As known in the art, the DOM XML parser produces a tree-like structure that may be characterized as a hierarchical structure of the XML rules. At step 432, a determination is made as to whether an error has occurred in connection with the parsing. If so, control proceeds to step 434 where error processing is performed. This may include, for example, sending an error to the console which may be displayed upon a user's display device. Other embodiments may perform other error processing at step 434. If at step 432 no error has been detected in connection with parsing, control proceeds to step 436 where a traversal of the hierarchical representation of the parsed rules is made in connection with performing several tasks. First, temporary definitions of new data objects or data structures are created in accordance with the new rules. For example, an expression as used within a rule may be expanded to utilize a complex expression not included in a previous rule version. Accordingly, the expression data structure or object may need to be redefined to be used in subsequent processing in accordance with the new rules. Additionally, as part of step 436 processing, error checking may be performed. Error checking may include, for example, some form of validation processing of the semantic and/or other syntactic checking of the rules. For example, type checking of parameters may be performed as well as a determination as to whether a correct number of parameters has been specified for a rule. Additionally, as part of step 436 processing, reference usage of defined elements within the rules data may be performed. As part of determining reference usage, for each definition, for example, of an expression, step 436 determines if the definition is actually referenced or used in any other elements of statements. If a definition is made but is never used or referenced, the definition of the expression may not be considered in an embodiment when producing a new data structure or object definition to take into account this more complex expression. In other words, reference usage determination provides for constructing temporary definitions of new data structures and objects to be used in accordance with references made to a defined element within the rules being analyzed. At step 438, a determination is made as to whether an error has occurred in step 436 processing. If so, control proceeds to step 440 where error processing may be performed similar to that as described in connection with step 434.

If at step 438 it is determined that no error has occurred, control proceeds to step 442 where existing object definitions and the new set of temporary object definitions are merged to determine which object definitions have changed. Step 442 results in a determination as to which object definitions or data structures used in connection with processing rules have been modified in accordance with the new set of rules. As a result of step 442 processing, a determination is made at step 443a as to whether there has been a change in object definitions. If not, control proceeds to step 443b where existing objects may be used. It should be noted that in connection with step 442, if there is no existing object definition, as may be the case with an initial set of rules being specified, steps 442, 443a, and 443b may be omitted from processing in an embodiment.

If step 443 results in a determination that object definitions have changed, control proceeds to step 444 where the session manager 320 attempts to instantiate the new session object and all other objects that may be used by the session object. At step 446, a determination is made as to whether an error has occurred in the instantiation of step 444. If so, control proceeds to step 448 where error processing is performed. Otherwise, control proceeds to step 450 where the new rules are committed to the rules data file 108. In performing step 450 processing, the session manager module 320 may forward the new set of rules to the configuration manager for storage in the rules data file 108. In one embodiment, the rules data file 108 may be a form of persistent storage. If an error is determined at step 452, error processing is performed at step 456. It should be noted that in one embodiment, the error processing steps may vary in accordance with the techniques used for implementation of the rules data file. For example, in one embodiment, an error that occurs after a commit operation has been initiated does not result in a roll back. However, other error processing and/or recovery may be performed. At step 452, if no error has occurred in connection with committing the new set of rules to the rules data file 108, control proceeds to step 454 where the rule revision number is increased as associated with a current set of rules. Additionally, an embodiment may discard any existing objects that are currently in a pool designated for reuse, such as the session object or other objects used in the prior version of the rules. The reuse of objects in an embodiment is described in more detail elsewhere herein. From this point forward, any new session objects created use the appropriate object definition associated with the new set of rules as stored in the rules data file 108.

It should be noted that at step 444, an attempt is made to instantiate the session object and all other possible objects that may be needed by a session object. Step 444 may be performed in an embodiment to try and detect as many failures as possible as part of the configuration of the rules (first mode of context engine processing) rather than at runtime when processing the data stream (second mode of context engine processing). In one embodiment, as part of step 448 processing, if an error occurs when instantiating a session object or any other new object that may be used, the temporary objects that have been constructed may be de-allocated as part of a winding down process with respect to the new rules. Additionally, the embodiment continues to use the current set of rules and associated objects or data structures due to the errors detected at step 446.

In connection with step 444 processing, what will now be described are some of the conditions that may be verified and evaluated at configuration time in connection with rule processing rather than at a later point in connection with data acquisition and filtering from the data stream. For example, as part of step 444 processing, determinations may be made with respect to a log, or other data file of a file system. It may be determined whether a writer method has the specified permissions to access a data file as needed to perform an operation, whether a particular file exists, and the like. In one embodiment, an Object Definition Format file (ODF file) may be used to specify a set of rules. As described elsewhere herein in more detail, an ODF file in this embodiment is an XML file describing interfaces, types, and objects used in performing the monitoring techniques described herein. The ODF file may include the rules as used in configuring the behavior of the stream sensor described herein. An ODF file may include any one or more elements. One of the items that may be specified in an ODF file as described elsewhere herein in more detail is an XML “encryption” element associated with a formatting section. The encryption element may be used in specifying how to format output to a log or other output destination. In one embodiment, the “encryption” element may include a parameter for a file with a key and/or specify a particular algorithm used in encrypting output. A determination may be made at step 444 as to whether the particular key file, if specified, exists or whether it may be accessed. Additionally, a determination may be made as to whether a particularly specified encryption algorithm or technique is used in this particular embodiment. Rules may be used in connection with encrypting particular output, such as personal health information, credit card information and the like.

In one embodiment, the objects or data structures may include a session object, a writer object, an expression object, and a format object. In an object oriented implementation, methods may be used in connection with performing operations using these objects. Referring back to FIG. 9, different types of objects may be operated upon by the particular processing modules. For example, the expression object may be operated upon by expression processing 330 which may include one or more expression processing methods. Similarly, the format processing module 332 and the writer processing module 334 may include one or more methods for each of, respectively, format objects and writer objects.

Once the session object and other associated objects used in an embodiment have been defined in accordance with a set of rules, data filtering and gathering of an application's data stream may be performed.

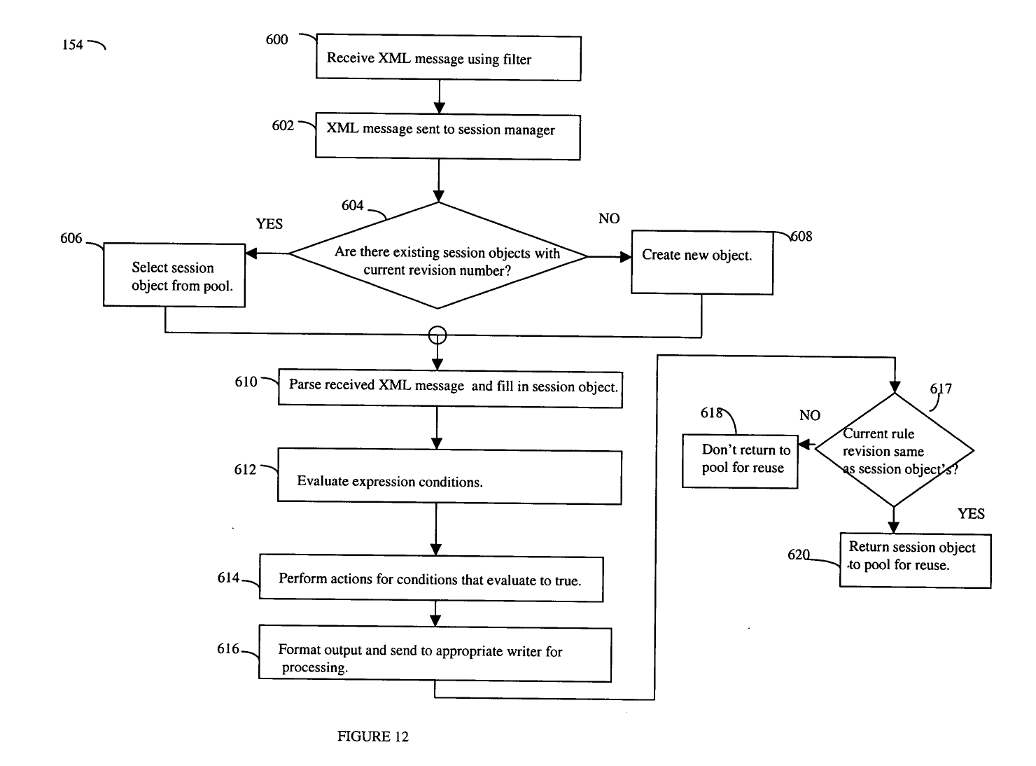

Referring now to FIG. 12, shown are more detailed processing steps that may be included in an embodiment in connection with step 154 of flowchart 150 of FIG. 5. At step 154, as described elsewhere herein, runtime data filtering and monitoring is performed on an application's data stream. At step 600, an XML message is received by the filter of the stream sensor. At step 602, the XML message is sent to the session manager module which then invokes the session manager of the stream sensor. In this embodiment, session objects may be reused. Thus, at step 604, a determination is made as to whether there is an existing session object with the current revision number. A revision number may be characterized as a data item describing a context or state associated with the current set of rules and associated objects. When the session processing module 328 completes data monitoring and gathering of an incoming data stream request, a session object may be returned to a pool of available session objects for reuse. If, at step 604, a determination may be made that there is an existing object associated with the current revision number available for reuse, control proceeds to step 606 where a session object is selected from the pool. Otherwise, at step 604, control proceeds to step 608 where a new session object is created and initialized.

It should be noted that in connection with the flowchart 154, only a session object is designated for reuse. Since the session object contains references to objects representing formats, expressions, writers, and rules, reusing the session object causes all other references objects and their associated buffers to be reused as well. When session objects are reused, the occurrence of other operations, such as memory allocation associated with creation of a new session object at step 608, decreases. This may be balanced against the costs of managing a pool of available data objects for reuse. An embodiment may also have other considerations and limitations that affect a decision of whether to reuse one or more data objects.

At step 610, the received XML message is parsed and the current session object is filled in with the data of the current XML message received from the application's data stream. Prior to step 610, the session object or data structure has been allocated to include appropriate buffers, and the like in accordance with the current set of rules. At step 610, the XML message received is parsed in accordance with these rules. The required data is extracted from the received XML message and stored in the session object and other objects. In one embodiment using XML messages as described herein, a parser may be used which supports a subset of Xpath as described, for example, at http://www.w3c.org/TR/xpath. As known in the art, Xpath is a language for addressing parts of an XML document and is described, for example, at the website www.w3c.org. Any one or more techniques may be used in connection with parsing the received message to extract the portions thereof used in connection with the rules as defined in the current session object. Parsing techniques known in the art are described, for example, at http://www.perfectxml.com/domsax.asp, http://www.saxproject.org/, http://www.w3.org/DOM/, http://www.xmlpull.org. At step 612, the expression conditions are evaluated using the data included in the XML message received at step 600. The evaluation may be performed using evaluation methods included in the expression processing module 330. It should be noted that how an embodiment evaluates rules may vary in accordance with how the rules and values are represented and stored in each embodiment. In one embodiment, the particular version of the rules and the rules themselves in use when the session object is first initialized are stored within the session object. The rules may be stored in a tree-like data structure representing the hierarchical relationship between operators and operands. The tree-like data structure may represent the precedence order of evaluation of the conditions used in a rule. Other embodiments may use other representations and evaluation techniques than as described herein. At step 614, actions associated with those rules having conditions evaluated to true are performed. At step 616, any output formatting is performed, as using format methods included in the format processing module 332. The formatted output is then sent to the appropriate writer for processing and output to, for example, one or more logs, such as a system log, an error log or other event log. It should be noted that a single writer may be shared by multiple session contexts.

After step 616 processing is complete, control proceeds to step 617 where a determination is made as to whether the current rule revision is the same as the rule revision of the session object. If not, it indicates that a rule revision or modification has taken place and the current session object is not reused. As a result, control proceeds to step 618 where the session object may be discarded and not returned to the pool of session objects available for reuse. If at step 617 a determination is made that the rule revision of the object matches the current rule revision indicating that no modification in the set of rules has taken place since the session object was created and initialized, control proceeds to step 620 where the session object is returned to the session object pool for reuse.

As described herein, performing runtime processing of an XML message as sent to the filter 338 includes creating a new session object for each incoming message or transmission, such as an HTTP request. A message may be, for example, a request for performing a particular customer operation or other administrative operation. For each HTTP request in this embodiment received by the stream sensor, a new session may be created. Creating a session for each request minimizes synchronization operations that are required to be performed at runtime by the stream sensor. The techniques described herein provide for minimization of resource contention by allowing multiple server threads to operate independently.

As used herein, a single transaction may be associated with one or more XML messages in this embodiment. As an example, a single transaction may be associated with obtaining inventory status, reserving a particular quantity with an ordering system, and also shipping an item in connection with a purchase. All of these tasks may be associated with performing a single transaction, such as in connection with making a purchase from an on-line book vendor's website.

A session and related processing may be characterized as being synchronized at three particular points during the processing lifetime of a single received request. A first point of synchronization occurs at the beginning of the request where, for example, a session object is allocated or an object is reused from an existing pool. Additionally, synchronization is performed at the end of the life of the session and associated message processing when winding down which is described in connection with processing of steps 617, 618 and 620. In connection with the foregoing two points, synchronization between executing threads may be performed in connection with providing access to the pool of available session objects for reuse as needed. Additionally, synchronization of a session may be performed in connection with writer methods for each type of writer. Whether synchronization of a session in connection with an output operation is required may vary with the type of destination or resource accessed by each writer. In one embodiment, the same writer object may be used by multiple session objects and server threads. In one embodiment, writers may access destination devices including an event log, a system log, a service or application, and a file system. In this embodiment, the event log and system log do not require synchronized access since multiple threads may write output to the same writer at the same time. However, in connection with a file of a file system, sequential write access to the file must be guaranteed to access to the writer object is synchronized. Synchronization at the foregoing three points may be performed to ensure serial access where needed to a shared resource, such as the pool of available objects, data files and the like, using any one or more synchronization techniques known in the art, such as, for example, using mutexes, monitors, or critical sections. The particular synchronization technique used may vary with those included and available for use in each particular embodiment.

Whether a particular application or service invoked by a writer method requires synchronization may vary in accordance with the resources accessed by the application and the operations that may be performed. For example, if the application invoked as an action portion of a rule is a mail application, synchronization may not be required. If the application invoked is a customized application that performs a particular operation, synchronization may be required at various points in the application in connection with reading and writing data to data files in a file system.

Use of the single session object for each message or transmission is one aspect in which the techniques described herein are scalable and efficient. One advantage is that if a rule revision occurs while a session is executing using a current set of rules, the rule revision processing happens without interrupting the executing session. In other words, new versions of the rules and associated data structures are created and used when needed. However, if an existing session object is still being used by a server thread, the sever thread is allowed to continue using its current set of rules included within the data structure of the session object. As a result, redefining or re-specifying a set of rules and associated objects does not interfere with those session objects already created and being used by server threads. Using the techniques described herein, once a rule revision occurs, no new server threads begin execution using a session object in accordance with an old set of rules. Once a new version of rules has been specified, session objects created from that point in time forward use the latest set of rules and associated objects. As described in following paragraphs, the data structures used in one embodiment provide for local storage of a current version of rules within each session object as defined at the time of processing an incoming message when filtering and gathering data.

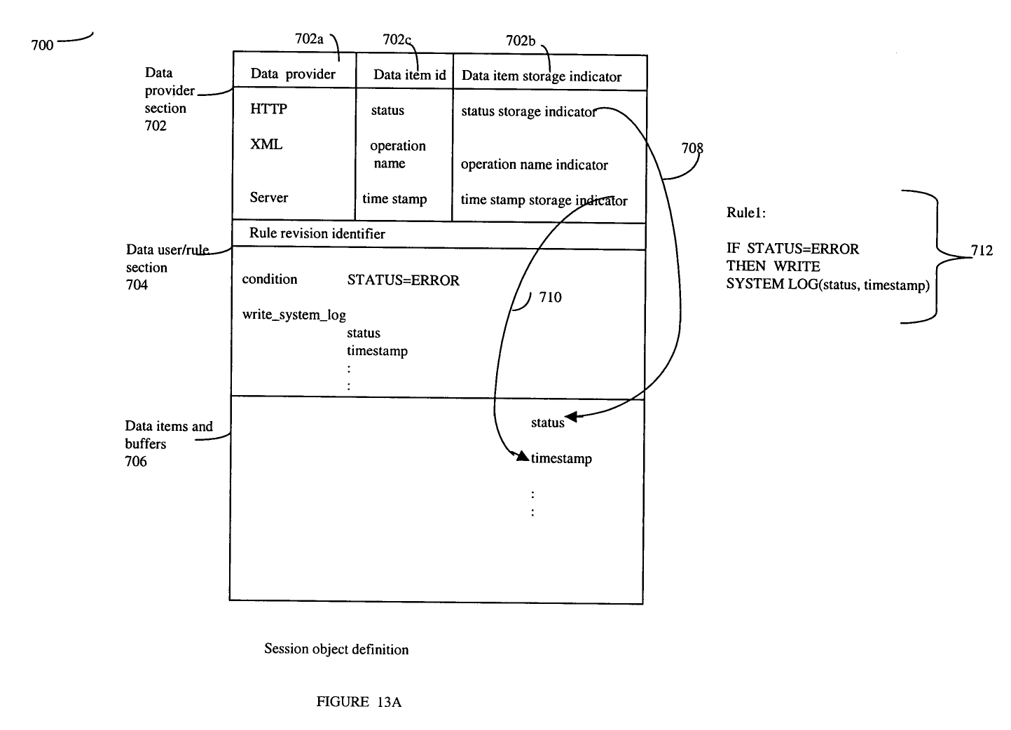

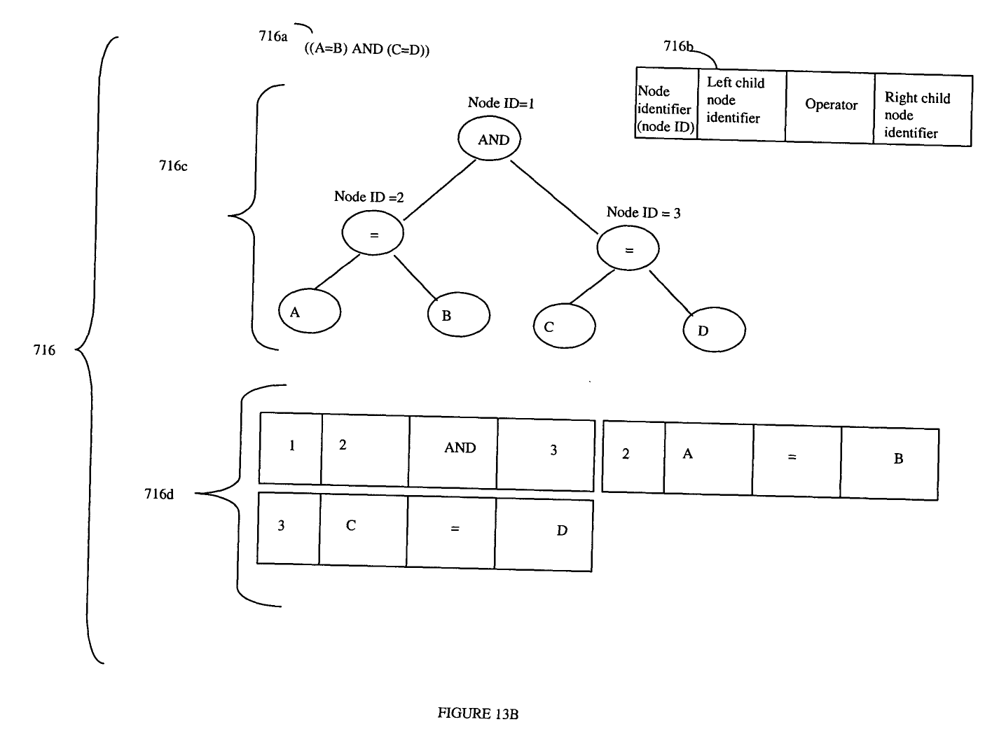

Referring now to FIG. 13A, shown is an example of one embodiment of a session object. The session object definition 700 in this example includes a data provider section 702, a data user/rule section 702, and a data items and buffers section 704. The data provider section 702 may include a record of data for each data item referenced. Each record of 702 may indicate the data provider in record portion 702a, a storage indicator in record portion 702b of where storage for the actual data item is located, and a data item identifier or id 702c providing a unique identifier for the data item described by the record 702. The data item identifier in 702c may include the identifier name, for example, as may be referenced in the section 704. In the example 700, a data provider in a first record of 702 is an HTTP parser providing a status data item. A second record of data provider section 702 specifies that an XML parser provides an operation name data item. A third record of data provider section 702 specifies that a time stamp data item is provided by the server system.

The data provider section 702 specifies those data items which are used in the rule section 704. Data is allocated for each of these data items in section 706. An indicator of what location has been allocated for a particular data item may be stored in 702b of the data provider section 702. For example, in connection with the status data item, a status storage indicator may be a pointer or an address within the data items and buffer section 706 as illustrated by arrow 708. Similarly, arrow 710 illustrates the data item indicator for the timestamp.

Section 704 includes a rule revision identifier and a complete set of rules. The rule revision identifier uniquely identifies the version of the set of rules within the section 704. As described elsewhere herein, rules may be revised while the stream sensor is processing the data stream of an application server causing generation of a new set of rules. When a message is received, a session object is created which is used in processing the message. Included in the session object is a copy of the current set of rules. In this manner, each session object stores locally its own version of the rules. The local session copy of the rules is not affected when a rule revision occurs. Each rule in this embodiment is evaluated such that it has the following form:

IF <condition>
THEN <action>

Data element 712 indicates that Rule 1 of section 704 has <condition> of “STATUS=ERROR” and an <action> of “WRITE SYSTEM LOG(status, timestamp)”. Rule 1 may be used, for example, to record the status and timestamp in the system log when there has been an error. Within section 704, the conditions may be stored in a tree-like representation. In one embodiment, the condition portion associated with a rule may be stored in a tree representation in accordance with the evaluation precedence of the condition. Any one of a variety of different data structures may be stored in representing each condition of a rule.

Referring now to FIG. 13B, shown is an example 716 illustrating how a condition of a rule may be represented with the rule section 704. 716a is one representation of an example rule condition. 716c is a representation of the condition 716a that may be stored within section 704 in an embodiment. 716b is an example of a data structure that may be used in an embodiment for storing a node of the condition in which the node corresponds to one non-leaf node of the tree 716c. 716d is an example of how the condition 716a may be represented using three instances of the foregoing data structure 716b. Each data item may refer to a location or data item identifier within the data provider section 702 corresponding to the correct data item as referenced in each condition. When an XML message is received in connection with data filtering and gathering, the particular data items included within the XML message are extracted and stored within section 706. When evaluating the condition, the expression processing obtains the data item values from section 706. For conditions evaluating to true, the evaluation processing method may, for example, then invoke a format processing method to output the result in accordance with the indicated action. Other embodiments may use other representations and data structures in connection with storing and evaluating rules and in particular the condition and other data items.

As described herein, the session manager 320 is responsible for providing the necessary information and context to any thread executing a server operation. This includes, for example, determining which parts of a received message are stored, where the message data is stored, and under what conditions. Application servers, such as 26b and 28b described herein, are capable of handling multiple requests or transmission concurrently and the stream sensor associated with each application server in this embodiment is able to support this behavior while introducing a minimum of overhead and latency. In order to accomplish this, the components of the stream sensor in this embodiment may perform the following tasks using techniques described herein:
1) Extract the pertinent information from a received message in a very efficient manner. A key activity of the stream sensor is to inspect the data being processed by the application server. Since application servers can handle large amounts of network I/O, the stream sensor in the embodiment described herein performs this data inspection in an efficient manner to avoid slowing the application server.
2) Minimize the amount of data that is stored depending on the message and its context. Generally, I/O operations are expensive in terms of processing time and computer resources. The techniques described herein provide flexibility so that the stream sensor may be configured to only capture information necessary as specified in accordance with user selections as expressed in a set of rules.
3) Minimize resource contention with other threads in the application. Any synchronization used in resolving resource contention takes place in many different server threads concurrently thereby reducing server scalability.
4) Avoid excessive memory allocations. Memory allocations can be relatively costly operations, especially in a heavily multi-threaded environment.
5) Ensure that the stream sensor uses the most current set of rules to determine which parts of a message should be captured, without introducing the possibility that the definition of the rules is in an inconsistent state. In the embodiment described herein, users are free to modify the rules at runtime during data gathering and monitoring while the stream sensor ensures that the rules are applied atomically and in a timely fashion without interrupting application server processing.
6) Ensure that shared resources, such as used by writers, are released at the earliest possible time. In one embodiment, this is done through a reference counting mechanism allowing release of resources as soon as the last session object is complete. This may be used to minimize the amount of time a resource is held without introducing undue resource management overhead.

The session manager accomplishes these tasks in one embodiment by creating session objects for each message received. The session object describes the context information for that particular message including all information, memory buffers, and the like, to handle the message. As processing of the message winds down, the session object is returned to the session manager. The session manager then decides whether the current context as defined by the session object can be reset and reused, or whether the session object should be discarded because a new set of rules have been defined and are in use as the current set of rules.

The foregoing design minimizes resource contention by allowing each server thread to run completely independently for most of the life of each message minimizing the amount of synchronization required during the lifetime processing of the message. Additionally, including memory buffers for the message information and rules within a session object associated with each message allows the thread to minimize memory allocations.

As described in one embodiment, rules are included and stored in the rules section of the session object. This is a design decision used in this embodiment as an approach to keep context information local within each session object to facilitate multiple rule revisions being defined and used simultaneously without interrupting processing of server threads. This facilitates efficient processing in the instance when a first set of rules is being used by a first server thread and a rule revision occurs generating a second different set of rules. The second set of rules may be specified and put in place for use by any new server threads. This preparation may occur without interrupting execution of the first server thread since the version of the rules used by each thread is included locally within the session object. In other words, each server thread uses a set of rules as included in its own local context. This is in contrast, for example, to referencing a set of rules which may be characterized as a global resources used by multiple server threads. When a later rule revision occurs, the current rule set is updated and included locally within each subsequently allocated session object for use by each server thread.

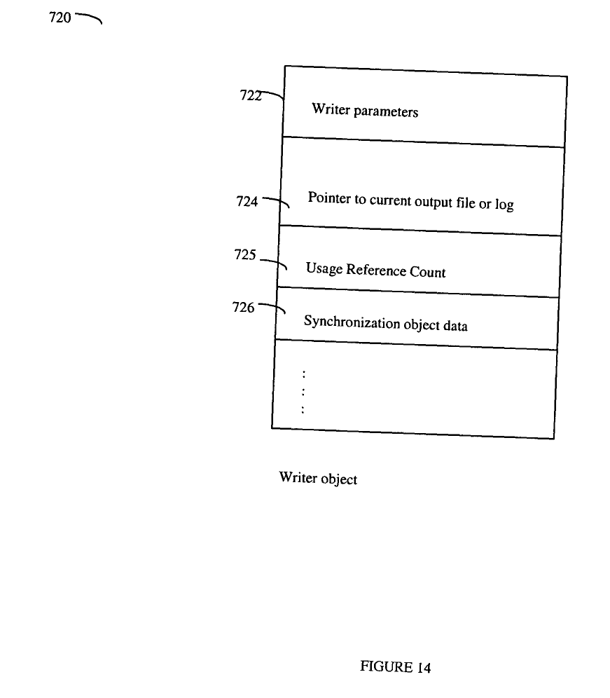

Referring now to FIG. 14, shown is an example of an embodiment of a writer object that may be used in one embodiment. The writer object 720 may include a section 722 for the writer parameters, a section 724 which includes a pointer to the current file system file, log file, application, or other destination for this particular writer object, a usage reference count 725, and a section 726 for the synchronization object data. Sections 722 and 724 may include information as specified in corresponding XML statements included in a file, such as when the log should be rolled over, the maximum amount of disk space the log is allowed to consume, when old logs may be deleted, and the like. This information may be specified in the ODF file described elsewhere herein. The synchronization data object section 726 may include the actual synchronization data object or appropriate pointers, addresses, and the like in connection with accessing the appropriate synchronization data object. As described elsewhere herein, the synchronization object may be used in connection with synchronizing access to resources accessed by the writer. A writer may be typed in accordance with a particular destination to which a writer produces output, for example, such as a Windows Event log, a UNIX syslog file, or an invocation of a service or application, such as an email server or other customized application. The synchronization object as indicated in section 726 may be used in connection with write method code which accesses a particular resource since the same write method may be used by multiple server threads concurrently. The writer parameters as included in the data structure 720 of FIG. 14 may include parameters that indicate, for example, how often to flush a particular destination file or log to disk, how big to let the associated log file get, and the like.

The writer module of the stream sensor may include methods for performing writer object operations. This includes ensuring that transaction information gathered using the techniques described herein is persisted in an efficient manner. The writer object and its associated methods in this embodiment minimize resource contention. Concurrent access to different files is allowed, while simultaneous access to the same file is serialized. In one embodiment, logs are one type of destination or output. In this embodiment, log files may be automatically rolled over when a log format change is detected. Additionally, an embodiment may also provide for other processing, such as automatic content compression and purging of outdated content. There may be multiple types of events logged in which each type is associated with a different log such as, for example, a Windows event log, UNIX system log, and the like.

It should be noted that other objects described herein, such as an expression object and a format object, may similarly include data fields corresponding to particular options that may be specified when defining rules. The particular example of the writer object and session object described herein should not be construed as a limitation.

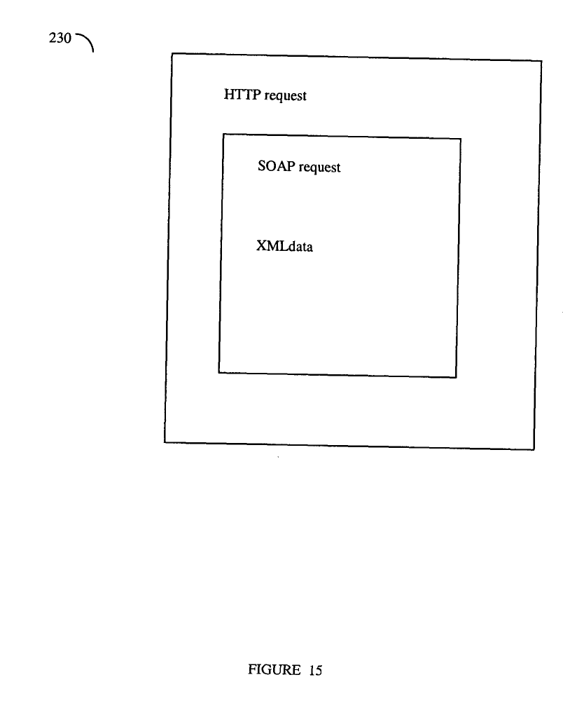

Referring now to FIG. 15, shown is an example of a representation 230 of an incoming message as may be received by the filter 338 of the stream sensor 26a in connection with gathering data regarding an application's data stream. The message received may include the XML data which is included as part of an SOAP request. The SOAP request may be encapsulated within an HTTP request. The incoming data message received may be processed until the XML data included within the SOAP request is reached. It should be noted that an embodiment may use one or more different parsers, such as an XML parser and an HTTP parser, in connection with recognizing and processing different portions of the received message.

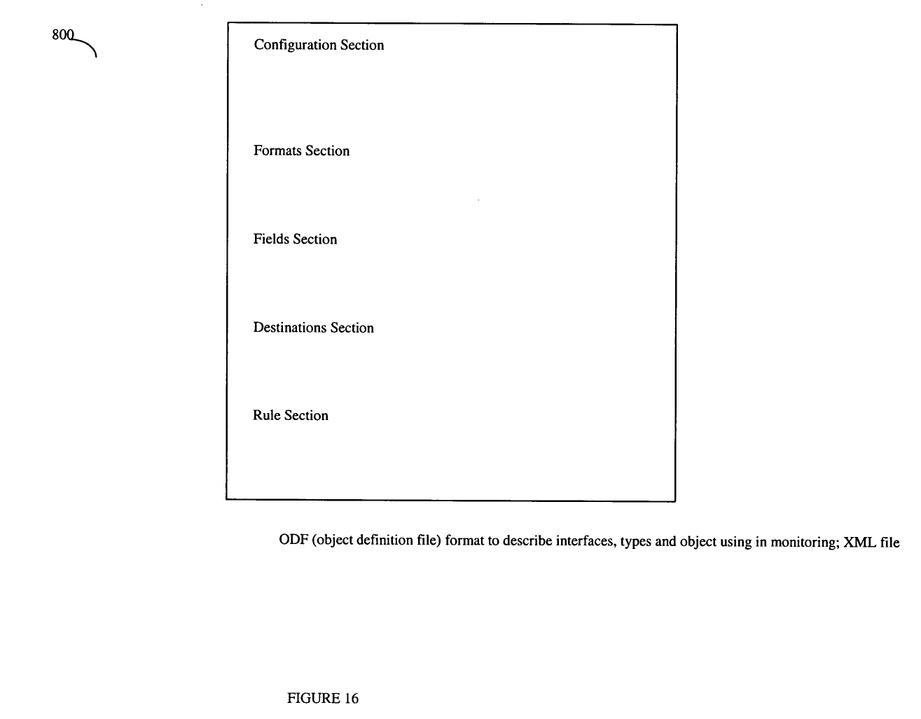

Referring now to FIG. 16, shown is an example of an embodiment 800 of the sections that may be included in an Object Definition Format (ODF) file. In one embodiment, the ODF file may be an XML file describing interfaces, types, and objects used in performing the monitoring techniques described herein. An ODF file may be an XML file specifying the rules as used in configuring the behavior of the stream sensor as described herein. The ODF file may include the data received from the console of the configuration request 206a previously described herein in connection with FIG. 8. The ODF file may be created and stored, for example, in the rules data file 108 as produced by the configuration manager 336.

The sections included in the embodiment 800 are the configuration section, the formats section, the fields section, the destinations section and a rules section. The configuration section describes general characteristics that may be associated with recording data such as, for example, licensing information. The formats section includes format definitions that may be used in connection with formatting output to a destination. The fields section may include expression definitions or variables that may be used, for example, in a condition portion or output portion of a rule. The destinations sections defines the output mechanisms that may be used such as, for example, an output file designation, the name of a log file, application, and the like. The rule section includes the actual rules which evaluate to the IF THEN form described elsewhere herein, as well as the list of items to log if the rule applies An embodiment may use any particular format and associated syntax in connection with rules.

Following is an example of the various XML elements, and the relationships there between, as represented in a tree-like illustration that may be used in connection with specifying an ODF file in one embodiment. The following tree illustrates the relationships among the XML elements that may be included in one embodiment with the XML element followed by a more detailed description and/or specification enclosed within the following set of parentheses:

serviceMonitor (delimits XML file being processed)

configuration section (block of information dictating behavior of data gathering and other processing

steps)

sampling (how often operations should be sampled)
logFlushInterval (number of seconds to wait before flushing file destinations that do not have

flushing performed automatically or in accordance with other defaults)

licenseKey(the key authorizing the user to monitor and instrument applications)

formats section(format definitions section indicating how to format output data)

string (formatting used when outputting strings)

transforms(indicates how string should be encoded or transformed when output)

replace (indicates that string contained in sub elements FROM and TO are transformed)

from (string elements to be replaced by what is specified in the “to” portion )
to (elements to be substituted for occurrences of the “from” portion)

encryption (encrypt field in accordance with attributes specified)
singleLine (replace all new lines with spaces in output)
encodeXml (encode according to indicated XML element)
encodeBase64 (indicates base 64 encoding)
trim (remove white spacing)
hash (field should be hashed and output using parameters specified)

formatting (specify output format of encoded/transformed string)

timestamp (formatting output when outputting timestamps)

fields section (section of user defined expressions that may be used)

fieldDefinition (user defined expression)

(expressions, including mathematical operators such as: add, sub, div, mult, mod;
comparison operators such as: eq, ne, lt, le, gt, ge;
string comparison operators: slt, sle, sgt, sge, match;
boolean operators: and, or, not; boolean unary operator if expression is defined: exists)

(fields, including server Variable-name of server variable such as name of server;
header-name of an HTTP header; element-name of XML element;
soapOperation-name of SOAP request; soapParameter-name of parameter in SOAP
request; soapFault-soap request error; literal-a constant; field-reference to a fieldDefinition
element; rawData-log all data of specified kind)

destinations section (indicates output mechanisms and destinations available to the filter)

file (indicates information about output to a file system)

rollover

copies (where and when log file should be rolled over)

delimited (option indicating whether output file includes particular delimiters)

event (details about an event log subsystem and what is recorded in each)

rule section (Rules controlling what data is gathered)

condition (indicates and output condition)

(expressions, as defined above)

(fields, as defined above)

output (indicates an output destination and one or more expressions to be output to destination)

(fields, as defined above)

Included as Appendix A is an example of an annotated ODF file using the foregoing XML elements as may be used in an embodiment. Included as Appendix B is a more detailed description of each of the XML elements described above that may be included in one embodiment of an ODF file.

An embodiment may include functionality for user defined routines to be invoked in connection with rule conditions and/or actions. For example, an embodiment may include only those operators as described above. A user may supplement the operators included in an embodiment by defining another mathematical operation, such as computing a logarithmic function of an expression, or other operation that invokes a corresponding user-defined routine. The interface for the user-defined routine, including parameters and other information if any, may be defined within the ODF file in the configuration section. In processing the ODF file, the parser also allows references to user-defined routines from the configuration section. A reference to the user-defined routine may occur, for example, in the field section of an ODF file in connection with expressions. When evaluating the expression, the user-defined routine may be invoked using data provided at a reference invocation site in accordance with its interface. This data may include, for example, parameters, call-linkage information, and the like, as needed in accordance with each particular embodiment. Upon completion, the user-defined routine may return one or more values, such as a function return value or parameter, for use in subsequent processing within the ODF file by the stream sensor. In other words, the user-defined routine may return one or more values in accordance with one or more input values. The return values may be used, for example, when evaluating a condition portion of a rule. The particular implementation details may vary in accordance with each embodiment.

The particular XML elements included in an embodiment may vary in accordance with the functionality and options included therein. The description and particulars of the ODF file set forth herein are just one example of rules and related sections may be specified in one embodiment and should not be construed as a limitation. An embodiment may specify rules and, optionally, ancillary features used in connection therewith, that may vary in accordance with each embodiment.

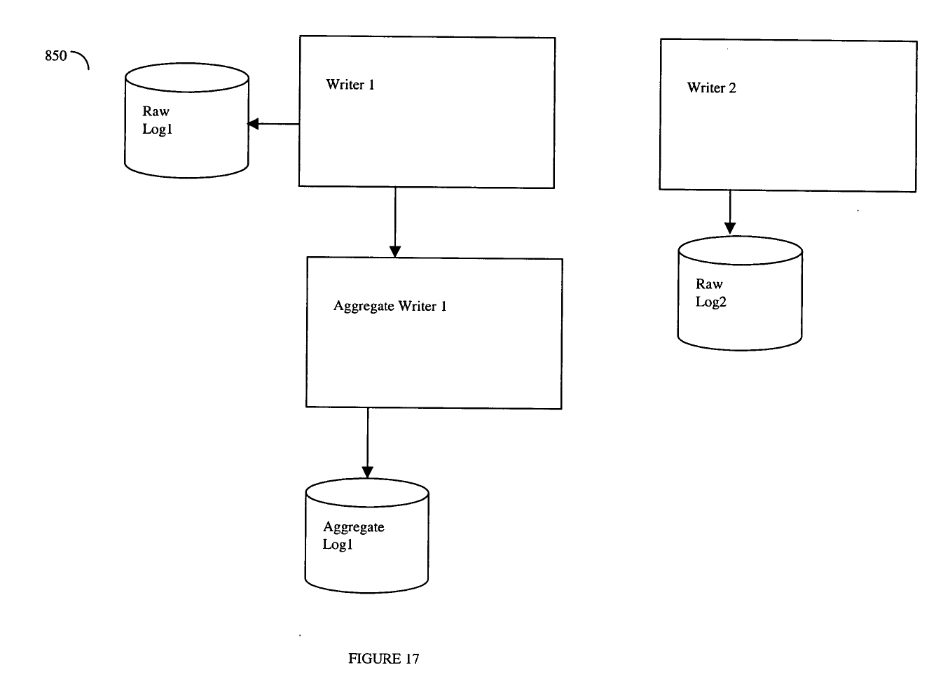

Referring now to FIG. 17, shown is an example of an embodiment 850 of two writer types and the particular destinations or outputs as used by the particular writers. In the illustration 850, writer 1 outputs to a log file, “raw log 1”. A second writer writes to a second log file, “raw log 2”. Additionally, writer 1 also produces output which is sent to aggregate writer 1. Aggregate writer 1 then outputs data to “aggregate log 1”. In 850, writer 1 may output data to “raw log 1” at a first rate. It may be desirable to aggregate the data from one particular writer, such as writer 1, in an aggregate file referred to as “aggregate log 1”. Writer 1 may send data to aggregate writer 1 at predetermined time intervals, such as, for example, some fraction of a minute. The scheduler may be programmed to schedule or wake up aggregate writer 1 at predetermined time intervals, such as every minute, to write out data to “aggregate log 1”, for example, as a batch of information received from writer 1.

The foregoing is just one technique that may be used in connection with performing an aggregation or summarization of data for a predetermined time interval. The technique illustrated in 850 of FIG. 17 may be used as an alternative to, or in addition to, using an Aggregation Service which performs the function of aggregating or summarizing data for a given transaction, or transactions over a predetermined time interval. The aggregate writer 1 may perform the aggregate service or functionality by summarizing all of the data received from writer 1 for a predetermined time interval in accordance with, for example, aggregating data for a plurality of messages for each transaction for a specified time interval. The foregoing example 850 of FIG. 17 may be referred to as a chained writer example to perform the aggregation service or summarization of data for a predetermined time interval.

The chained writing technique may be used in aggregating recorded data in a variety of different ways. For example, it may be used in connection with aggregating information across a set of stream sensors or nodes within the server system. Operations may be performed in accordance with gathering data about each of the particular phases of a transaction and the different components used in each phase or step. Information may be gathered for any portion of the transaction or the entire transaction by aggregating data from the appropriate stream sensors.

It should be noted that a writer may also be associated with a particular application or service, for example, which may be provided by an email server. In one embodiment, the action portion of the rule may also identify a writer which outputs to a destination dedicated to logging non-error data, or logging error data. A rule may be used, for example, for logging authentication failures and writing output to an authentication log with particular information regarding the failure. The action portion of a rule may also result in invoking a particular customized application in accordance with specified conditions. Utilizing the techniques in connection with chained writers, a first authentication writer may log authentication failures. If five failures are detected, for example, as maintained in a variable or data item used within a rule, another second authentication writer may be called rather than the first authentication writer. The second authentication writer may, for example, send an e-mail or pager message to disable further login attempts to an account associated with the authentication failure, and the like.

The action portion of a rule may be used in connection with enforcing a compliance rule such as, for example, in connection with policing requirements, conditions, and the like. For example, a condition may evaluate to true, information may be recorded as in a log or event file, and additionally, it may be desirable not to perform the requested processing indicated by the current message of the application's data stream received at run time in connection with a particular operation. For example, upon the detection of three consecutive authentication failures, rather than try again or otherwise provide for further processing the received message, the filter may be used as an intervention mechanism when the condition portion of a rule evaluates to true. An embodiment may stop processing the current request, redirect the request, and/or perform other processing when the condition evaluates to true.

In connection with the writers described herein that use a particular resource, serialization of the resource may be performed at the lowest level where needed in accordance with the standard synchronization techniques that may be included in an embodiment. This provides for minimizing resource contention in an efficient manner in connection with other techniques described herein.

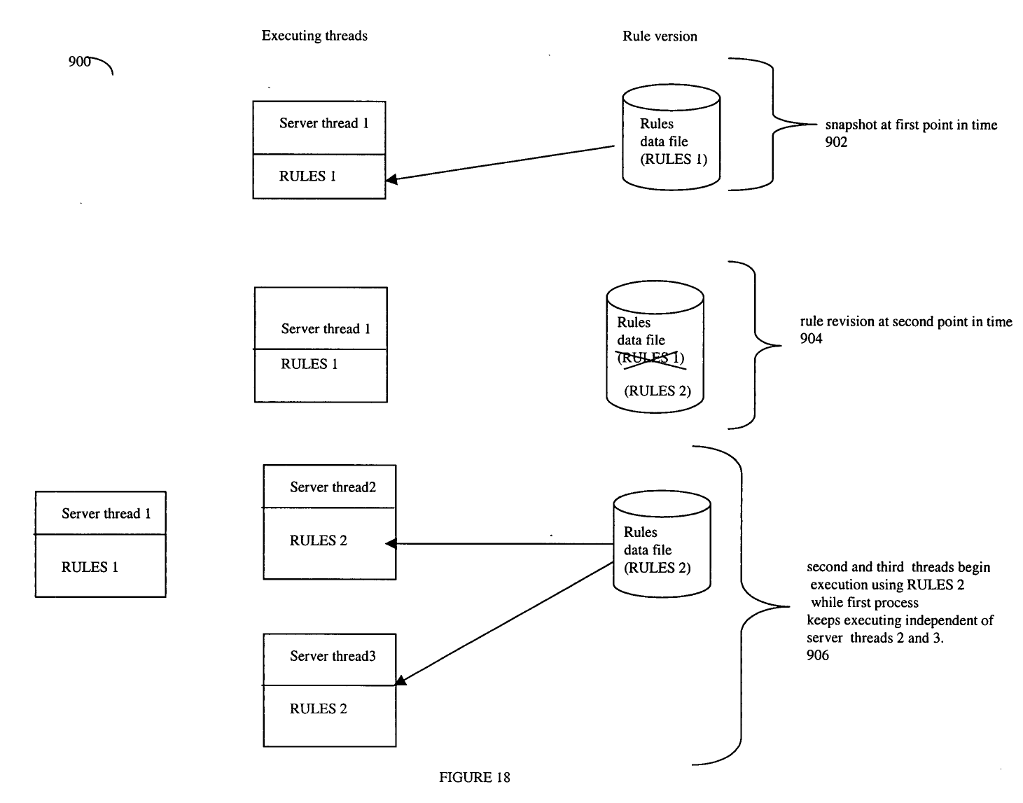

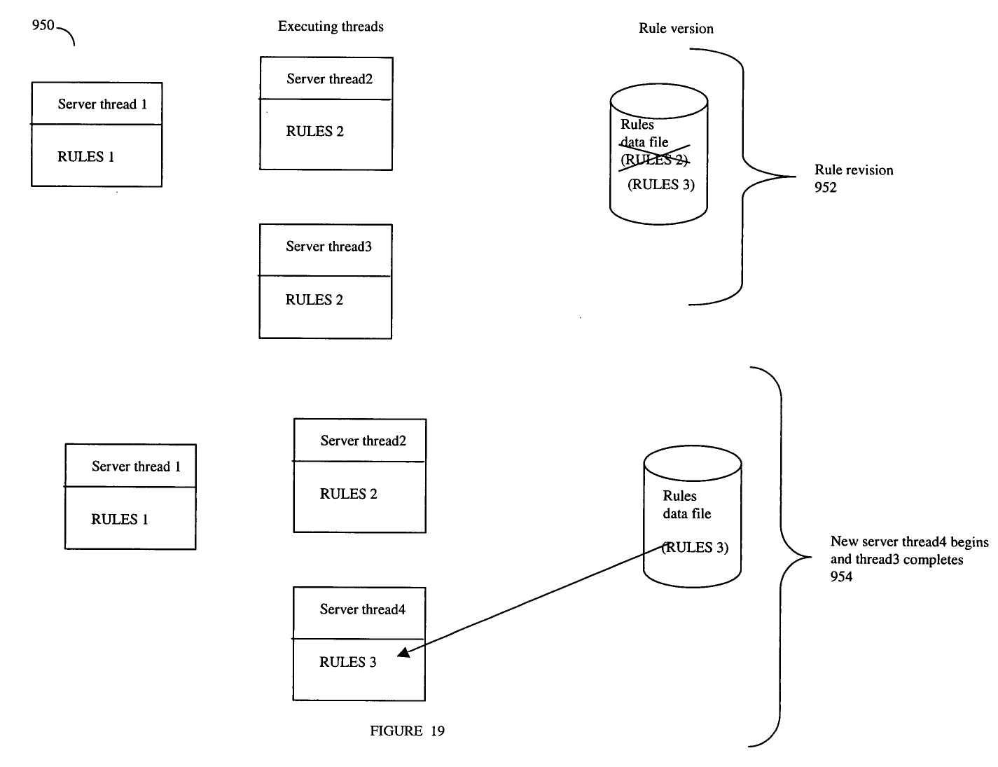

Referring now to FIGS. 18 and 19, shown is an example 900 illustrating steps in connection with how different rule versions may be used within an embodiment at different points in time. Each element corresponds to a snapshot of executing server threads and rule versions at each of the different points in time. Element 902 is an illustration at a first point in time in which a first set of rules, RULES 1, is the current set of rules. At the first point in time, the server thread 1 begins executing using RULES 1 as included in the local server thread's context as may be stored, for example, in the session object or data structure described elsewhere herein. At a second point in time as illustrated in 904, a rule revision is made so that the current set of rules at the second point in time is RULES2. The rules data file in 904 is updated to RULES 2. At a third point in time as illustrated in 906, server thread 1 is executing using RULES1 and second and third server threads begin execution using RULES 2. Both the second and third threads use a local copy of RULES2 when processing a received message. At a fourth point in time as illustrated in 952, a revision is made to the rules such that RULES3 is the version of the current set of rules. This revision is done while server threads 1, 2 and 3 are executing using different versions of the rules as locally defined within the context of each server thread. As described herein, an embodiment of the server thread uses the version of the rules stored within the session object. At a fifth point in time as illustrated in 954, a new server thread 4 begins execution using RULES3 and server thread 3 has completed execution.

The foregoing example of FIGS. 18 and 19 illustrate how the techniques described herein may be used in connection with having different versions of rules in use concurrently by different threads of execution using thread-local rule definitions. Each session object and thread of FIG. 18 and 19 may be associated with processing a single HTTP request received during data gathering and monitoring of an application's data stream at runtime.

What will now be described and presented are examples of screen shots as may be used in connection with a graphic user interface (GUI) as may be used in an embodiment of the system 10 of FIG. 1 in connection with performing data operations using the techniques described herein.

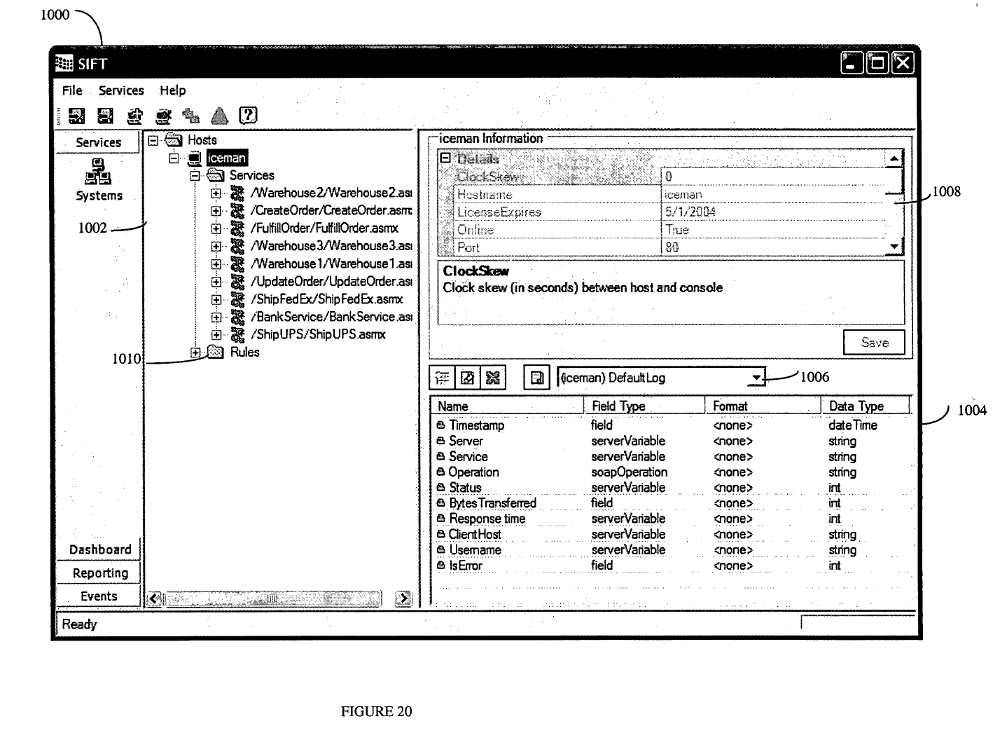

Referring now to FIG. 20, shown is an example of a screen shot that may be used in connection with presenting information to a user for various services that may be performed by one or more applications within the server system 12. In particular, the screen shot 1000 may be displayed to a user on a display device of a console 34 in connection with viewing different services and data elements or variables used in connection with performing the filtering and/or monitoring techniques described herein. The screen shot 1000 includes a section 1002 listing the various services associated with the node Iceman. In this example, Iceman may be a node within the server system 12 and provide the various services listed in 1002. Additionally, the section 1002 includes a rules item 1010 that may be expanded to display, for example, the various rules that have been defined in connection with previous data monitoring operations from this particular console. Also shown in the screen shot 1000 is a Section 1008 displaying information about the particular node Iceman. In the lower right quadrant of screen shot 1000 is element 1004 which displays the various data elements or variables and associated information regarding the node Iceman. The particular data elements shown in section 1004 may be specified, for example, in a rule used with data monitoring. The time stamp element in section 1004 may be output, for example, to a log file as part of an action of a rule that may be specified as described elsewhere herein. Other variables displayed in section 1004, such as status, for example, may be used in connection with a condition and an output or action of a rule. The element 1006 of the screen shot 1000 is the name of the log file to which the output is written. In this example, the log file is “DefaultLog”.

It should be noted that an embodiment may provide functionality as used in connection with a GUI, for example, to specify a completely new set of rules, add one or more new rules to currently defined rules, delete one or more existing rules, and/or modify an existing rule. A copy of the rules defined for a particular console and/or user may be stored locally on the console as well as on the server system. An embodiment may have multiple consoles and may handle rule support and functionality in any one or more of a variety of ways. In one embodiment, there may be one large set of aggregated rules representing the combined set of rules from all consoles. Another embodiment may keep each rule set as associated with each console separately.

In one embodiment, multiple consoles may alter and access the same set of rules at the server. Different techniques may be used in connection with management of the rules. One technique associates a rule revision number with each set of rules at a console. If a first console is making revisions to a current set of rules with a version of “X”, and the current revision number of the rules at the server is “not X”, the server rejects any rule revisions from the first console. This may occur, for example, when another console has made a revision to the rules between when the first console obtained a snapshot of the rules as revision number “X” and when the first console requests rule changes. Other embodiments may use other techniques than as described herein.

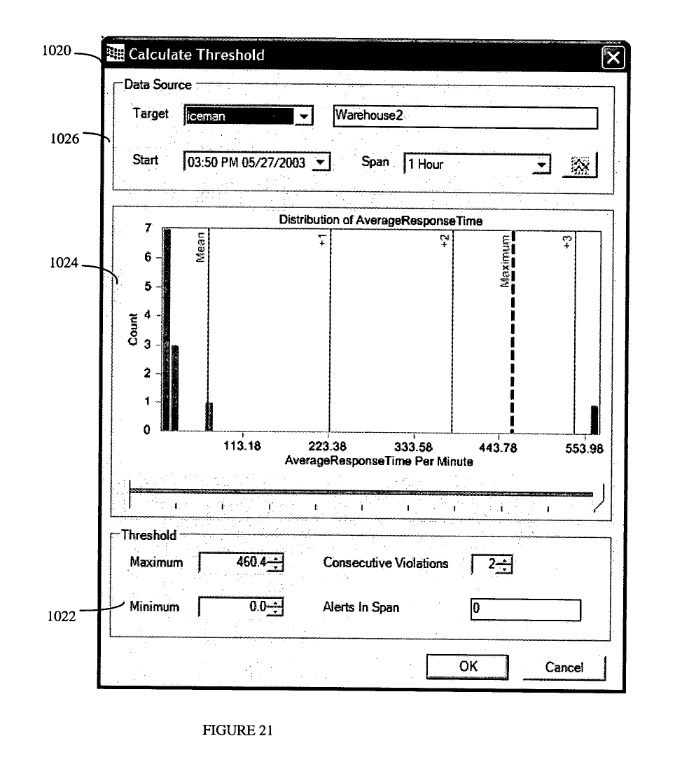

Referring now to FIG. 21, shown is an example of a screen shot 1020 may be used in connection with establishing a threshold value. In one embodiment, a threshold value may be associated with one or more conditions, such as in connection with setting an alert or alarm level. An embodiment may then use an established threshold value to trigger a notification event to a user defined location. The context engine may then monitor the specified data items using the techniques described herein in connection with an application, for example, as may be executing on the server system, and perform a notification if the value of the data item exceeds a defined threshold value at a point in time. The screen shot 1020 may be used in determining, for example, a threshold value for the average response time per minute. The screen shot 1020 includes a lower portion 1022, a middle portion 1024, and an upper portion 1026.

The lower portion 1022 in this example includes particular parameters, such as minimum and maximum threshold values as well as a consecutive violation number, that a user may select in connection with establishing a threshold value. The screen portion 1024 includes a graphical display of the historical range of values of average response time per minute for a particular selected portion of data that has been previously gathered. Screen portion 1026 may be used to define what particular data set is used to produce the graphical display of screen portion 1024. In screen portion 1026, the user may select, for example, a target application, a start time and a time span indicating a band of data which is graphically displayed in screen portion 1024. The parameters in screen portion 1022 are applied to the data set specified in screen portion 1026. For example, a threshold band is established using screen portion 1022 with a minimum and a maximum value. A violation may be detected for the data set as indicated in the “alerts in span” field of 1022 for those values of the data set which are outside of the band specified in the minimum and maximum threshold. An alert may be triggered when the number of violations of a threshold exceed the consecutive violations threshold specified. For example, a first violation may occur in a first minute and a second violation may occur at the next consecutive minute in accordance with determining the average response time. If the average response time per minute exceeds the threshold minimum or maximum value for two consecutive times, an alert is indicated in “alerts in span” field of 1022.

It should be noted that the screen shot 1020 may be used in connection with viewing data that has already been gathered or collected in which the user may select a pre-determined amount or portion of that data using screen shot 1020 in order to, for example, establish what may be an expected average response time per minute. In other words, a user may not have an idea about what average response time per minute is typically associated with a service and a target node. Using the screen shot 1020, the user may preview data that has already been collected in order to investigate what a threshold value typically looks like as profiled in accordance with previously collected data.

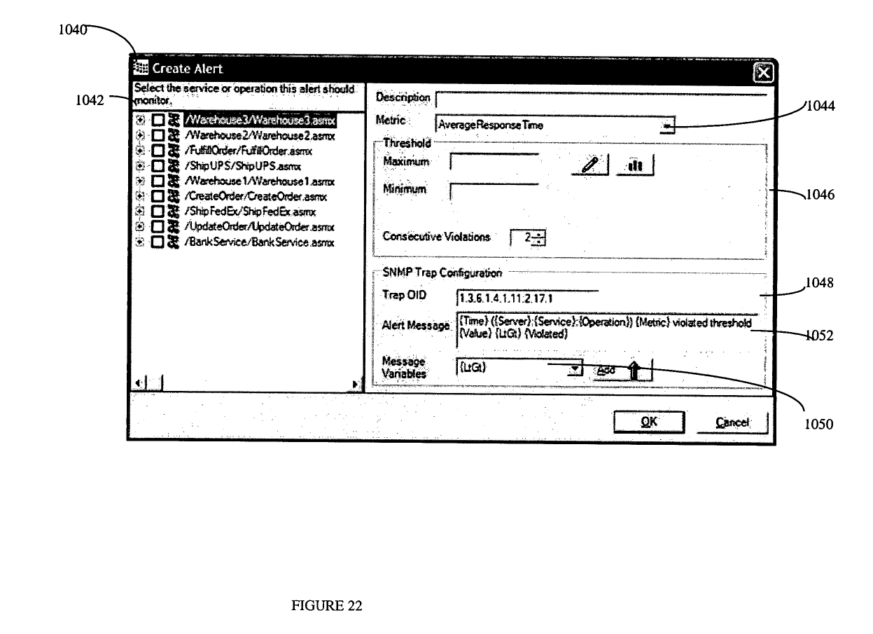

Referring now to FIG. 22, shown is an example of a screen shot 1040 that may be used in connection with registering an alert. The alert may be used in connection with collecting and filtering data from an application's data stream at some future point in time in accordance with specified conditions. The user, on a console for example, may use the information from screen shot 1020 in order to determine a threshold value. The threshold value may be used to specify when an operator needs to be notified because the application has departed from its normal operating range. The screen shot 1040 includes a left portion 1042 from which the user may select the service or operation that the alert condition monitors. A list of services or operations that may be displayed in screen portion 1042, for example, may be similar to a list which is displayed on screen shot 1000, section 1002. The user may then select a particular metric using field 1044 of the screen shot 1040 and establish certain threshold conditions using the portion 1046. The portion 1046 includes, for example, establishment of a minimum and a maximum threshold value establishing a range in this example. Additionally, the user may also indicate a number of consecutive violations of this threshold which cause the generation of an alert condition. In screen portion 1048, the user specifies what types of values may be recorded when an alert condition has been detected. Using field 1050, the user may select from various message variables that may be added to screen portion 1052. In this example, the screen portion 1052 indicates those data items, such as message variables, which are to be recorded when the average response time falls outside of the established threshold for two consecutive violations.

It should be noted that the screen shots 1000, 1020, and 1040 may be displayed, for example, on a display device of a console in connection with a user of the server system, such as an administrator, performing various tasks. The foregoing screen shots may also be used in connection with rule specification processing, for example, when the user specifies the various data items and associated conditions under which particular data items are recorded. As a result of selecting the okay button on screen shot 1040, one or more rules may be generated which are then sent by the console to the server system.

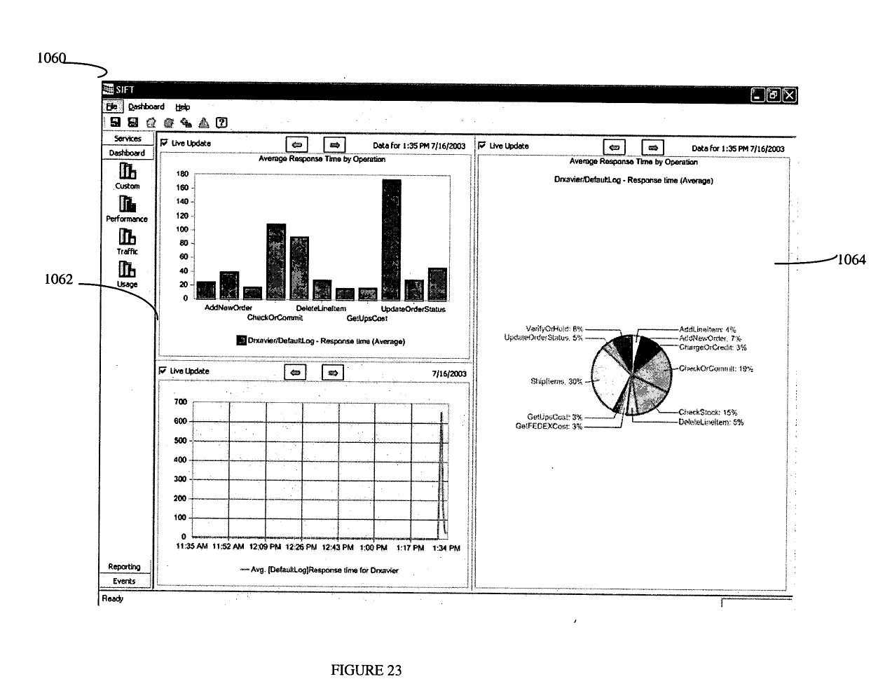

Referring now to FIG. 23, shown is a screen shot 1060 that may also be displayed to a user on a console. The screen shot 1060 may be used in connection with displaying the data that was previously gathered, or is currently being gathered, in order to provide a performance profile or view, such as in connection with displaying the average response time for each of different operations for a particular application, node, or the like in the server system. The screen shot 1060 may be displayed by a user sometime after or during, for example, gathering data in accordance with rules that may be specified using other screen shots as part of rule specification processing. The performance view screen shot 1060 includes a portion 1062 with a graphical display of the average response time by operation using data collected from a default log file of a server node. In this example, the log file is the default log file listing the average response time in connection with operations or services performed on node of the server system DRXAVIER. The lower portion of 1062 displays the average response time as it varies in accordance with the time of day. In other words, screen portion 1062 includes an upper portion displaying the average response time for operation and a lower portion displaying the average response time as it varies across all operations for a particular time of day. Portion 1064 of screen shot 1060 shows a pie chart displaying the average response time for each operation in an application. Screen shot 1060 may be displayed, for example, by someone profiling information regarding the performance of services or operations on the server system.

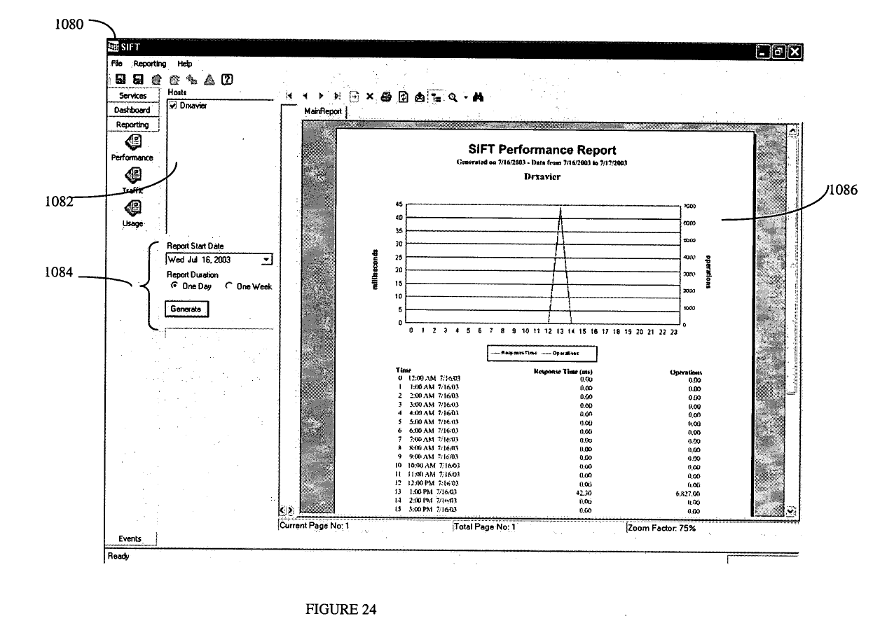

Referring now to FIG. 24, shown is a screen shot 1080 that may be used in connection with generating reports. In screen portion 1082, a node within the server system may be selected for use in connection with report generation. Using the interface elements in the portion 1084, a report start date and duration may be selected. Selection of the generate button, for example, using an input device such as a mouse, causes generation of the report using data that has previously been collected. The data of the report may be displayed in screen portion 1086 in graphical form.

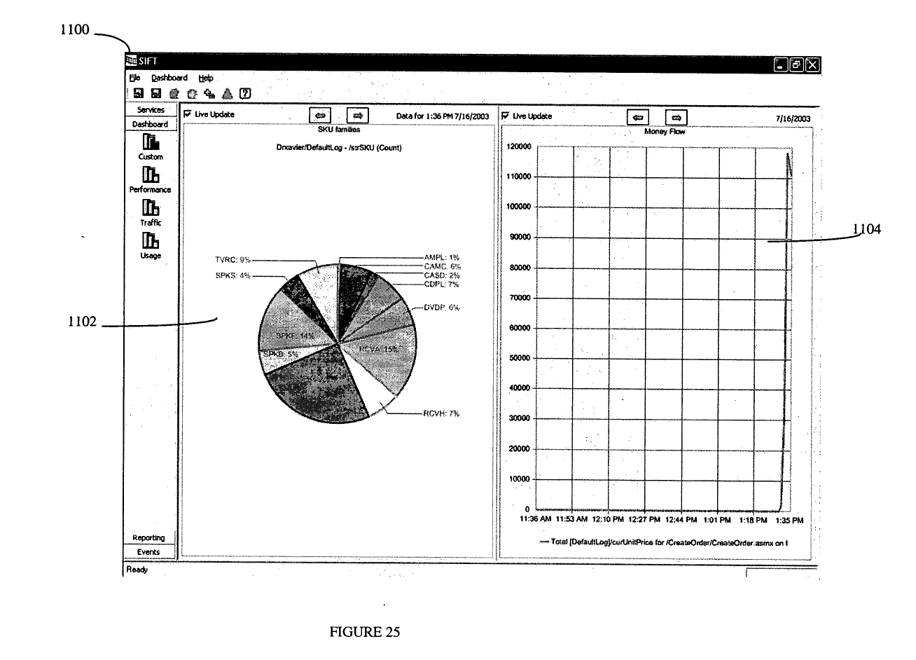

Referring now to FIG. 25, shown is a screen shot 1100 may be used in connection with displaying information collected data for a business view of profile. In the screen shot 1100, portion 1102 is a pie chart display of data collected from a default log file. The pie chart in 1102 displays percentages associated with different SKU numbers where, for example, one SKU may be associated with an item for sale. Screen portion 1104 may be used in connection with a graphical display of information from the default log file for a particular service or operation.

Screen shots 1060, 1080, and 1100 may be displayed to a user on a console, for example, subsequent to data being collected from one or more operations and/or applications for services performed by the server system. It should be noted that an embodiment may provide other types of screen shots and user interfaces in accordance with the particular uses of the data that has been collected. Additionally, an embodiment may also utilize other techniques in connection with obtaining information for rule specification and data profiling. Data profiling may be, for example, displaying a selected portion of collected data in accordance with a particular view or purpose, such as in connection with screen shots 1060, 1080 and 1100. Users may have associated profile information stored locally on each system and/or stored within the server system. The profile information may be used in determining which data items a user and/or console may access and which are displayed.

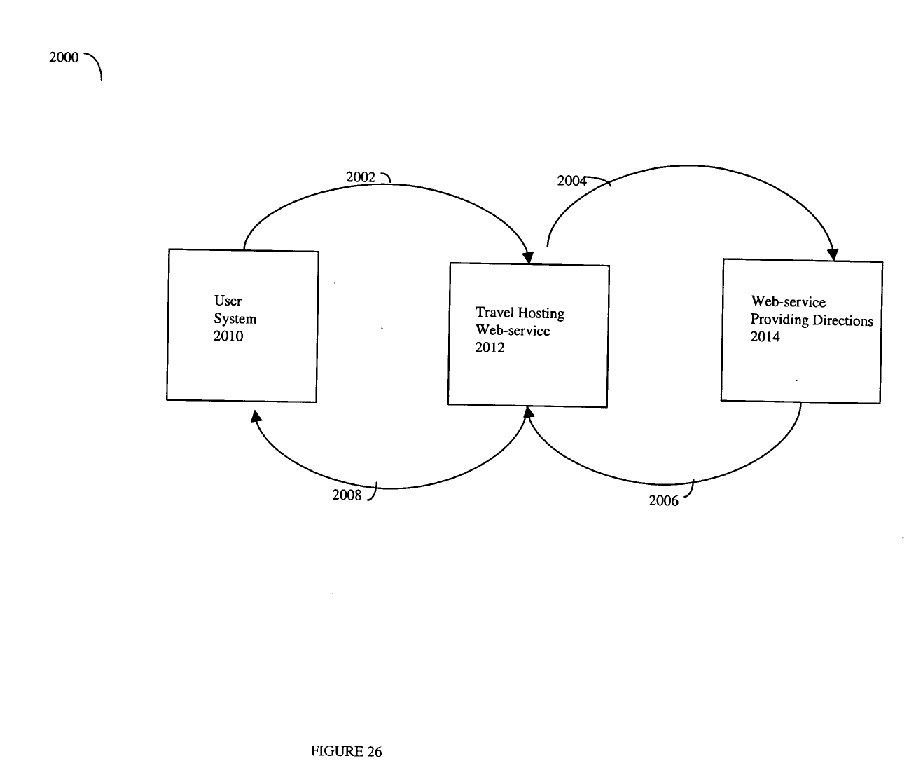

Referring now to FIG. 26, shown is an example 2000 illustrating a particular configuration and message flow within which the foregoing techniques may be used. Only particular components of the system of FIG. 1 are shown in the example 2000 for purposes of simplicity. A user system 2010 may be using a web-services client to request a service of the travel hosting web-service via request 2002, such as how far it is to travel by automobile between two geographical points and related driving directions. The travel hosting web services application server 2012 may use the services of another web-service application server providing directions 2014. The travel hosting web-service may issue request 2004 to the web-service providing the directions 2014 without the user directly issuing a request. In this example 2000, a first web-service uses services offered by another web-service in performing a user request. The web-service providing the directions 2014 provides a response 2006 to the travel hosting web-service 2012 in response to the request 2004. The travel hosting web-service 2012 then provides a response 2008 to the user system 2010. The stream sensor and application server may be used in monitoring the message flow 2002, 2004, 2006 and 2008 by using a stream sensor and application server at each of the travel hosting web-service 2012 and the web-service providing directions 2014 in an arrangement similar to that described herein, for example, in connection with FIG. 2. A first stream sensor at the web-service 2012 may be used to gather information about messages 2002, 2004, 2006 and 2008. A second stream sensor at the web-service 2014 may be used to gather information about messages 2004 and 2006. A Global Aggregator (not shown) may be used in gathering collective information about all the messages 2002, 2004, 2006 and 2008 from the view points of each of the web-services 2012 and 2014.

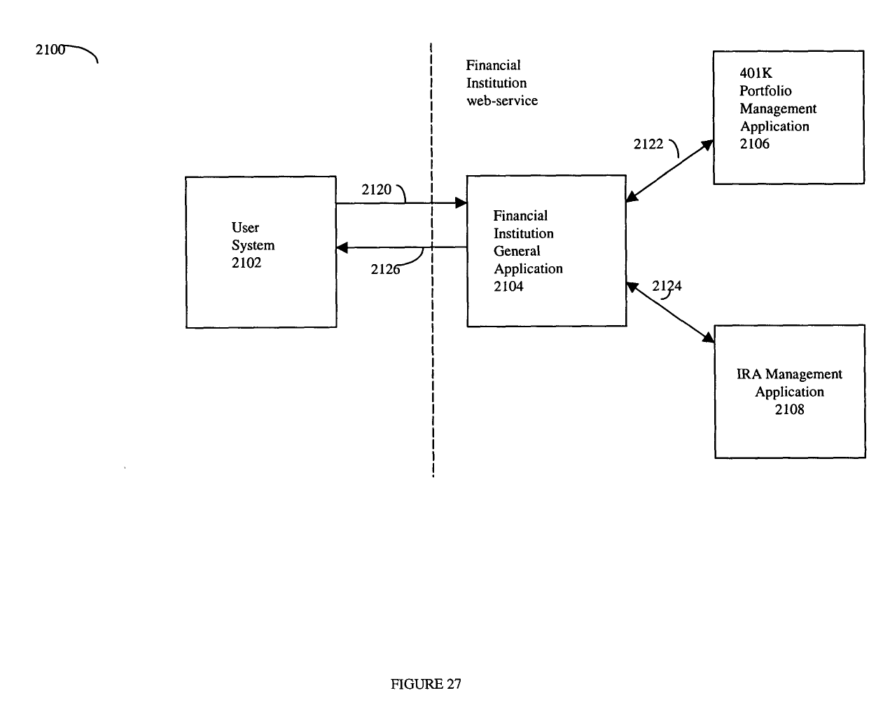

Referring now to FIG. 27, shown is another example 2100 illustrating a particular configuration and message flow within which the foregoing techniques may be used. Only particular components of the system of FIG. 1 are shown in the example 2100 for purposes of simplicity. A user system 2102 may be executing a web-services client issuing a request 2120 for certain account information. In this example, the user has a 401K account and an IRA. The financial institution's web-service may execute multiple applications within the same web-service to process a single request. The user's request 2120 invokes a general application 2104 which then uses the services of other applications in accordance with particular user account information. The general application 2104 uses services of the 401K portfolio management application 2106 and the IRA management application 2108, as illustrated with message exchanges 2122 and 2124, and then returns a response 2126 to the user system 2102. The stream sensor and application server may be used in monitoring the message flow 2120, 2122, 2124 and 2126 by using a stream sensor and application server at each of the general application 2104, 401K portfolio management application 2106, and IRA management application 2108 in an arrangement similar to that described herein, for example, in connection with FIG. 2. A first stream sensor at the general application 2104 may be used to gather information about messages 2120, 2122, 2124 and 2126. A second stream sensor at the 401 portfolio management application 2106 may be used to gather information about message exchanges 2122. A third stream sensor at the IRA management application 2108 may be used to gather information about message exchanges 2124. A Global Aggregator (not shown) may be used in gathering collective information about all the messages 2120, 2122, 2124 and 2126 from the view points of each of the applications 2104, 2016 and 2108. Using the techniques described herein, the financial institution may monitor its own systems and applications based on volume, trades, and the like. Using the gathered information, the financial institution may assess charges, for example, based on the number of trades for each customer number, the amount of activity for a particular account for a particular time period, and the like. Data may be gathered from each point of interest on a per transaction basis as well.

The techniques described herein may also be used in separating out data for a commonly performed service. For example, referring back to FIG. 27, the services of the 401K portfolio management application may be used in performing different types of transactions, such as in providing account information, trading, and the like. Using the techniques described herein, the services of the 401K portfolio management application may be segregated in accordance with a type of financial operation.

The Global Aggregator as described herein in one embodiment may coordinate the collection of data at a point in time after the real-time dynamic content capture has been performed. In other words, the data from the messages is captured as the messages are being sent. The functionality of the Global Aggregator, and additionally the Aggregation Service of each application server also described herein, do not have to perform operations in real time.

Each of the foregoing illustrations in FIGS. 26 and 27 may use existing applications. Components described herein, such as the stream sensor, may be used with the existing applications to monitor message flow and gather data accordingly without modifying the existing applications. The foregoing are only two illustrations of how existing application usage may be monitored using the techniques described herein.

As described herein, the stream sensor records information about transactions as included in the data stream of an application of the server system. Depending on the types of applications hosted at the server system, different information in messages received in connection with each transaction are deemed important in accordance with different conditions. The foregoing describes techniques that process and record the information while introducing a minimum of overhead to the system. The user is able to configure the stream sensor's behavior through a set of rules that the filter stores locally. The rules are used in determining which parts of a message should be recorded, under what conditions, where the recorded data should be logged, and the like. The foregoing uses techniques which processes incoming XML messages of an application's data stream at a fast rate in an efficient manner. The foregoing description provides for revising rules while the stream sensor is actively processing an incoming message. Using the techniques described herein, the rules may be revised while actively processing one or more incoming messages without disrupting the work or pace of the server. In other words, the server performance is not adversely affected by the data monitoring of the data stream of the server applications.

The techniques described herein are scalable because of the data filtering and local consolidation performed at the Web Service application nodes which is then further consolidated, such as by the Global Aggregator. The data obtained as a result of the techniques performed herein may be used in connection with any one or more of a variety of different purposes. For example, the data gathered may be used in determining business impacts of downtime, performance of individual components or nodes to identify bottlenecks, determining component interdependencies, and understanding relationships between the different applications based on the messages exchanged. The rules may be used in recognizing that XML Web Services messages have context. Context may be characterized as a way to specify criteria for what data in the XML stream is interesting for the purposes of monitoring and understanding. The goal of recognizing that XML Web Services messages have context is to have a powerful scheme to create a high signal-to-noise ratio in the XML data being captured. In the foregoing, a set of XML rules specifies the context that is determined to be of interest. Context can include, but is not limited to, the following: message origin, message headers, Web Service methods being called, any message parameter and any metadata in the message. Described herein is a process and system for translating these rules into context-based filtering. The rules-based filtering system accepts rules and changes the context of what needs to be filtered in the underlying XML message stream. The system determines the context of what is captured by applying rules which examine the actual XML stream as well as appropriate metadata. One feature is having the filtering be dependent on the contents of the stream itself. The stream data may dynamically modify the context settings of what data to collect throughout the stream of data. This also makes the system able to automatically scale down the data to only collect that portion specified in accordance with the rules adding to the scalability of the techniques described herein.

It should be noted that a writer may also be associated with a particular application or service for example that may be provided by an email server. In one embodiment, the action portion of the rule may identify a writer which operates on a device that is a destination device for error logging or tracking, or non-error logging or tracking. The action portion of a rule may result in invoking one or more applications, such as an email application sending a message as an action, or a customized application for the particular action and conditions specified. The rule may be used, for example, with logging authentication failures and writing output to an authentication log with particular information regarding the authentication failure. Utilizing the techniques in connection with chained writers, if five failures have been detected, for example, as maintained in a variable or data item design within a rule, another writer may be called rather than a first authentication writer. Rules may be used in connection with encrypting and/or hashing output such as personal health information, credit card information and the like.

The foregoing techniques may be performed in data gathering and monitoring in accordance with a set of predefined rules. The filter of the stream sensor receives data associated with an application. Using the set of rules, the stream sensor may then extract certain portions of data in accordance with the evaluation of those rules at that particular time. As described herein, the actions that may be performed in accordance with rules that evaluate to true may vary with each embodiment. The foregoing may be used in accordance with monitoring the performance of applications on the server system for the particular services provided. Using the techniques described herein, data flow in connection with service provided may be gathered without modifications to the application code and planning ahead of time to guess how information will be gathered and what particular information will be gathered. The particular data items which are gathered and the conditions under which they are gathered may be performed dynamically based on the evaluation of rules at a particular point in time in which a data stream is received and captured. Using the techniques described herein, a commonly used service may be shared by more than one user. As described herein, the filter of the stream sensor receives data associated with an application. Using the set of rules, the stream sensor may then extract certain portions of data in accordance with the evaluation of those rules at that particular time. As described herein, the actions that may be performed in accordance with rules that evaluate to true may vary with each embodiment.

The foregoing techniques may be used in accordance with monitoring the performance of applications on the server system for the particular services provided. The particular data items which are gathered and the conditions under which they are gathered may be performed dynamically based on the evaluation of rules at a particular point in time in which a data stream is received and captured. The data gathered may be aggregated in accordance with each transaction or other aggregation conditions. In connection with aggregating XML message data into business transactions as described herein, message data flowing through a distributed network of service peers, using one or more transport technologies such as HTTP or various Message Queueing protocols, is filtered down to just the data of interest. A tracing process, as may be performed by an Aggregation Service, may then be executed at each application site to examine collected data to extract the business transaction data. The foregoing techniques may be used with real-time data gathering and monitoring of application data streams allowing observers to see and monitor transactions as they occur. It allows these observers to discover business transactions that are embedded in the stream data. A set of rules specifies how the XML embedded in the messages correspond to business transactions. The techniques described herein may also be used in discovering the business transactions embedded in the XML message stream using time-coherency and key-value pattern matching. External workflow specifications such as BPEL4WS (as described, for example, at http://www-106.ibm.com/developerworks/library/ws-bpel/), and WSFL (as described, for example, at http://www-3.ibm.com/software/solutions/webservices/pdf/WSFL.pdf), can also be used to discover these business transactions. In connection with time-coherency, messages exchanged between applications at a website, for example, at a predetermined time interval may be collected and associated with a particular transaction based on the time information included in each message. If there are multiple applications, messages received by each application at different times may correlate to performing different operations for a same transaction at different points in time. The key-value pattern matching may be used, for example, in connection with looking for messages with particular transaction information, such as customer identifier, account information, and the like.

One typical approach to data capture in a distributed environment as with Web Services is to consolidate the data from the nodes to a central repository and then to filter the collected data down to just the data of interest. However, this approach is not readily scalable. In contrast, the techniques described herein take a different approach by filtering data at the distributed nodes and then consolidates the already filtered data from the XML messages. The XML messages may be mapped to business transactions allowing an observer of the data stream to put a business context on the stream of monitored data. The techniques described herein may be used as with a monitoring system to determine business impact of downtime or failures in individual components, and the relationship between the components based on the messages exchanged.

While the invention has been disclosed in connection with preferred embodiments shown and described in detail, their modifications and improvements thereon will become readily apparent to those skilled in the art. Accordingly, the spirit and scope of the present invention should be limited only by the following claims.

APPENDIX A: Sample ODF File

<?xml version=“1.0” encoding=“utf-8”?>
<!-- serviceMonitor is the name of the configuration. The entire
configuration may be enabled or not

the revision SHOULD be modifed EACH time ANY changes are performed

to the configuration. The version

should remain constant.

-->
<serviceMonitor
xmlns=“http://www.serviceintegrity.com/serviceMonitor/rulesDefinition.xm
l” version=“1” enabled=“true” revision=“22”>

<!-- this is where we will stick config information that tells us

how to behave in general -->

<configuration>

<!-- Sampling says that only look at every nth operation.

This is useful if your server gets a

ton of traffic and the things you are asking us to do

would slow down the server if done on

each request -->

<sampling>5</sampling>
<!-- logFlushInterval indicates how often to flush buffered

output files. Any open buffered

file will be flushed every logFlushInterval seconds.

If this value is 0, the files will

never be flushed. The default value is 15. -->

<logFlushInterval>15</logFlushInterval>
<!-- Required attribute, contains the license of the product

-->

<licenseKey>TEST-20101231-

l5Cp/+bNh37HnjW/zApkrDTnhV8=</licenseKey>

<!-- reapAfter specifies the minimum number of days that an

orphaned log (directory) will be

left before we reap it. The filter will remove any

sub-directories under the log base

that are not owned by a log and have not been touched

for a least reapAfter days.

Default is 0, which means that the feature is disabled

-->

<reapAfter>1</reapAfter>
<!-- logErrorInterval specifies how often to log parse

errors on incoming requests in seconds.

The default value (3600) indicates that a message

indicating that there have been

parse errors on the server will be logged no more often

than once an hour.

A value of 0 indicates that all parse errors are to be

logged to the system event

log. Any value greater than or equal to 0 is allowed,

and specifies in seconds how often

to log parse error on incoming requests -->

<logErrorInterval>3600</logErrorInterval>

</configuration>
<!-- formats section is used to defined all format definitions

a format definition tells us how to write a variable to the

output device

In one embodiment, there are 2 kinds of formats: string and

time stamp

-->
<formats>

<!-- string format allows the user to define the following:

1) formatting
fieldWidth (0+): the minimum number of spaces to

take up for this field (0 means no limit)

maxLength (0+): the maximum number of characters to

print (0 means no limit)

justify (left or right): whether to justify the data

to the left or right

2) transforms
replace: replace all instances of the string in

“from” to the string in “to”

trim: truncate all leading and trailing whitespace

(“ ”, “\t”, “\n”)

encryption: encrypt this field using the given

algorithm, password in keyFile and output

using the encoding defined in “format”

singleLine: replace all new lines in the field with

spaces

encodeXml: encode according to xml encoding

definition

encodeBase64: encode according to the base64

encoding definition

-->
<string name=“PrivateString”>

<transforms>

<encryption algorithm=“aes” keyFile=“ticket.key”

format=“base64” />

</transforms>

</string>
<string name=“SecretString”>

<transforms>

<hash algorithms “md5” format=“base64” />

</transforms>

</string>
<string name=“String100”>

formatting fieldWidth=“100” maxLength=“100”

justify=“left” />

<transforms>

<replace>

<from>\t</from>
<to> </to>

</replace>
<trim/>
<encodeXml/>
<singleLine />

</transforms>

</string>
<string name=“Encoded100”>

<formatting fieldWidth=“100” maxLength=“100”

justify=“left” />

<transforms>

<encodeBase64/>

</transforms>

</string>
<!-- timestamp format expects that it will get an integer

that specifies time as the number of

```
    seconds since EPOCH (this means January 1, 1970 GMT)
    The output definition we use uses the format
```

specification defined by strftime( )

This says that % Y is equivalent to 4 digit year (i.e.

2002) and so on

-->
<timestamp name=“Timeformat”>%Y-%m-%d %H:%M:%S</timestamp>

</formats>
<!-- Fields allow you to define expressions that you are going to

use in either conditions or

output. For example lets say that I am interested in

printing the available credit for

each customer, but all I see in the request is the total

credit and the outstanding balance.

I then define an expression “Credit” that is TotalCredit −

Balance. Now I can print Credit

when I want to
-->
<fields>

<!-- The expressions supported in fields and conditional

expressions are:

add - numeric addition
sub - numeric subtraction
div - numeric division
mult - numeric multiplication
mod - numeric modulo (%)
eq - string, numeric, boolean equality
ne - string, numeric, boolean non-equality
lt - numeric less than
le - numeric less than or equal
gt - numeric greater than
ge - numeric greater than equal
slt - string less than
sle - string less than or equal
sgt - string greater than
sge - string greater than or equal
match - regular expression match (i.e. foo match

f[oO]+)

and - boolean
or - boolean
not - boolean unary negation
exists - unary

-->
<fieldDefinition name=“TotalBytes” type=“integer”>

<add>

<!-- Fields, conditions and output elements can

be of the following types:

serverVariable: (i.e. HttpStatus, Duration,

Timestamp)

header: HTTP header (i.e. Host, Referer)
element: xml element
soapOperation: the name of the soap request
soapParmeter: a parameter in the soap

request

soapFault: the fault (error) from the soap

request

literal: a constant value
field: user defined expression

-->
<serverVariable name=“BytesSent”/>
<serverVariable name=“BytesReceived”/>

</add>

</fieldDefinition>

</fields>
<!-- Destinations are the output mechaninsms available to the

filter

Currently the types of output mechanisms supported are: file

(file system), event (event log)

-->
<destinations>

<!-- Files must have a name. the path to the file written is

determined by the filter using the

directory attribute in the config section and the name

attribute designated here.

Optionally they may also specify whether to flush the

output on each write (by default false)

and whether they are enabled (default true). Finally

users may specify the maximum size (in megabytes)

that a file is allowed to read. If a file reaches that

limit, the file will either be rolled over

(if rollover is enabled) or rewound to the beginning.

(default 0, no limit)

-->
<file name =“Errorlog” enabled=“true” autoFlush=“false”

maxSize=“200”>

<!-- Files support an optional rollover specification

that allows the user to define when and where

to rollover the file. Rollover supports the

following options

interval [0]: (seconds) how often to roll over

(i.e. 86400 means every day). If this attribute is 0, there will

be no time-based rollover.
startTime [0]: (seconds) when to roll over. The

time from which we start counting interval. (i.e.

an interval of 86400 (24 hours) and a startTime or

7200, means we will roll the file

every day at 2:00 AM)
enabled [true]: whether the rollover is in use or

not.

backup [false]: whether to write log entries to the

backupDirectory if it is unable to write

them to the normal file (i.e. out of disk)
The name of the rollover files is based on the

configuration element's directory element,

the file element's name attribute and the date/time

at which the file was created and rolled over.

-->
<!-- <rollover enabled=“true” startTime=“7200”

interval=“86400” backup=“true”> -->

<rollover enabled=“true” startTime=“7200”

interval=“86400”>

<!-- Rollover support an optional copies element

that allows the user to define attributes of

the rolled over files. Copies supports the

following options

totalSize [0]: (megabytes) the maximum

(appoximate) amount of disk space that all rolledover

files can take.
zipLevel [1]: (number 0-9) the level of

compression to apply on the log

discardAfter [0]: (secodns) the maximum

number of seconds that a rolled over log will be allowed to

remain before we reap it. After the

specified number of seconds the log may be reaped (deleted)

even if the log does not exceed it

totalSize

-->
<copies totalSize=“1000” zipLevel=“1”

discardAfter=“1209600”/>

</rollover>
<!-- Delimited output suppport is provide through the

optional “delimited” element.

This element indicates that output file generated

will contain delimiters in between fields and

records. Any occurence of the one of the

delimiters in the actual data will be “escaped” by

another delimiter. The default delimiters are

“|” (pipe) for field, “\n” (new line) for record and

“\\” (single backslash) for escape. The defaults

may be overloaded by the element attributes

record, field and escape. The value of these

attributes must be the sequence of characters of the

delimiter in hexadecimal notation. For example

if the field delimiter should instead be a sequence

of two tabs, the element specification should be

<delimited field=“0x090x09”/>.

The element delimited supports the following

attributes:

field [0x7c] (pipe ‘|’): the separator between

fields, this separator will appear after EVERY field in a record

written to a delimited log
record [0x0a] (new line ‘\n’): the separator

between records, this separtor will apper after EVERY record

immediately following the last field delimiter
escape [0x5c] (backslash ‘\’): the escape

delimiter, this delimiter appears once before each instance of a
delimiter

(field, record or escape) in the actual log data.

The escape delimiter MUST be only one character long.

Note that delimiter may consist of more than one

character, and that they may contain non-printable

characters. Delimiters may not start with

another delimiter (i.e. field=“0x0a09” is invalid if record=“0x0a”)

-->
<delimited field=“0x7c” record=“0x0a” escape=“0x5c”/>

</file>
<!-- Event log entries also must have a name. They may

specify a severity (Error, Warning, Information,

AuditSuccess, AuditFailure), application (name that

will show up in event log), server (the

name of the host where the event will be logged ... if

omitted then event are logged locally)

Like files, you may have multiple event entries (i.e.

you may wish to have one to log warnings,

another for errors etc). Like file, the event

destination may be enabled or disabled

-->
<event name=“Eventlog” enabled=“true” severity=“Error”

application=“Test” server=“” />

</destinations>
<!-- rules define what to log, where to log it and when to do it.

-->

<rule name=“Errorlogger” enabled=“true”>

<!-- Each rule may have 0 or 1 conditions. The condition is

an expression that must evaluate to

true if the rule is to produce any output for this

message. As stated before, the expression

can consist of the logical, lexical and arithmetic

expressions described above combined to

result in a single boolean result

-->
<condition>

<and>

<eq>

<!-- headers indicate an HTTP header. The

header definition must include the name

and the direction (input|output)

-->
<header direction=“input” name=“Uri”/>
<!-- Literals define a constant -->
<literal>Accounting/Service1</literal>

</eq>
<or>

<!-- exists indicates that the following

expression is defined in the message -->

<exists>

<!-- element is an xml element. The

xml element must include a name which is the

combination of all ancestor

elements separated by spaces.

-->
<element

name=“http:\/\/schemas.xmlsoap.org\/soap\/envelope\/:Envelope”
direction=“output” />

</exists>
<ge>

<literal>40</literal>
<add>

<serverVariable

name=“BytesReceived” />

<serverVariable

name=“BytesSent” />

</add>

</ge>

</or>

</and>

</condition>
<!-- Output defines an individual output specification.

There must be at least 1 output specification

in each rule. Each output must include a reference to

a destination (defined above) and 1 or

more expressions for output. The output will submit

all the expressions provided in order to

the destination specified for processing

-->
<output destinations “Eventlog” enabled=“true”>

<literal>Error </literal>
<serverVariable name=“Status” displayName=“Status”/>
<literal> processing request from: </literal>
<serverVariable name=“ClientUserName” />
<literal>, </literal>
<!-- soapParameter is another form of expression that

defines a parameter in the soap request

soap parameters require a name (like element),

and a direction.

-->
<soapParameter name=“/TransactionId” direction=“input”

displayName=“Transaction” />

<literal>: </literal>
<field name=“TotalBytes” displayName=“Bandwidth”/>
<literal>\t</literal>
<!-- all expressions in an output section (except for

literal) may include a reference to a

format specification. This specification will be

used to alter the appearance of the

result prior to submission to the destination

-->
<soapParameter name=“/Payment/Balance”

direction=“input” format=“PrivateString” />

<soapParameter name=“/Account/Nanme” direction=“input”

format=“SecretString” />

</output>
<!-- outputs may also be disabled individually -->
<!-- Each output in a rule may contained a completely

different list of expressions -->

<output destination=“Errorlog” enabled=“true”>

<serverVariable name=“Timestamp” format=“Timeformat”

/>

<literal>: Error </literal>
<serverVariable name=“Status” />
<literal> processing request from: </literal>
<serverVariable name=“ClientUserName” />
<literal>, </literal>
<soapParameter name=“/TransactionId” direction=“input”

format=“String100”/>

<literal>. Details: </literal>
<soapOperation displayName=“Operation” />
<literal>:</literal>
<soapFault name=“/” format=“String100”

displayName= “Error” />

<literal>\nFull message:\n</literal>
<rawData direction=“input” kind=“xml”

displayName=“Input”/>

<literal>\n\n</literal>

</output>

</rule>

</serviceMonitor>

APPENDIX B: Description of XML Elements of an ODF File

add Element

The add element, an optional sub element of fieldDefinition and condition, indicates the start and end of a block in which users can list expressions to be added together. The add element requires 2 expressions that evaluate to a number.

| Start Element | End Element | Attribute Required | Attributes |
|---|---|---|---|
| <add> | </add> | N/A | (None) |

Attributes: None
Sub Elements

May be used 0-2 times:

| | |
|---|---|
| <serverVariable> | The serverVariable element indicates |
| | a server variable (e.g., HttpStatus, |
| | Duration, Timestamp) |
| <header> | The header element indicates an HTTP |
| | header (e.g., Host, Referrer) |
| <element> | The element element indicates an xml |
| | element |
| <soapOperation> | The soapOperation element indicates |
| | the name of the soap request |
| <soapParameter> | The soapParameter element indicates |
| | a parameter in the request |
| <soapFault> | The soapFault element indicates the |
| | error from the soap request |
| <literal> | The literal element indicates a |
| | constant value |
| <field> | The field element indicates a user- |
| | defined expression |
| <rawData> | The rawData element indicates that |
| | all information received in the |
| | request is to be logged. |

Other expressions (e.g., add, sub, mult . . .) may also be used as sub elements.

### EXAMPLES

The following example adds together the server variable named BytesSent and the server variable named BytesReceived, and returns the result:

<add>

<serverVariable name=“BytesSent” type=”int”/>
<serverVariable name=“BytesReceived” type=”int”/>

</add>

The following example multiplies the soapParameter named EarningsPerShare and the soapParameter named Shares, and adds the result to DividendsIncome:

<add>

<mult>

<soapParameter direction=“output”
name=“EarningsPerShare” type=”int”/>
<soapParameter direction=“output”
name=“Shares” type=”int”/>

</mult>
<soapParameter direction=“output”
name=“DividendsIncome” type=”int”/>

</add>

and Element

The and element, an optional sub element of fieldDefinition and condition, indicates the start and end of a block in which users can list conditions which must all be met.

| Start Element | End Element | Attribute Required | Attributes |
|---|---|---|---|
| <and> | </and> | N/A | (None) |

Attributes: None
Sub Elements

May be used 0 or more times:

| | |
|---|---|
| <serverVariable> | The serverVariable element indicates |
| | a server variable (e.g., HttpStatus, |
| | Duration, Timestamp) |
| <header> | The header element indicates an HTTP |
| | header (e.g., Host, Referrer) |
| <element> | The element element indicates an xml |
| | element |
| <soapOperation> | The soapOperation element indicates |
| | the name of the soap request |
| <soapParameter> | The soapParameter element indicates |
| | a parameter in the request |
| <soapFault> | The soapFault element indicates the |
| | error from the soap request |
| <literal> | The literal element indicates a |
| | constant value |
| <field> | The field element indicates a user- |
| | defined expression |
| <rawData> | The rawData element indicates that |
| | all information received in the |
| | request is to be logged. |

Other expressions (e.g, add, sub, mult . . . ) may also be used as sub elements.

### Example

The following example checks to see if the values of foo and bar are both true. If so, the condition is met, and true is returned:

<and>

<field name=“foo”>true</field>
<field name=“bar”>true</field>

</and>

condition Element

The condition element, an optional sub element of rule, is an expression that must evaluate to true if the rule is to produce any output for this message. The expression can combine any of the logical, lexical, and arithmetic expressions described throughout this section; and must produce a single Boolean result.

| Start Element | End Element | Attribute Required | Attributes |
|---|---|---|---|
| <condition> | </condition> | N/A | (None) |

Attributes: None
Sub Elements

May be used 0-1 times:

| | |
|---|---|
| <add> | The add element is for numeric addition |
| <sub> | The sub element is for numeric subtraction |
| <div> | The div element is for numeric division |
| <mult> | The mult element is for numeric multiplication |
| <mod> | The mod element is for numeric modulo (%) |
| <eq> | The eq element is for string, numeric or Boolean equality |
| <ne> | The ne element is for string, numeric or Boolean inequality |
| <lt> | The lt element is for numeric less than |
| <le> | The le element is for numeric less than or equal to |
| <gt> | The gt element is for numeric greater than |
| <ge> | The ge element is for numeric greater than or equal to |
| <slt> | The slt element is for string less than |
| <sle> | The sle element is for string less than or equal to |
| <sgt> | The slt element is for string greater than |
| <sge> | The sle element is for string greater than or equal to |
| <match> | The match element is for regular expression matches |
| <and> | The and element is for Boolean add |
| <or> | The or element is for Boolean or |
| <not> | The not element is for Boolean unary negation |
| <exists> | The exists element is unary |

configuration Element

The configuration element, an optional unique sub element of serviceMonitor, demarcates the start and end of a block of information dictating the behavior of the service. The only configuration sub elements currently supported is sampling.

| Start Element | End Element | Attribute Required | Attributes |
|---|---|---|---|
| <configuration> | </configuration> | N/A | (None) |

Attributes: None
Sub Elements

May be used 0-1 times:

| | |
|---|---|
| <sampling> | sampling indicates how often |
| | operations should be sampled. |
| <logFlushInterval> | logFlushInterval shows the number |
| | of seconds to wait before flushing |
| | file destinations that do not have |
| | autoFlush turned on or a zero |
| | buffer size. |

copies Element

The copies element, an optional sub element of rollover, specifies where and when the log file should be rolled over

| Start Element | End Element | Attribute Required | Attributes |
|---|---|---|---|
| <copies> | </copies> | No | totalSize |
| | | No | zipLevel |

Attributes

totalSize
totalSize represents the maximum disk space, in megabytes, that all rolled-over files may take cumulatively. Older files will be removed when this limit is reached. If a new rollover copy would exceed this limit, the oldest files will be removed until there is either a single copy left, or disk usage is below the specified threshold. The default value, 0, indicates that older files will never be deleted by the application. The value of totalSize must be a positive integer.

zipLevel

ZipLevel indicates the compression level that will be applied to rolled-over versions of the log. Acceptable values range from 0 to 9. The default value of 1 indicates that fast compression will be performed.

Example: <copies totalsize=″1000″ zipLevel=″0″ />

Sub Elements: None

Note: Currently the attribute zipLevel is ignored by the parser. All logs are written uncompressed onto disk regardless of the value of zipLevel

delimited Element

The delimited element, an optional sub element of file, indicates that the output file generated will contain delimiters between fields and records. Any occurrence of one of the delimiters in the actual data will be “escaped” by another delimiter. Default delimiters are “|” (pipe) for field, “\n” (new line) for record and “\” (single backslash) for escape. The defaults may be overloaded by the element attributes record, field and escape. The value of these attributes must be the sequence of characters of the delimiter in hexadecimal notation. For example if the field delimiter should be a sequence of two tabs instead of the default pipe, the element specification should be <delimited field=“0x090x09”/>.

| Start Element | End Element | Attribute Required | Attributes |
|---|---|---|---|
| <delimited> | </delimited> | no | field |
| | | no | record |
| | | no | escape |

Attributes

field [0x7c]
The separator between fields, this delimiter will appear after EVERY field in a record written to a delimited log. The field delimiter may consist of more than one character.

record [0x12]
The separator between records, this delimiter will appear after EVERY record immediately following the last field delimiter. The record delimiter may consist of more than one character.

escape [0x5c]

The escape delimiter, this delimiter appears once before each instance of a delimiter (field, record or escape) in the actual log data. Note that the escape delimiter can only be one character long.

Example, with the values set to defaults:
<delimited field=“0x7c” record=“0x12” escape=“0x5c” />

Note that no delimiter may start with the same character(s) as another. (So <delimited field=“0xAA” record=“0xAA0xBB” escape=“0x5c”/> would not be permitted, but <delimited field=“0xAA” record=“0xBB0xAA” escape=“0x5c”/> would be fine.
Note further that all delimiters may contain non-printable characters.
Note: Only delimited files may be used by the product's LocalAggregator for reports and monitoring actions.
Sub Elements: None
destinations Element

The destinations element, an optional sub element of serviceMonitor, demarcates the start and end of a block of information specifying the output mechanisms available to the filter. Output mechanisms currently supported are file (file system) and event (event log). (Note that while destinations is optional, it can only be removed if there are no output elements in the rules.xml file.)

| Start Element | End Element | Attribute Required | Attributes |
|---|---|---|---|
| <destinations> | </destinations> | N/A | (None) |

Attributes: None
Sub Elements

At least one of the following must be defined; multiple instances of each are allowed.

| | |
|---|---|
| <file> | file specifies file system |
| <event> | event specifies event log |

div Element

The div element, an optional sub element of fieldDefinition and condition, indicates the start and end of a block in which users can list expressions to be divided. The first expression will be divided by the second.

| Start Element | End Element | Attribute Required | Attributes |
|---|---|---|---|
| <div> | </div> | N/A | (None) |

Attributes: None
Sub Elements

May be used 0 or more times:

| | |
|---|---|
| <serverVariable> | The serverVariable element indicates |
| | a server variable (e.g., HttpStatus, |
| | Duration, Timestamp) |
| <header> | The header element indicates an HTTP |
| | header (e.g., Host, Referrer) |
| <element> | The element element indicates an xml |
| | element |
| <soapOperation> | The soapOperation element indicates |
| | the name of the soap request |
| <soapParameter> | The soapParameter element indicates |
| | a parameter in the request |
| <soapFault> | The soapFault element indicates the |
| | error from the soap request |
| <literal> | The literal element indicates a |
| | constant value |
| <field> | The field element indicates a user- |
| | defined expression |
| <rawData> | The rawData element indicates that |
| | all information received in the |
| | request is to be logged. |

Other expressions (e.g, add, sub, mult . . . ) may also be used as sub elements.

### Example

The following example divides the user-defined field named BigNumber by the user-defined field named SmallNumber, and returns the result:

<div>

<field name=“BigNumber” />
<field name=“SmallNumber” />
</div>

element Element

element, an optional sub element used in expressions defined under fields, condition, and output, specifies the name of an xml element.

| Start Element | End Element | Attribute Required | Attributes |
|---|---|---|---|
| <element> | </element> | Yes | name |
| | | Yes | direction |
| | | No | format |
| | | No | displayName |
| | | No | type |

Attributes

name

name, a required attribute, must consist of the combination of all ancestor elements in XPATH-compliant form, as described in the following examples:

/ABC/DEF defines all sub elements <DEF> of <ABC>
/ABC/DEF[2] defines the second sub element <DEF> of <ABC>
/ABC/[1] defines the first sub element of <ABC>
/ABC/DEF[2]/GHI selects all sub elements <GHI>
of the second element named <DEF>

of<ABC>

direction
direction, a required attribute, indicates the direction (input or output) of the request in question.

format
format, an optional attribute, specifies the format of the header in question. Note that in this example, the format String100 has previously been defined in the formats section.

displayName

displayName, an optional attribute, is used only with delimited output to override the default name of the field with a name the user prefers.

| | |
|---|---|
| Example: | <element name=“/foo/bar” direction=“output” |

format=“String100” displayName=“boo” />

type

type, an optional attribute, is used exclusively in delimited files to modify the header with the type information of the field. The GUI uses type to ascertain which fields are numeric (and thus whether they can be operated upon). If no type is specified, the filter will use the default value, “unknown”.

| | |
|---|---|
| Example: | <element name=“/foo/bar” direction=“output” |

type=“String” >

Sub Elements: None
encodeBase64 Element

The encodeBase64 element, an optional sub element of transforms, indicates that the field should be encoded according to the base64 encoding definition.

| Start Element | End Element | Attribute Required | Attributes |
|---|---|---|---|
| <encodeBase64> | </encodeBase64> | N/A | (None) |

Attributes: None
Sub Elements: None
encodeXml Element

The encodeXml element, an optional sub element of transforms, indicates that the field should be encoded according to xml encoding definition. Xml encoding means that any occurrence of the characters <'''&> will be replaced by &lt; &quot; &apos; &amp; &gt; respectively

| Start Element | End Element | Attribute Required | Attributes |
|---|---|---|---|
| <encodeXml> | </encodeXml> | N/A | (None) |

Attributes: None
Sub Elements: None
encryption Element

The encryption element, an optional sub element of transforms, indicates that this field should be encrypted using the given values for algorithm and keyFile, and should be outputted using the encoding defined in format. Note that in cases where several transforms will be chained together, encryption must always be used last. (Later transforms could conceivably prevent decryption from being successful.)

| Start Element | End Element | Attribute Required | Attributes |
|---|---|---|---|
| <encryption> | </encryption> | No | algorithm |
| | | Yes | keyFile |
| | | No | format |

Attributes

algorithm
algorithm, an optional attribute, indicates the algorithm with which the field should be encrypted. The only value currently valid is aes (default).

keyFile
keyFile, a required attribute, indicates the path to a file containing the key with which the encryption should take place.

format

format, an optional attribute, defines the encoding in which the output should be formatted. The only value currently valid is base64 (default).

| | |
|---|---|
| Example: | <encryption algorithm=“aes” keyFile=“tickets.key” |

format=“base64” />

Sub Elements: None

Note: The KeyFile must be created and must contain a valid encryption key before the configuration can successfully be loaded onto the module. It is recommended that access to the key file be restricted such that only the system administrator can write read and write it, and the web-server can read it.

eq Element

The eq element, an optional sub element of fieldDefinition and condition, indicates the start and end of a block in which users can list expressions to be compared for equality. This comparison can be performed on strings, numbers, or Boolean values. Note that if the types are not compatible, the operation will throw, and the entire condition will evaluate to false.

| Start Element | End Element | Attribute Required | Attributes |
|---|---|---|---|
| <eq> | </eq> | N/A | (None) |

Attributes: None
Sub Elements

May be used 0 or more times:

| | |
|---|---|
| <serverVariable> | The serverVariable element indicates |
| | a server variable (e.g., HttpStatus, |
| | Duration, Timestamp) |
| <header> | The header element indicates an HTTP |
| | header (e.g., Host, Referrer) |
| <element> | The element element indicates an xml |
| | element |
| <soapOperation> | The soapOperation element indicates |
| | the name of the soap request |
| <soapParameter> | The soapParameter element indicates |
| | a parameter in the request |
| <soapFault> | The soapFault element indicates the |
| | error from the soap request |
| <literal> | The literal element indicates a |
| | constant value |
| <field> | The field element indicates a user- |
| | defined expression |
| <rawData> | The rawData element indicates that |
| | all information received in the |
| | request is to be logged. |

Other expressions (e.g, add, sub, mult . . . ) may also be used as sub elements.

### Example

The following example compares the values of BytesSent and BytesReceived. If the values are the same, it returns a value of true:

<eq>

<serverVariable name=“BytesSent” />
<serverVariable name=“BytesReceived” />

</eq>

event Element

The event element, an optional sub element of destinations, demarcates the start and end of a block of information specifying details about output to the event log subsystem.

| Start Element | End Element | Attribute Required | Attributes |
|---|---|---|---|
| <event> | </event> | Yes | name |
| | | No | enabled |
| | | No | severity |
| | | No | application |
| | | No | server |

Attributes

name

name, a required attribute, should be the name of the destination.

| | |
|---|---|
| Example: | < event name=“Eventlog” /> |

enabled

enabled, an optional attribute, specifies whether or not logging should be enabled to this destination. It defaults to true.

| | |
|---|---|
| Example: | <event name=“Eventlog” enabled=“true” /> |

severity

severity, an optional attribute, specifies what level the message should be logged. Valid options are Error, warning, Information, AuditSuccess, and AuditFailure.

| | |
|---|---|
| Example: | <event name=“Eventlog” severity=“error” /> |

application

application, an optional attribute, is the name of the application that should appear in the event log. It defaults to “SiftLog”.

| | |
|---|---|
| Example: | <event name=“Errorlog” application=“testApp”> |

server
server, an optional attribute, is the name of the host where the events should be logged.

If this option is omitted, events are logged locally.

| | |
|---|---|
| Example: | <event name=“Errorlog” server=“ ”> |

Sub Elements: None

Note: If event is configured to log to a different application, the user should install the SIFT message DLL as the event handler for that application. If the server attribute is set, the user should configure the domain so that the SIFTParser has the necessary permissions to log to that system.

exists Element

The exists element, an optional sub element of fieldDefinition and condition, indicates that the expression it contains is defined in the message.

| Start Element | End Element | Attribute Required | Attributes |
|---|---|---|---|
| <exists> | </exists> | N/A | (None) |

Attributes: None
Sub Elements

May be used 0 or more times:

| | |
|---|---|
| <serverVariable> | The serverVariable element indicates a |
| | server variable (e.g., HttpStatus, |
| | Duration, Timestamp) |
| <header> | The header element indicates an HTTP |
| | header (e.g., Host, Referrer) |
| <element> | The element element indicates an xml |
| | element |
| <soapOperation> | The soapOperation element indicates |
| | the name of the soap request |
| <soapParameter> | The soapParameter element indicates |
| | a parameter in the request |
| <soapFault> | The soapFault element indicates the |
| | error from the soap request |
| <literal> | The literal element indicates a |
| | constant value |
| <field> | The field element indicates a user- |
| | defined expression |
| <rawData> | The rawData element indicates that |
| | all information received in the |
| | request is to be logged. |

Other expressions (e.g, add, sub, mult . . . ) may also be used as sub elements.

### Example

<exists>

<xml name=“http://schemas.xmlsoap.org/soap/envelope/:Envelope”
direction=“output”

/>
</exists>

field Element

The field element, an optional sub element used in expressions defined under fields, condition, and output, is a reference to a fieldDefinition element. For instance, if you want to obtain a number that is the sum or difference of two expressions in a request, you can define an expression to obtain that result using fieldDefinition. You would refer to that element later using field.

| Start Element | End Element | Attribute Required | Attributes |
|---|---|---|---|
| <field> | </field> | Yes | name |
| | | No | format |
| | | No | displayName |
| | | No | type |

Attributes

name
name, a required attribute, should be the name of the soapParameter in question. The parameter may refer to a component of a complex parameter (i.e. a data structure or an array).

format
format, an optional attribute, specifies the format of the soapParameter in question. Note that in this example, the format String100 has previously been defined in the formats section.

displayName

displayName, an optional attribute, is used only with delimited output to override the default name of the field with a name the user prefers.

| | |
|---|---|
| Example: | <fieldname=“TransactionId Value” |

format=“String100” displayName=“boo” />

type

type, an optional attribute, is used exclusively in delimited files to modify the header with the type information of the field. The GUI uses type to ascertain which fields are numeric (and thus whether they can be operated upon). If no type is specified, the filter will use the default value, “unknown”.

| | |
|---|---|
| Example: | <fieidname=“TransactionId Value” type=“int”> |

Sub Elements: None

fieldDefinition Element

The fieldDefinition element, an optional sub element of fields, indicates the start and end of a block in which users can define expressions that will be later used in either conditions or output. For instance, if you want to obtain a number that is the sum or difference of two expressions in a request, you can define an expression to obtain that result using fieldDefinition. You would refer to that element later using field.

| Start Element | End Element | Attribute Required | Attributes |
|---|---|---|---|
| <fieldDefinition> | </fieldDefinition> | Yes | name |
| | | No | type |

Attributes

name

name, a required attribute, indicates the name of the field in question. This is specified as a string of characters enclosed in quotes.

| | |
|---|---|
| Example: | <fieldDefinition name=“TotalBytes”> |

type

type, an optional attribute, is used by the GUI to “remember” what type the field should resolve to so that it will know whether it can be aggregated. The default value is “ ”.

| | |
|---|---|
| Example: | <fieldDefinition name=“TotalBytes” type=“int”> |

Sub Elements

May be used 0-1 times:

| | |
|---|---|
| <add> | The add element is for numeric addition |
| <sub> | The sub element is for numeric subtraction |
| <div> | The div element is for numeric division |
| <mult> | The mult element is for numeric multiplication |
| <mod> | The mod element is for numeric modulo (%) |
| <eq> | The eq element is for string, numeric or |
| | Boolean equality |
| <ne> | The ne element is for string, numeric or |
| | Boolean inequality |
| <lt> | The lt element is for numeric less than |
| <le> | The le element is for numeric less than |
| | or equal to |
| <gt> | The gt element is for numeric greater than |
| <ge> | The ge element is for numeric greater than |
| | or equal to |
| <slt> | The slt element is for string less than |
| <sle> | The sle element is for string less than or |
| | equal to |
| <sgt> | The slt element is for string greater than |
| <sge> | The sle element is for string greater than |
| | or equal to |
| <match> | The match element is for regular expression |
| | matches |
| <and> | The and element is for Boolean add |
| <or> | The or element is for Boolean or |
| <not> | The not element is for Boolean unary negation |
| <exists> | The exists element is unary |

fields Element

The fields element, an optional sub element of serviceMonitor, indicates the start and end of a block in which users can define expressions to be used in either conditions or output.

| Start Element | End Element | Attribute Required | Attributes |
|---|---|---|---|
| <fields> | </fields> | N/A | (None) |

Attributes: None
Sub Elements

May be used 0 or more times:

| | |
|---|---|
| <fieldDefinition> | The fieldDefinition element is where custom |

expressions are defined.

file Element

The file element, an optional sub element of destinations, demarcates the start and end of a block of information specifying details about output to the file system.

| Start Element | End Element | Attribute Required | Attributes |
|---|---|---|---|
| <file> | </file> | Yes | name |
| | | No | enabled |
| | | No | autoFlush |
| | | No | bufferSize |
| | | No | maxSize |

Attributes

name

name, a required attribute, should be the name of the destination in question.

| | |
|---|---|
| Example: | <file name=“Errorlog”> |

enabled

enabled, an optional attribute, specifies whether or not logging should be enabled. It defaults to true.

| | |
|---|---|
| Example: | <file name=“Errorlog” enabled=“false”> |

autoFlush

autoFlush, an optional attribute, specifies whether or not to flush the output on each write. It defaults to false.

| | |
|---|---|
| Example: | <file name=“Errorlog” autoFlush=“true”> |

bufferSize
The bufferSize element, an optional sub element of file, indicates the buffering size which the SIFT parser will use. Only values between −1 and 10 Meg are valid. bufferSize impacts the behavior of the file in the following way:
   If the value is the default (−1), the SIFT parser will use the default buffering mechanism for the file writer.
   If the value is 0, the SIFT parser will use no buffer. This is currently the same as having autoFlush turned off. (This will change in the future.)

If the value is any other positive integer (e.g., 64000), the SIFT parser will use that as the buffer for the writer. If there is no urgent need to retain all information if the server goes down, setting this to a larger number will ensure efficient writing.

| | |
|---|---|
| Example: | <file name=“Errorlog” bufferSize=“64000”> |

maxSize

maxSize is the maximum size in megabytes that the log file should be allowed to reach. If the log reaches that limit, the rollover manager will either roll it over (if rollover is enabled) or rewind it to the beginning. The default value, 0, indicates that the file should not be rolled over because of size. Only positive integers are allowed.

| | |
|---|---|
| Example: | <file name=“Errorlog” MaxSize=“1”> |

Sub Elements

May be used 0-1 times:

| | |
|---|---|
| <rollover> | rollover specifies how the file should |
| | be rolled over |
| <delimited> | delimited indicates that the output |
| | file will contain delimiters between |
| | fields and records. |

formats Element

The formats element, an optional sub element of serviceMonitor, is used to mark the start and end of a set of format definitions in an ODF file. Format definitions indicate how variables should be written to output devices.

| Start Element | End Element | Attribute Required | Attributes |
|---|---|---|---|
| <formats> | </formats> | N/A | (None) |

Attributes: None
Sub Elements

May be used 0 or more times:

| | |
|---|---|
| <string> | The string element allows the user to |
| | define a string format for output. |
| <timestamp> | The timestamp element allows the user |
| | to define a time format for output. |

formatting Element

The formatting element, an optional sub element of string, indicates how the given string should be encoded or otherwise transformed when it is written to the output device.

| Start Element | End Element | Attribute Required | Attributes |
|---|---|---|---|
| <formatting> | </formatting> | No | fieldWidth |
| | | No | maxLength |
| | | No | justify |

Attributes

fieldWidth

fieldWidth, an optional attribute, indicates the minimum number of spaces to allot for this field. This is specified as a positive integer, with 0 itself meaning no limit. The default value is 0.

| | |
|---|---|
| Example: | <formatting field Width=“100” /> |

maxLength

maxLength, an optional attribute, indicates the maximum number of characters to print for this field. This is specified as a positive integer, with 0 itself meaning no limit. The default is 0.

| | |
|---|---|
| Example: | <formatting maxLength=“100” /> |

justify

justify, an optional attribute, indicates how the data should be justified. Valid values are right and left. The default is left.

| | |
|---|---|
| Example: | <formatting justify=“left” /> |

Sub Elements: None
from Element

The from element is a required sub element of replace. From takes a string that will be replaced with the contents of the to element when this is written to the output device

| Start Element | End Element | Attribute Required | Attributes |
|---|---|---|---|
| <from> | </from> | N/A | (None) |

Attributes: None
Sub Elements: None

Valid values for this element include any string (Strings must be encoded to conform with the xml specification). Note that from must always be paired with to. The following example replaces the string “Rags” with the string “Riches”:

| | |
|---|---|
| Example: | <from>Rags</from> |

<to>Riches</to>

ge Element

The ge element, an optional sub element of fieldDefinition and condition, indicates the start and end of a block in which users can list numbers to be compared to see if one is greater than or equal to the other.

| Start Element | End Element | Attribute Required | Attributes |
|---|---|---|---|
| <ge> | </ge> | N/A | (None) |

Attributes: None
Sub Elements

May be used 0 or more times:

| | |
|---|---|
| <serverVariable> | The serverVariable element indicates |
| | a server variable (e.g., HttpStatus, |
| | Duration, Timestamp) |
| <header> | The header element indicates an HTTP |
| | header (e.g., Host, Referrer) |
| <element> | The element element indicates an xml |
| | element |
| <soapOperation> | The soapOperation element indicates |
| | the name of the soap request |
| <soapParameter> | The soapParameter element indicates |
| | a parameter in the request |
| <soapFault> | The soapFault element indicates the |
| | error from the soap request |
| <literal> | The literal element indicates a |
| | constant value |
| <field> | The field element indicates a user- |
| | defined expression |
| <rawData> | The rawData element indicates that |
| | all information received in the |
| | request is to be logged. |

Other expressions (e.g, add, sub, mult . . . ) may also be used as sub elements.

### Example

The following example compares the values of BytesSent and BytesReceived. If the former is greater than or equal to the latter, it returns a value of true:

<ge>

<serverVariable name=“BytesSent” />
<serverVariable name=“BytesReceived” />

</ge>

gt Element

The gt element, an optional sub element of fieldDefinition and condition, indicates the start and end of a block in which users can list numbers to be compared to see if one is greater than the other.

| Start Element | End Element | Attribute Required | Attributes |
|---|---|---|---|
| <gt> | </gt> | N/A | (None) |

Attributes: None
Sub Elements

May be used 0 or more times:

| | |
|---|---|
| <serverVariable> | The serverVariable element indicates |
| | a server variable (e.g., HttpStatus, |
| | Duration, Timestamp) |
| <header> | The header element indicates an HTTP |
| | header (e.g., Host, Referrer) |
| <element> | The element element indicates an xml |
| | element |
| <soapOperation> | The soapOperation element indicates |
| | the name of the soap request |
| <soapParameter> | The soapParameter element indicates |
| | a parameter in the request |
| <soapFault> | The soapFault element indicates the |
| | error from the soap request |
| <literal> | The literal element indicates a |
| | constant value |
| <field> | The field element indicates a user- |
| | defined expression |
| <rawData> | The rawData element indicates that |
| | all information received in the |
| | request is to be logged. |

Other expressions (e.g, add, sub, mult . . . ) may also be used as sub elements.

### Example

The following example compares the values of BytesSent and BytesReceived. If the former is greater than the latter, it returns a value of true:

<gt>

<serverVariable name=“BytesSent” />
<serverVariable name=“BytesReceived” />

</gt>

hash Element

The hash element, an optional sub element of transforms, indicates that this field should be hashed using the given value for algorithm, and should be outputted using the encoding defined in format.

| Start Element | End Element | Attribute Required | Attributes |
|---|---|---|---|
| <hash> | </hash> | No | algorithm |
| | | No | format |

Attributes

Algorithm
Algorithm, an optional attribute, indicates the algorithm with which the field should be hashed. The only value currently valid is md5 (default).

Format

Format, an optional attribute, defines the encoding in which the output should be formatted. The only value currently valid is base64 (default).

| | |
|---|---|
| Example: | <hash algorithm=“md5” format=“base64” /> |

Sub Elements: None
header Element

The header element, an optional sub element used in expressions defined under fields, condition, and output, specifies the name of an HTTP header.

| Start Element | End Element | Attribute Required | Attributes |
|---|---|---|---|
| <header> | </header> | Yes | direction |
| | | Yes | name |
| | | No | format |
| | | No | displayName |
| | | No | type |

Attributes

direction
direction, a required attribute, indicates the direction (input or output) of the HTTP header in question.

name
name, a required attribute, indicates the name of the HTTP header in question. This is specified as a string of characters enclosed in quotes.

format
format, an optional attribute, specifies the format of the HTTP header in question. Note that in this example, the format String100 has previously been defined in the formats section.

displayName

displayName, an optional attribute, is used only with delimited output to override the default name of the field with a name the user prefers.

| | |
|---|---|
| Example: | <header direction=“input” name=“Uri” format=“String100” |

displayName=“boo” />

type

type, an optional attribute, is used exclusively in delimited files to modify the header with the type information of the field. The GUI uses type to ascertain which fields are numeric (and thus whether they can be operated upon). If no type is specified, the filter will use the default value, “unknown”.

| | |
|---|---|
| Example: | <header direction=“input” name=“Uri” type=“String” /> |

Sub Elements: None
le Element

The le element, an optional sub element of fieldDefinition and condition, indicates the start and end of a block in which users can list numbers to be compared to see if one is less than or equal to the other.

| Start Element | End Element | Attribute Required | Attributes |
|---|---|---|---|
| <le> | </le> | N/A | (None) |

Attributes: None
Sub Elements

May be used 0 or more times:

| | |
|---|---|
| <serverVariable> | The serverVariable element indicates |
| | a server variable (e.g., HttpStatus, |
| | Duration, Timestamp) |
| <header> | The header element indicates an HTTP |
| | header (e.g., Host, Referrer) |
| <element> | The element element indicates an xml |
| | element |
| <soapOperation> | The soapOperation element indicates |
| | the name of the soap request |
| <soapParameter> | The soapParameter element indicates |
| | a parameter in the request |
| <soapFault> | The soapFault element indicates the |
| | error from the soap request |
| <literal> | The literal element indicates a |
| | constant value |
| <field> | The field element indicates a user- |
| | defined expression |
| <rawData> | The rawData element indicates that |
| | all information received in the |
| | request is to be logged. |

Other expressions (e.g, add, sub, mult . . . ) may also be used as sub elements.

### Example

The following example compares the values of BytesSent and BytesReceived. If the former is less than or equal to the latter, it returns a value of true:

<le>

<serverVariable name=“BytesSent” />
<serverVariable name=“BytesReceived” />

</le>

literal Element

The literal element, an optional sub element used in expressions defined under fields, condition, and output, indicates a constant, specified within the elements.

| Start Element | End Element | Attribute Required | Attributes |
|---|---|---|---|
| <literal> | </literal> | N/A | (None) |

Attributes: None
Sub Elements: None

### Example

<literal>processing request from:</literal>

Note that the contents within this element really are interpreted literally. \n, for instance, does not result in a carriage return, but prints literally as backslash n.

logFlushInterval Element

logFlushInterval, an optional sub element of configuration, indicates the number of seconds to wait before flushing all file destinations that do not have autoFlush turned on or a zero buffer size (i.e., file destinations that have buffering enabled). The purpose of this feature is to ensure that data does not remain in the stream buffer for more than logFlushlnterval seconds.

| | | Attribute | |
|---|---|---|---|
| Start Element | End Element | Required | Attributes |
| <logFlushInterval> | </logFlushInterval> | N/A | (None) |

Attributes: None
Sub Elements: None

The value for logFlushInterval can be any integer greater than or equal to 0, and should be enclosed directly in the element. If the element is not present, the product will default to a logFlushlnterval of 15 seconds; if its value is 0, there will be no logFlushInterval.

| | |
|---|---|
| Example: | <logFlushInterval>5</logFlushInterval> |

lt Element

The lt element, an optional sub element of fieldDefinition and condition, indicates the start and end of a block in which users can list numbers to be compared to see if one is less than the other.

| Start Element | End Element | Attribute Required | Attributes |
|---|---|---|---|
| <lt> | </lt> | N/A | (None) |

Attributes: None
Sub Elements

May be used 0 or more times:

| | |
|---|---|
| <serverVariable> | The serverVariable element indicates |
| | a server variable (e.g., HttpStatus, |
| | Duration, Timestamp) |
| <header> | The header element indicates an HTTP |
| | header (e.g., Host, Referrer) |
| <element> | The element element indicates an xml |
| | element |
| <soapOperation> | The soapOperation element indicates |
| | the name of the soap request |
| <soapParameter> | The soapParameter element indicates |
| | a parameter in the request |
| <soapFault> | The soapFault element indicates the |
| | error from the soap request |
| <literal> | The literal element indicates a |
| | constant value |
| <field> | The field element indicates a user- |
| | defined expression |
| <rawData> | The rawData element indicates that |
| | all information received in the |
| | request is to be logged. |

Other expressions (e.g, add, sub, mult . . . ) may also be used as sub elements.

### Example

The following example compares the values of BytesSent and BytesReceived. If the former is less than the latter, it returns a value of true:

<lt>

<serverVariable name=“BytesSent” />
<serverVariable name=“BytesReceived” />

</lt>

match Element

The match element, an optional sub element of fieldDefinition and condition, indicates the start and end of a block in which users can list perl regular expressions to see if they match.

| Start Element | End Element | Attribute Required | Attributes |
|---|---|---|---|
| <match> | </match> | N/A | (None) |

Attributes: None
Sub Elements

May be used 0 or more times:

| | |
|---|---|
| <serverVariable> | The serverVariable element indicates |
| | a server variable (e.g., HttpStatus, |
| | Duration, Timestamp) |
| <header> | The header element indicates an HTTP |
| | header (e.g., Host, Referrer) |
| <element> | The element element indicates an xml |
| | element |
| <soapOperation> | The soapOperation element indicates |
| | the name of the soap request |
| <soapParameter> | The soapParameter element indicates |
| | a parameter in the request |
| <soapFault> | The soapFault element indicates the |
| | error from the soap request |
| <literal> | The literal element indicates a |
| | constant value |
| <field> | The field element indicates a user- |
| | defined expression |
| <rawData> | The rawData element indicates that |
| | all information received in the |
| | request is to be logged. |

Other expressions (e.g, add, sub, mult . . . ) may also be used as sub elements.

### Example

The following example compares the values of two fields to see if they match:

<match>

<field name=“foo” />

<field name=“\hat{ }fo+$” />

</match>

mod Element

The mod element, an optional sub element of fieldDefinition and condition, indicates the start and end of a block in which users can list expressions to be divided. The first expression will be divided by the second, and the remainder returned.

| Start Element | End Element | Attribute Required | Attributes |
|---|---|---|---|
| <mod> | </mod> | N/A | (None) |

Attributes: None
Sub Elements

May be used 0 or more times:

| | |
|---|---|
| <serverVariable> | The serverVariable element indicates |
| | a server variable (e.g., HttpStatus, |
| | Duration, Timestamp) |
| <header> | The header element indicates an HTTP |
| | header (e.g., Host, Referrer) |
| <element> | The element element indicates an xml |
| | element |
| <soapOperation> | The soapOperation element indicates |
| | the name of the soap request |
| <soapParameter> | The soapParameter element indicates |
| | a parameter in the request |
| <soapFault> | The soapFault element indicates the |
| | error from the soap request |
| <literal> | The literal element indicates a |
| | constant value |
| <field> | The field element indicates a user- |
| | defined expression |
| <rawData> | The rawData element indicates that |
| | all information received in the |
| | request is to be logged. |

Other expressions (e.g, add, sub, mult . . . ) may also be used as sub elements.

### Example

The following example takes the user-defined field named BigNumber, divides it by the user-defined field named SmallNumber, and returns the remainder:

<mod>

<field name=“BigNumber” />
<field name=“SmallNumber” />

</mod>

mult Element

The mult element, an optional sub element of fieldDefinition and condition, indicates the start and end of a block in which users can list expressions to be multiplied.

| Start Element | End Element | Attribute Required | Attributes |
|---|---|---|---|
| <mult> | </mult> | N/A | (None) |

Attributes: None
Sub Elements:

0 or more times:

| | |
|---|---|
| <serverVariable> | The serverVariable element indicates |
| | a server variable (e.g., HttpStatus, |
| | Duration, Timestamp) |
| <header> | The header element indicates an HTTP |
| | header (e.g., Host, Referrer) |
| <element> | The element element indicates an xml |
| | element |
| <soapOperation> | The soapOperation element indicates |
| | the name of the soap request |
| <soapParameter> | The soapParameter element indicates |
| | a parameter in the request |
| <soapFault> | The soapFault element indicates the |
| | error from the soap request |
| <literal> | The literal element indicates a |
| | constant value |
| <field> | The field element indicates a user- |
| | defined expression |
| <rawData> | The rawData element indicates that |
| | all information received in the |
| | request is to be logged. |

Other expressions (e.g, add, sub, mult . . . ) may also be used as sub elements.

### Example

The following example multiplies the user-defined field named BigNumber by the user-defined field named SmallNumber, and returns the result:

<mult>

<field name=“BigNumber” />
<field name=“SmallNumber” />

</mult>

ne Element

The ne element, an optional sub element of fieldDefinition and condition, indicates the start and end of a block in which users can list expressions to be compared for inequality. The comparison can be performed on strings, numbers, or Boolean values. Note that if the types are not compatible, the operation will throw, and the entire condition will evaluate to false.

| Start Element | End Element | Attribute Required | Attributes |
|---|---|---|---|
| <ne> | </ne> | N/A | (None) |

Attributes: None
Sub Elements

May be used 0 or more times:

May be used0 or more times:

| | |
|---|---|
| <serverVariable> | The serverVariable element indicates |
| | a server variable (e.g., HttpStatus, |
| | Duration, Timestamp) |
| <header> | The header element indicates an HTTP |
| | header (e.g., Host, Referrer) |
| <element> | The element element indicates an xml |
| | element |
| <soapOperation> | The soapOperation element indicates |
| | the name of the soap request |
| <soapParameter> | The soapParameter element indicates |
| | a parameter in the request |
| <soapFault> | The soapFault element indicates the |
| | error from the soap request |
| <literal> | The literal element indicates a |
| | constant value |
| <field> | The field element indicates a user- |
| | defined expression |
| <rawData> | The rawData element indicates that |
| | all information received in the |
| | request is to be logged. |

Other expressions (e.g, add, sub, mult . . . ) may also be used as sub elements.

### Example

The following example compares the values of BytesSent and BytesReceived. If the values are different, it returns a value of true:

<ne>

<serverVariable name=“BytesSent” />
<serverVariable name=“BytesReceived” />

</ne>

not Element

The not element, an optional sub element of fieldDefinition and condition, indicates the start and end of a block in which users can list a condition which must not be true.

| Start Element | End Element | Attribute Required | Attributes |
|---|---|---|---|
| <not> | </not> | N/A | (None) |

Attributes: None
Sub Elements

May be used 0 or more times:

May be used 0 or more times:

| | |
|---|---|
| <serverVariable> | The serverVariable element indicates |
| | a server variable (e.g., HttpStatus, |
| | Duration, Timestamp) |
| <header> | The header element indicates an HTTP |
| | header (e.g., Host, Referrer) |
| <element> | The element element indicates an xml |
| | element |
| <soapOperation> | The soapOperation element indicates |
| | the name of the soap request |
| <soapParameter> | The soapParameter element indicates |
| | a parameter in the request |
| <soapFault> | The soapFault element indicates the |
| | error from the soap request |
| <literal> | The literal element indicates a |
| | constant value |
| <field> | The field element indicates a user- |
| | defined expression |
| <rawData> | The rawData element indicates that |
| | all information received in the |
| | request is to be logged. |

Other expressions (e.g, add, sub, mult . . . ) may also be used as sub elements.

### Example

The following example checks to make sure the value of foo is not true. If the condition is met, true is returned:

<not>

<field name=“foo”>true</field>

</not>

or Element

The or element, an optional sub element of fieldDefinition and condition, indicates the start and end of a block in which users can list conditions, one of which must be met.

| Start Element | End Element | Attribute Required | Attributes |
|---|---|---|---|
| <or> | </or> | N/A | (None) |

Attributes: None
Sub Elements

May be used 0 or more times:

| | |
|---|---|
| <serverVariable> | The serverVariable element indicates |
| | a server variable (e.g., HttpStatus, |
| | Duration, Timestamp) |
| <header> | The header element indicates an HTTP |
| | header (e.g., Host, Referrer) |
| <element> | The element element indicates an xml |
| | element |
| <soapOperation> | The soapOperation element indicates |
| | the name of the soap request |
| <soapParameter> | The soapParameter element indicates |
| | a parameter in the request |
| <soapFault> | The soapFault element indicates the |
| | error from the soap request |
| <literal> | The literal element indicates a |
| | constant value |
| <field> | The field element indicates a user- |
| | defined expression |
| <rawData> | The rawData element indicates that |
| | all information received in the |
| | request is to be logged. |

Other expressions (e.g, add, sub, mult . . . ) may also be used as sub elements.

### Example

The following example checks to see if the value of foo or the value of bar is true. If one of these is true, the condition is met and true is returned:

<or>

<field name=“foo”>true</field>
<field name=“bar”>true</field>

</or>

output Element

The output element is a required sub element of rule. Each output must include a reference to a destination and one or more expressions for output The output will submit all expressions provided, in order, to the specified destination for processing.

| Start Element | End Element | Attribute Required | Attributes |
|---|---|---|---|
| <output> | </output> | Yes | destination |
| | | No | enabled |

Attributes

destination
destination, a required attribute, should be the destination where this output should be logged.

enabled

enabled, an optional attribute, specifies whether or not logging should be enabled to this destination. It defaults to true.

Example: <output destination=“Eventlog” enabled=“true” />

Sub Elements

May be used 0 or more times:

| | |
|---|---|
| <serverVariable> | The serverVariable element indicates a server variable |
| | (e.g., HttpStatus, Duration, Timestamp) |
| <header> | The header element indicates an HTTP header |
| | (e.g., Host, Referrer) |
| <element> | The element element indicates an xml element |
| <soapOperation> | The soapOperation element indicates the name of |
| | the soap request |
| <soapParameter> | The soapParameter element indicates a parameter |
| | in the request |
| <soapFault> | The soapFault element indicates the error |
| | from the soap request |
| <literal> | The literal element indicates a constant value |
| <field> | The field element indicates a user-defined expression |
| <rawData> | The rawData element indicates that all information |
| | received in the request is to be logged. |

Other expressions (e.g, add, sub, mult . . . ) may also be used as sub elements.

rawData Element

The rawData element, an optional sub element used in expressions defined under fields, condition, and output, indicates that it will log all the data of specified kind that it sees on the wire.

| Start Element | End Element | Attribute Required | Attributes |
|---|---|---|---|
| <rawData> | </rawData> | Yes | kind |
| | | Yes | direction |
| | | No | format |
| | | No | displayName |
| | | No | type |

Attributes

direction
direction, a required attribute, indicates the direction (input or output) of the rawData in question.

kind
kind, a required attribute, specifies the kind of the rawData in question. Valid options are headers and xml.

format
format, an optional attribute, specifies the format of the rawData in question. Note that in this example, the format String100 has previously been defined in the formats section.

displayName

displayName, an optional attribute, is used only with delimited output to override the default name of the field with a name the user prefers.

Example: <rawData direction=“input” kind=“xml”
format=“String100” displayName=“boo”>

type

type, an optional attribute, is used exclusively in delimited files to modify the header with the type information of the field. The GUI uses type to ascertain which fields are numeric (and thus whether they can be operated upon). If no type is specified, the filter will use the default value, “unknown”.

Example: <rawData direction=“input” kind=“xml” type=“string”>

Sub Elements: None
replace Element

The replace element, an optional sub element of transforms, indicates that the string contained in its from sub element should be transformed to the string in its to sub element when written to the output device. Multiple replace elements are accepted in a transform.

| Start Element | End Element | Attribute Required | Attributes |
|---|---|---|---|
| <replace> | </replace> | N/A | (None) |

Attributes: None
Sub Elements

Must appear 1 time each:

| | |
|---|---|
| <from> | The from element indicates the string to be replaced |
| <to> | The to element offers what should replace it |

rollover Element

The rollover element, an optional sub element of file, specifies where and when the log file should be rolled over.

| Start Element | End Element | Attribute Required | Attributes |
|---|---|---|---|
| <rollover> | </rollover> | No | startTime |
| | | No | interval |
| | | No | enabled |

Attributes

startTime
startTime represents the time, in seconds since EPOCH, from which the file rolling interval will be counted. If the startTime is in the future, rollover will not occur until this time; if it is in the past, rollover will occur on the next interval that is compatible with startTime. That is, if interval is every hour, and startTime specifies a 12:35 rollover time, rollover will occur every 60 minutes at 35 minutes past the hour. If the interval is not an exact multiple of hour, day, or week, then this parameter is ignored. The default value of 0 means it should be ignored.

interval
interval represents the interval, in seconds, at which the file should be rolled. This should be a positive integer.

enabled

Enabled indicates whether or not the rollover property is active. It defaults to true.

Example:
<rollover startTime=“0” interval=“86400” enabled=“true”/>

Sub Elements

May use 0-1 times:

| | |
|---|---|
| <copies> | Copies indicates what should happen to rolled over log files. |

rule Element

The rule element, a required sub element of serviceMonitor, indicates what, where, and when to log. Each rule may have 0 or 1 conditions.

| Start Element | End Element | Attribute Required | Attributes |
|---|---|---|---|
| <rule> | </rule> | Yes | name |
| | | No | enabled |

Attributes

name
name, a required attribute, should be the name of the rule in question.

enabled

enabled, an optional attribute, specifies whether or not logging should be enabled to this destination. It defaults to true.

Example: <rule name=“Errorlogger” enabled=“true” />

Sub Elements

May use 0-1 of the following:

| | |
|---|---|
| <condition> | The condition must be true for output to be produced. |

May use 0 or more of the following:

| | |
|---|---|
| <output> | Output defines an individual output specification. |

sampling Element

Sampling, an optional sub element of configuration, indicates the frequency with which operations should be sampled. For instance, in cases where performing requested operations every time might bog down the server, sampling can be used to request that data be sampled only every Nth occurrence. The default value for sampling is 1, indicating that every request should be evaluated.

| Start Element | End Element | Attribute Required | Attributes |
|---|---|---|---|
| <sampling> | </sampling> | N/A | (None) |

Attributes: None
Sub Elements: None

The value for sampling can be any integer greater than 0, and should be enclosed directly in the element.

| | |
|---|---|
| Example: | <sampling>5</sampling> |

serverVariable Element

The serverVariable element, an optional sub element used in expressions defined under fields, condition, and output, specifies the name of a server variable.

| Start Element | End Element | Attribute Required | Attributes |
|---|---|---|---|
| <serverVariable> | </serverVariable> | Yes | name |
| | | No | format |
| | | No | displayName |
| | | No | type |

Attributes

name

name, a required attribute, indicates the name of the serverVariable in question. This is specified as a string of characters enclosed in quotes. Acceptable values are:

[symbol]

clienthostname [symbol]
clientusername [symbol]
servername [symbol]
httpoperation [symbol]
uri [symbol]
uriparameters [symbol]
status [symbol]
localstatus [symbol]
bytessent [symbol]
bytesreceived [symbol]
duration [symbol]
timestamp [symbol]
hostname

format
format, an optional attribute, specifies the format of the serverVariable in question.

Note that in this example, the format String100 has previously been defined in the formats section.

displayName

displayName, an optional attribute, is used only with delimited output to override the default name of the field with a name the user prefers.

| | |
|---|---|
| Example: | <serverVariable name=“BytesSent” format=“String100” |

displayName=“boo”>

type

type, an optional attribute, is used exclusively in delimited files to modify the header with the type information of the field. The GUI uses type to ascertain which fields are numeric (and thus whether they can be operated upon). If no type is specified, the filter will use the default value, “unknown”.

| | |
|---|---|
| Example: | <serverVariable name=“BytesSent” type=“int”> |

Sub Elements: None
serviceMonitor Element

The serviceMonitor element is required in every ODF file. It is used to indicate the start and end of the file.

| Start Element | End Element | Attribute Required | Attributes |
|---|---|---|---|
| <serviceMonitor> | </serviceMonitor> | Yes | revision |
| | | Yes | version |
| | | No | enabled |

Namespace

http://www.serviceinteqrity.com/serviceMonitor/rulesDefinition.xml

Attributes

revision
revision, a required attribute, indicates the version of the configuration. This is specified as a positive integer enclosed in quotes. The revision number should be incremented every time any change is made to the configuration.

version

version, a required attribute, refers to the version of the SIFT code. The value of this attribute must be “1” for version 1 of SIFT; the parser will ignore configurations with version numbers that do not match its own.).

| | |
|---|---|
| Example: | <serviceMonitor revision=“22” version=”1”> |

enabled

enabled, an optional attribute, shows whether or not the configuration is enabled. This is specified as true or false. The default value is true.

| | |
|---|---|
| Example: | <serviceMonitor xmlns= |

“http://www.serviceintegrity.com/serviceMonitor/rulesDefinition.xml”
revision=“23”
version=”1” enabled=“false”>

Sub Elements

May be used 0-1 times:

| | |
|---|---|
| <configuration> | configuration dictates the |
| | behavior of the service |
| <formats> | formats shows how variables |
| | should be written to output devices |
| <fields> | fields enable users to define |
| | expressions in conditions or output |
| <destinations> | destinations specify the |
| | device for data output |

May be used 0 or more times:

| | |
|---|---|
| <rule> | rule defines what, where, and when to log |

sge Element

The sge element, an optional sub element of fieldDefinition and condition, indicates the start and end of a block in which users can list strings to be compared to see if one is greater than or equal to the other.

| Start Element | End Element | Attribute Required | Attributes |
|---|---|---|---|
| <sge> | </sge> | N/A | (None) |

Attributes: None
Sub Elements

May be used 0 or more times:

| | |
|---|---|
| <serverVariable> | The serverVariable element indicates |
| | a server variable (e.g., HttpStatus, |
| | Duration, Timestamp) |
| <header> | The header element indicates an HTTP |
| | header (e.g., Host, Referrer) |
| <element> | The element element indicates an xml |
| | element |
| <soapOperation> | The soapOperation element indicates |
| | the name of the soap request |
| <soapParameter> | The soapParameter element indicates |
| | a parameter in the request |
| <soapFault> | The soapFault element indicates the |
| | error from the soap request |
| <literal> | The literal element indicates a |
| | constant value |
| <field> | The field element indicates a user- |
| | defined expression |
| <rawData> | The rawData element indicates that |
| | all information received in the |
| | request is to be logged. |

Other expressions (e.g, add, sub, mult . . . ) may also be used as sub elements.

### Example

The following example compares the values of Host and Referrer lexically. If the former is greater than or equal to the latter, it returns a value of true:

<sge>

<Header name=“Host” />
<Header name=“Referrer” />

</sge>

sgt Element

The sgt element, an optional sub element of fieldDefinition and condition, indicates the start and end of a block in which users can list strings to be compared to see if one is greater than the other.

| Start Element | End Element | Attribute Required | Attributes |
|---|---|---|---|
| <sgt> | </sgt> | N/A | (None) |

Attributes: None
Sub Elements

May be used 0 or more times:

| | |
|---|---|
| <serverVariable> | The serverVariable element indicates a |
| | server variable (e.g., HttpStatus, |
| | Duration, Timestamp) |
| <header> | The header element indicates an HTTP |
| | header (e.g., Host, Referrer) |
| <element> | The element element indicates an xml |
| | element |
| <soapOperation> | The soapOperation element indicates |
| | the name of the soap request |
| <soapParameter> | The soapParameter element indicates |
| | a parameter in the request |
| <soapFault> | The soapFault element indicates the |
| | error from the soap request |
| <literal> | The literal element indicates a |
| | constant value |
| <field> | The field element indicates a user- |
| | defined expression |
| <rawData> | The rawData element indicates that |
| | all information received in the |
| | request is to be logged. |

Other expressions (e.g, add, sub, mult . . . ) may also be used as sub elements.

### Example

The following example compares the values of Host and Referrer lexically. If the former is greater than the latter, it returns a value of true:

<sgt>

<Header name=“Host” />
<Header name=“Referrer” />

</sgt>

singleLine Element

The singleLine element, an optional sub element of transforms, indicates that all new lines in the field should be replaced with spaces when written to the output device.

| Start Element | End Element | Attribute Required | Attributes |
|---|---|---|---|
| <singleLine> | </singleLine> | N/A | (None) |

Attributes: None
Sub Elements: None
sle Element

The sle element, an optional sub element of fieldDefinition and condition, indicates the start and end of a block in which users can list strings to be compared to see if one is less than or equal to the other.

| Start Element | End Element | Attribute Required | Attributes |
|---|---|---|---|
| <sle> | </sle> | N/A | (None) |

Attributes: None
Sub Elements

May be used 0 or more times:

| | |
|---|---|
| <serverVariable> | The serverVariable element indicates a |
| | server variable (e.g., HttpStatus, |
| | Duration, Timestamp) |
| <header> | The header element indicates an HTTP |
| | header (e.g., Host, Referrer) |
| <element> | The element element indicates an xml |
| | element |
| <soapOperation> | The soapOperation element indicates |
| | the name of the soap request |
| <soapParameter> | The soapParameter element indicates |
| | a parameter in the request |
| <soapFault> | The soapFault element indicates the |
| | error from the soap request |
| <literal> | The literal element indicates a |
| | constant value |
| <field> | The field element indicates a user- |
| | defined expression |
| <rawData> | The rawData element indicates that |
| | all information received in the |
| | request is to be logged. |

Other expressions (e.g, add, sub, mult . . . ) may also be used as sub elements.

### Example

The following example compares the values of Host and Referrer lexically. If the former is less than or equal to the latter, it returns a value of true:

<sle>

<Header name=“Host” />
<Header name=“Referrer” />

</sle>

slt Element

The slt element, an optional sub element of fieldDefinition and condition, indicates the start and end of a block in which users can list strings to be compared to see if one is less than the other.

| Start Element | End Element | Attribute Required | Attributes |
|---|---|---|---|
| <slt> | </slt> | N/A | (None) |

Attributes: None
Sub Elements

May be used 0 or more times:

| | |
|---|---|
| <serverVariable> | The serverVariable element indicates a |
| | server variable (e.g., HttpStatus, |
| | Duration, Timestamp) |
| <header> | The header element indicates an HTTP |
| | header (e.g., Host, Referrer) |
| <element> | The element element indicates an xml |
| | element |
| <soapOperation> | The soapOperation element indicates |
| | the name of the soap request |
| <soapParameter> | The soapParameter element indicates |
| | a parameter in the request |
| <soapFault> | The soapFault element indicates the |
| | error from the soap request |
| <literal> | The literal element indicates a |
| | constant value |
| <field> | The field element indicates a user- |
| | defined expression |
| <rawData> | The rawData element indicates that |
| | all information received in the |
| | request is to be logged. |

Other expressions (e.g, add, sub, mult . . . ) may also be used as sub elements.

### Example

The following example compares the values of Host and Referrer lexically. If the former is less than the latter, it returns a value of true. (Host is less than Referrer because it occurs first in the alphabet):

<slt>

<Header name=“Host” />
<Header name=“Referrer” />

</slt>

soapFault Element

The soapFault element, an optional sub element used in expressions defined under fields, condition, and output, specifies the error from the soap request.

| Start Element | End Element | Attribute Required | Attributes |
|---|---|---|---|
| <soapFault> | </soapFault> | Yes | name |
| | | No | format |
| | | No | displayName |
| | | No | type |

Attributes

name

name, a required attribute, should be the name of the soapFault in question. This should be specified in XPATH-compliant form, as described in the following examples. (Note that if you do not wish to print the name of the soapFault, you can simply enter “ ”):

1./ABC/DEF defines all sub elements <DEF> of <ABC>
2./ABC/DEF[2] defines the second sub
element <DEF> of <ABC>
3./ABC/[1] defines the first sub
element of <ABC>
4./ABC/DEF[2]/GHI selects all sub
elements <GHI> of the second element named <DEF>

of <ABC>

format
format, an optional attribute, specifies the format of the soapFault in question. Note that in this example, the format String100 has previously been defined in the formats section.

displayName

displayName, an optional attribute, is used only with delimited output to override the default name of the field with a name the user prefers.

| | |
|---|---|
| Example: | <soapFault name=“/foo/bar” |

format=“String100” displayName=”boo”/>

type

type, an optional attribute, is used exclusively in delimited files to modify the header with the type information of the field. The GUI uses type to ascertain which fields are numeric (and thus whether they can be operated upon). If no type is specified, the filter will use the default value, “unknown”.

| | |
|---|---|
| Example: | <soapFault name=“/foo/bar” type=“string”> |

Sub Elements: None
soapOperation Element

The soapOperation element, an optional sub element used in expressions defined under fields, condition, and output, specifies the name of the soap request.

| Start Element | End Element | Attribute Required | Attributes |
|---|---|---|---|
| <soapOperation> | </soapOperation> | No | format |
| | | No | displayName |
| | | No | type |

Attributes

format
format, an optional attribute, specifies the format of the soapOperation in question. Note that in the following example, the format String100 has previously been defined in the formats section.

displayName

displayName, an optional attribute, is used only with delimited output to override the default name of the field with a name the user prefers.

| | |
|---|---|
| Example: | <soapOperation format=“String100” displayName=”boo”/> |

type

type, an optional attribute, is used exclusively in delimited files to modify the header with the type information of the field. The GUI uses type to ascertain which fields are numeric (and thus whether they can be operated upon). If no type is specified, the filter will use the default value, “unknown”.

| | |
|---|---|
| Example: | <soapOperation type=“string”> |

Sub Elements: None

### Example

In an output operation, the following would print the name of the value of soapOperation to the output device.

<soapOperation />

soapParameter Element

The soapParameter element, an optional sub element used in expressions defined under fields, condition, and output, specifies the name of a parameter in the soap request.

| | | Attribute | |
|---|---|---|---|
| Start Element | End Element | Required | Attributes |
| <soapParameter> | </soapParameter> | Yes | name |
| | | Yes | direction |
| | | No | format |
| | | No | displayName |
| | | No | type |

Attributes

name

name, a required attribute, should be the name of the soapParameter in question. The parameter may refer to a component of a complex parameter, such as a data structure or an array. It should be specified in XPATH-compliant form, as described in the following examples:

1./ABC/DEF defines all sub elements <DEF> of <ABC>
2./ABC/DEF[2] defines the second sub element
<DEF> of <ABC>
3./ABC/[1] defines the first sub element of <ABC>
/ABC/DEF[2]/GHI selects all sub elements <GHI>
of the second element named <DEF>
of <ABC

direction
direction, a required attribute, indicates the direction (input or output) of the soapParameter in question.

format
format, an optional attribute, specifies the format of the soapParameter in question. Note that in this example, the format string100 has previously been defined in the formats section.

displayName
displayName, an optional attribute, is used only with delimited output to override the default name of the field with a name the user prefers.

### Examples

<soapParameter name=“TransactionId/Value”
direction=“input”

format=“String100” displayName=”boo” />

<soapParameter name=“/TransactionId/Value[3]”
direction=“output”

format=“String100” displayName=”boo” />

<soapParameter name=“/TransactionId/Value[@type=int]”
direction=“input”

format=“String100” displayName=”boo” />

type

type, an optional attribute, is used exclusively in delimited files to modify the header with the type information of the field. The GUI uses type to ascertain which fields are numeric (and thus whether they can be operated upon). If no type is specified, the filter will use the default value, “unknown”.

| | |
|---|---|
| Example: | <soapParameter name=“TransactionId/Value” |

direction=“input” type=“int”>

Sub Elements: None
string Element

The string element, a sub element of formats, specifies the formatting that should be used when a string is written to the output device.

| Start Element | End Element | Attribute Required | Attributes |
|---|---|---|---|
| <string> | </string> | No | name |

Attributes

Name

Name, a required attribute, indicates the name of the format. This is specified as a string of characters enclosed in quotes.

| | |
|---|---|
| Example: | <string name=“MyString”> |

Sub Elements

May use 0-1 of the following:

| | |
|---|---|
| <transforms> | The transforms element specifies |
| | how the string will be |
| | encoded/changed. |
| <formatting> | The formatting element allows the |
| | user to specify the string's output |
| | format. |

sub Element

The sub element, an optional sub element of fieldDefinition and condition, indicates the start and end of a block in which users can list expressions to be subtracted from each other.

| Start Element | End Element | Attribute Required | Attributes |
|---|---|---|---|
| <sub> | </sub> | N/A | (None) |

Attributes: None
Sub Elements

May be used 0 or more times:

| | |
|---|---|
| <serverVariable> | The serverVariable element indicates a server variable |
| | (e.g., HttpStatus, Duration, Timestamp) |
| <header> | The header element indicates an HTTP header (e.g., |
| | Host, Referrer) |
| <element> | The element element indicates an xml element |
| <soapOperation> | The soapOperation element indicates the name of the |
| | soap request |
| <soapParameter> | The soapParameter element indicates a parameter in |
| | the request |
| <soapFault> | The soapFault element indicates the error from the |
| | soap request |
| <literal> | The literal element indicates a constant value |
| <field> | The field element indicates a user-defined expression |
| <rawData> | The rawData element indicates that all information |
| | recieved in the request is to be logged. |

Other expressions (e.g, add, sub, mult . . . ) may also be used as sub elements.

### Example

The following example subtracts the server variable named BytesReceived from the server variable named BytesSent, and returns the result:

<sub>

<serverVariable name=“BytesSent” />
<serverVariable name=“BytesReceived” />

</sub>

timestamp Element

The timestamp element, a sub element of formats, specifies a format that can be used when the timestamp is written to the output device.

| Start Element | End Element | Attribute Required | Attributes |
|---|---|---|---|
| <timestamp> | </timestamp> | No | name |

Attributes

Name

Name, a required attribute, indicates the name of the timestamp in question. This is specified as a string of characters enclosed in quotes.

| | |
|---|---|
| Example: | <timestamp name=“TimeAfterTime”> |

Sub Elements: None

The timestamp format requires an integer that specifies time as the number of milliseconds since EPOCH (Jan. 1, 1970 GMT). The output definition below uses a modified version of the format specification defined by the strftime ( ) system call, where %Y is equivalent to a 4 digit year, etc. In this case, %L represents milliseconds.

| | |
|---|---|
| Example: | <timestamp name=“Timeformat”>%Y-%m-%d |

%H:%M:%S.%L </timestamp>

to Element

The to element, a required sub element of replace, identifies a string with which to replace the string specified by the from element when written to the output device.

| Start Element | End Element | Attribute Required | Attributes |
|---|---|---|---|
| <to> | </to> | N/A | (None) |

Attributes: None
Sub Elements: None

Valid values for this element include any string. Note that it must be paired with the from element. The following example replaces the string “Rags” with the string “Riches”:

| | |
|---|---|
| Example: | <from>Rags</from> |

<to>Riches</to>

transforms Element

The transforms element, an optional sub element of string, indicates how the given string should be encoded or otherwise transformed when it is written to the output device. All sub elements will be evaluated in the order in which they are defined to produce the output.

| Start Element | End Element | Attribute Required | Attributes |
|---|---|---|---|
| <transforms> | </transforms> | N/A | (None) |

Attributes: None
SubElements

May use 0-1 times:

| | |
|---|---|
| <encryption> | The encryption element encrypts the field |
| | with the given information. Note that |
| | in cases where several transforms will |
| | be chained together, encryption must |
| | always be used last. (Otherwise, later |
| | transforms could conceivably prevent |
| | decryption from being successful.) |
| <singleLine> | The singleLine element replaces new |
| | lines with spaces |
| <encodeXml> | The encodeXml element encodes according |
| | to the xml encoding definition |
| <encodeBase64> | The encodeXml element encodes according |
| | to the base64 encoding definition. |
| <trim> | Trim causes the formatted string to be |
| | trimmed of leading and trailing white |
| | space. |
| <hash> | hash uses md5 to hash the field. |

May use 0 or more times:

| | |
|---|---|
| <replace> | The replace element replaces one string with another |

trim Element

The trim element, an optional sub element of transforms, causes the formatted string to be trimmed of leading and trailing white space (including “”, “\t”, “\n”).

| Start Element | End Element | Attribute Required | Attributes |
|---|---|---|---|
| <trim> | </trim> | N/A | (None) |

Attributes: None
SubElements: None

1. A method for obtaining data about a transaction in a computer system comprising:
receiving at least one message at each of a plurality of nodes in connection with performing a service of said transaction;
filtering said at least one message at each of said plurality of nodes in accordance with a current set of one or more rules producing local filtered data at each of said plurality of nodes; and
processing said local filtered data producing aggregated data about said transaction.

2. The method of claim 1, wherein the plurality of nodes includes one of: a single instance of a web service, an application server, a host computer, a geographical computer site.

3. The method of claim 1, wherein at least two nodes of said plurality of nodes are associated with performing processing for a single application.

4. The method of claim 1, wherein said filtering at each of said plurality of nodes is performed while said each node is servicing a request.

5. The method of claim 4, further comprising:
collecting said aggregated data from each of said plurality of nodes about said transaction.

6. The method of claim 4, further comprising:
collecting said aggregated data from a portion of said plurality of nodes about said transaction.

7. The method of claim 1, further comprising:
aggregating XML message data received at each of said plurality of nodes, said plurality of nodes being a distributed network of service node peers.

8. The method of claim 6, wherein each of said plurality of nodes is an application performing an operation in connection with servicing a transaction.

9. The method of claim 8, wherein said current set of rules is evaluated in accordance with each received message.

10. The method of claim 9, further comprising:
revising said current set of rules at one of said plurality of nodes while said one node is servicing a request.

11. The method of claim 9, wherein each rule in said current set of rules includes a condition portion and an action portion, and the method further comprising:
evaluating a condition portion of a first rule in accordance with a first received message wherein said condition portion evaluates to false and said action portion is not performed; and
evaluating said condition portion of said first rule in accordance with a second received message wherein said condition portion evaluates to true and said action portion is performed.

12. The method of claim 11, wherein said action portion includes performing at least one of: outputting data to a destination and invoking an application.

13. The method of claim 1, wherein a transaction is determined in accordance with at least one of: a transaction identifier, a customer identifier, and a timestamp included in each of said at least one message.

14. The method of claim 13, wherein said processing includes analyzing said local filtered data at at least a portion of said plurality of nodes in accordance with a time-coherency and key-value pattern matching.

15. The method of claim 14, further comprising:
determining a first time for performing a first operation at a first of said plurality of nodes;
determining a second time for performing a second operation at a second of said plurality of nodes;
analyzing first local filtered data at said first node using an identifier associated with a transaction producing a first transaction data set;
analyzing second local filtered data at said second node using said identifier producing a second transaction data set; and
determining that said first and second transaction data sets are messages received by each of said first and second nodes for performing different operations for a same transaction at different points in time.

16. The method of claim 15, further comprising:
determining a processing path of operations performed by one or more of said plurality of nodes in connection with servicing said transaction in accordance with said identifier associated with said transaction.

17. A computer program product method for obtaining data about a transaction in a computer system comprising:
executable code that receives at least one message at each of a plurality of nodes in connection with performing a service of said transaction;
executable code that filters said at least one message at each of said plurality of nodes in accordance with a current set of one or more rules producing local filtered data at each of said plurality of nodes; and
executable code that processes, at each of said plurality of nodes, said local filtered data producing aggregated data about said transaction.

18. The computer program product of claim 17, wherein each of at least a portion of said plurality of nodes is one of: a single instance of a web service, an application server, a host computer, a geographical computer site.

19. The computer program product of claim 17, wherein at least two nodes of said plurality of nodes are associated with performing processing for a single application.

20. The computer program product of claim 17, wherein said executable code that filters at each of said plurality of nodes performs filtering in real-time while said each node is servicing a request.

21. The computer program product of claim 20, further comprising:
executable code that collects said aggregated data from each of said plurality of nodes about said transaction.

22. The computer program product of claim 20, further comprising:
executable code that collects said aggregated data from a portion of said plurality of nodes about said transaction.

23. The computer program product of claim 17, further comprising:
executable code that aggregates XML message data received at each of said plurality of nodes, said plurality of nodes being a distributed network of service node peers.

24. The computer program product of claim 22, wherein each of said plurality of nodes is an application performing an operation in connection with servicing a transaction.

25. The computer program product of claim 24, wherein said current set of rules is evaluated in accordance with each received message.

26. The computer program product of claim 25, further comprising:
executable code that revises said current set of rules at one of said plurality of nodes while said one node is servicing a request.

27. The computer program product of claim 25, wherein each rule in said current set of rules includes a condition portion and an action portion, and the computer program product further comprising:
executable code that evaluates a condition portion of a first rule in accordance with a first received message wherein said condition portion evaluates to false and said action portion is not performed; and
executable code that evaluates said condition portion of said first rule in accordance with a second received message wherein said condition portion evaluates to true and said action portion is performed.

28. The computer program product of claim 27, wherein said action portion includes performing at least one of: outputting data to a destination and invoking an application.

29. The computer program product of claim 17, wherein a transaction is determined in accordance with at least one of: a transaction identifier, a customer identifier, and a timestamp included in each of said at least one message.

30. The computer program product of claim 29, wherein said executable code that processes includes executable code that analyzes said local filtered data at at least a portion of said plurality of nodes in accordance with a time-coherency and key-value pattern matching.

31. The computer program product of claim 30, further comprising:
executable code that determines a first time for performing a first operation at a first of said plurality of nodes;
executable code that determines a second time for performing a second operation at a second of said plurality of nodes;
executable code that analyzes first local filtered data at said first node using an identifier associated with a transaction producing a first transaction data set;
executable code that analyzes second local filtered data at said second node using said identifier producing a second transaction data set; and
executable code that determines that said first and second transaction data sets are messages received by each of said first and second nodes for performing different operations for a same transaction at different points in time.

32. The computer program product of claim 31, further comprising:
executable code that determines a processing path of operations performed by one or more of said plurality of nodes in connection with servicing said transaction in accordance with said identifier associated with said transaction.

33. The method of claim 1, wherein at least some of the processing of the local filtered data is performed at each of the plurality nodes.

34. The method of claim 4, wherein the filtering is performed in real time.
